(19) United States
(12) Patent Application Publication
(10) Pub. No.: US 2010/0234071 A1
(43) Pub. Date: Sep. 16, 2010

(54) VEHICLE INTEGRATED COMMUNICATIONS SYSTEM

(75) Inventors: Ophir Shabtay, Haifa (IL); Jacob Scheim, Pardes Hanna (IL); Eyal Barnea Nehoshtan, Ramat Hasharon (IL); Avi Sharon, Modiin (IL)

Correspondence Address: Zaretsky Patent Group PC, 20783 N 83rd Ave, Ste 103-174, Peoria, AZ, 85382-7430, US

(73) Assignee: Comsys Communication & Signal Processing Ltd.

(21) Appl. No.: 12/722,808

(22) Filed: Mar. 12, 2010

Related U.S. Application Data
(60) Provisional application No. 61/159,748, filed on Mar. 12, 2009.

(51) Int. Cl. H04M 1/00; H04K 1/10

(52) U.S. Cl. 455/562.1; 375/260

(57) ABSTRACT

A novel and useful vehicle integrated communications system that provides a solution to the poor performance experienced at the cell edge in a cellular communications system due to weak signal strength and high interference levels. A core cellular communications platform embedded (integrated) into the vehicle platform utilizes multiple antennas integrated into the body of the vehicle which are coupled to a multi-antenna transceiver; receives electrical power from the vehicle power source eliminating the limitations of hand held device batteries; processes multiple MIMO RF signals taking advantage of antenna diversity, beamforming and spatial multiplexing; executes advanced interference mitigation algorithms; implements adaptive modulation and coding algorithms; and utilizes dynamic channel modeling and estimation to significantly improve performance. The core cellular link functions as a platform for any number of vehicle based applications including a smart vehicle repeater, mobile femtocell, inverted femtocell and vehicle infotainment system.

### REFERENCE TO PRIORITY APPLICATION

This application claims priority to U.S. Provisional Application Ser. No. 61/159,748, filed Mar. 12, 2009, entitled “Smart Car Repeater System,” incorporated herein by reference in its entirety.

### TECHNICAL FIELD

The disclosure relates generally to the field of wireless communication systems and more particularly relates to a vehicle integrated communications system for providing advanced communications features and services in a vehicle platform.

### BACKGROUND

In recent years, the demand for higher and higher data rates in wireless networks has increased unabated and has triggered the design and development of new data-centric cellular standards such as WiMAX (802.16e), 3GPP's High Speed Packet Access (HSPA) and LTE standards, and 3GPP2's EVDO and UMB wireless standards.

Reception efficiency at the edges of cells, however, is a key factor in the spectral performance of the entire cellular network. Furthermore, data throughput reported at the cell edge in third and fourth generation cellular systems (i.e. 3G and 4G respectively) drops by two orders of magnitude compared with the spectral efficiency measured close to the center of a cell area where the base station (BS) is located. This drop in data throughput lowers the quality of service and the resulting data rates that are attainable which leads to a major degradation in the user's experience.

Conventional cellular systems are made up of cells that cover geographical areas. In the center of the cells is an antenna tower or mast connected to a base station. The cellular network (NW) is a multiple access system whereby a large number of users are covered by these cells. All users are connected to the access part of the cellular network wherein some users exchange information through the cellular network. Due to limited availability of frequency bands, the same carrier frequencies are reused causing an unequal condition wherein users that are close to the base station antenna experience a strong signal with low interference. The majority of users, however, populate the edge of the cell where they experience a weak signal combined with strong interference. This results in a spectral efficiency ratio in the range 100 to 200 between the cell center and cell edge. For example, the throughput at the center of the cell may be 5 to 7 bps/Hz/Sector but only 0.04 or 0.01 bps/Hz/Sector at the cell edge. The implications are two fold: (1) users experience a significant reduction in quality and data rate at the cell edge; and (2) network operators obtain an actual capacity that is much lower than the theoretical capacity.

As an example of this problem, consider the example conventional wireless network shown in FIG. 1. The example cellular network, generally referenced 10, comprises a first cell 12 with base station (BS1), second cell 14 with base station (BS2), multiple UEs, including UE1 and UE2 both near their cell edges. UE1 communicates with BS1 over link L1 and UE2 communicates with BS2 over link L2. For simplicity sake, the relationship to the environment driven by UE1 is demonstrated. Transmissions from BS1 intended for UE1 over link L1 interfere with transmissions from BS2 intended for UE2 over link L2. The UE2 receiver experiences a linear combination of its desired signal denoted L2 and interference signal denoted I1. Thus, UE2 receives a level of interference which is on the order of the received signal power over link L1. Such interference which is typical at the cell edge, significantly degrades the data throughput and performance of the UEs located in the vicinity of the cell's edge. Similarly, transmissions from BS2 intended for UE2 over link L2 interfere with transmissions from BS1 intended for UE1 over link L1. The UE1 receiver experiences a linear combination of its desired signal denoted L1 and interference signal denoted I2. UE1 therefore receives a level of interference which is on the order of the received signal power over link L2.

Thus, the problem of coverage in cellular communication systems increases as a mobile user approaches the cell edge. In cell edge conditions, a mobile user experiences both poor link levels due to the relatively large distance to the cell site along with high interference coming from neighboring cells. Note that by default, a moving user must experience cell edge conditions just before and after a handover event since during the handover, the new cell stops being interference for the UE and starts to be useful signal.

Further, the cell edge is actually a thin ring where only about 5% to 10% of users experience the worst conditions. The majority of cellular users in both suburban and dense urban deployments are neither at the cell center nor the cell edge. These users experience only approximately one order of magnitude reduction in spectral efficiency. Users that start from the cell center and travel along the cell radius will experience degradation of signal quality until the handover event, when the link is transferred to the next base station.

### SUMMARY

A novel and useful vehicle integrated communications system that provides a solution to the poor performance experienced at the cell edge in a cellular communications system due to weak signal strength and high interference levels. A core cellular communications platform embedded (integrated) into the vehicle platform utilizes multiple antennas integrated into the body of the vehicle which are coupled to a multi-antenna transceiver; receives electrical power from the vehicle power source eliminating the limitations of hand held device batteries; processes multiple MIMO RF signals taking advantage of antenna diversity, beamforming and spatial multiplexing; executes advanced interference mitigation algorithms; implements adaptive modulation and coding algorithms; and utilizes dynamic channel modeling and estimation to significantly improve performance. The core cellular link functions as a platform for any number of vehicle based applications including a smart vehicle repeater, mobile femtocell, inverted femtocell and vehicle infotainment system.

There is thus provided a vehicle integrated communications system comprising a multi-antenna radio frequency (RF) module operative to be coupled to a plurality of antennas integrated into a vehicle platform for transmitting and receiving a plurality of spatial streams over a communications network link, a receiver baseband module coupled to the RF module and operative to generate RX data in accordance with multiple receive spatial streams received from the plurality of antennas, a transmitter baseband module coupled to the RF module and operative to generate, from TX data, multiple transmit spatial streams for transmission over the plurality of antennas and a controller operative to control the operation of the multi-antenna RF module, the receiver baseband module and the transmitter baseband module.

There is also provided a method of communications for use in a vehicle communications system integrated into a vehicle platform, the method comprising providing a multi-antenna radio frequency (RF) module operative to be coupled to a multiple antenna system (MAS) comprising a plurality of antennas integrated into a vehicle platform, the multi-antenna RF module operative to transmit and receive multiple spatial streams over a communications network link, providing a receiver baseband module coupled to the RF module and operative to generate RX data in accordance with multiple receive spatial streams received from the plurality of antennas, providing a transmitter baseband module coupled to the RF module and operative to generate, from TX data, multiple transmit spatial streams for transmission over the plurality of antennas, providing a controller operative to control the operation of the multi-antenna RF module, the receiver baseband module and the transmitter baseband module and selecting one or more optimal RX algorithms for execution in the receiver baseband module and one or more optimal TX algorithms for execution in the transmitter baseband module that exploit the plurality of antennas.

There is further provided a vehicle integrated cellular communications platform comprising a multiple antenna system (MAS) comprising a plurality of antennas integrated into a vehicle form factor, the MAS operative to transmit and receive a plurality of spatial streams over a radio access network (RAN), a cellular transceiver radio coupled to the MAS operative to provide communications over the RAN and a processor operative to execute one or more algorithms to maximize cell edge spectral efficiency and performance by exploiting one or more properties of the MAS.

There is also provided a vehicle integrated cellular communications platform, comprising a cellular transceiver radio operative to be coupled to a multiple antenna system (MAS) integrated into a vehicle form factor and to transmit and receive a plurality of spatial streams over a radio access network (RAN) via the MAS, and a processor operative to execute one or more algorithms to maximize cell edge spectral efficiency and performance by exploiting one or more properties of the MAS.

### BRIEF DESCRIPTION OF THE DRAWINGS

The mechanism is herein described, by way of example only, with reference to the accompanying drawings, wherein:

FIG. 1 is a diagram illustrating an example prior art wireless network including multiple UEs at the cell edge;

FIG. 2 is a high level block diagram illustrating the components of an example vehicle communication system;

FIG. 3 is a high level block diagram illustrating the vehicle integrated subsystems in more detail;

FIG. 4 is a block diagram illustrating the vehicle communication system in more detail;

FIG. 5 is a block diagram illustrating example channel impairments and modem parameters;

FIG. 6 is a block diagram illustrating the integration between components of the vehicle communications system and components of the automotive system;

FIG. 7 is a diagram illustrating example placement of antennas and infotainment system terminals in a vehicle;

FIG. 8 is a diagram illustrating an example placement of the components making up the vehicle communications system;

FIG. 9 is a diagram illustrating example placement of antennas on the roof top of a vehicle;

FIG. 10 is a diagram illustrating alternate locations for antennas on the roof racks and roof top of a vehicle;

FIG. 11 is a diagram illustrating example placement of antennas on the pillars of a vehicle;

FIG. 12 is a diagram illustrating example placement of antennas on the lower body portions of a vehicle;

FIG. 13 is a diagram illustrating the receive diversity gain improvements as the number of antennas increases;

FIG. 14 is a diagram illustrating the STC gain improvement with and without receive diversity;

FIG. 15 is a diagram illustrating the receive throughput in diversity and spatial multiplexing configuration with two, three and four antennas;

FIG. 16 is a block diagram illustrating an example multi-antenna OFDMA transmitter;

FIG. 17 is a flow diagram illustrating an example TX antenna configuration control method;

FIG. 18 is a block diagram illustrating an example multi-antenna OFDMA receiver;

FIG. 19 is a flow diagram illustrating an example MIMO decoder configuration method;

FIG. 20 is a block diagram illustrating an example look up table based MIMO decoder configuration selection scheme;

FIG. 21 is a diagram illustrating example parameters making up the look up table index;

FIG. 22 is a diagram illustrating the relative improvement of the vehicle communications system over conventional cellular systems;

FIG. 23 is a high level diagram illustrating a first example dumb vehicle repeater;

FIG. 24 is a high level diagram illustrating a second example dumb vehicle repeater;

FIG. 25 is a diagram illustrating message forwarding for an example vehicle repeater;

FIG. 26 is a diagram illustrating a first example wireless network incorporating a repeater/relay device;

FIG. 27 is a diagram illustrating a second example wireless network incorporating a repeater/relay device;

FIG. 28 is a diagram illustrating message forwarding for an example first embodiment smart vehicle repeater;

FIG. 29 is a diagram illustrating an example wireless network incorporating a second embodiment smart vehicle repeater;

FIG. 30 is a high level diagram illustrating an example VCS based second embodiment smart vehicle repeater;

FIG. 31 is a diagram illustrating an example of the interference inherent in the VCS based second embodiment smart vehicle repeater;

FIG. 32 is a diagram illustrating an example wireless network incorporating a mobile femtocell;

FIG. 33 is a high level diagram illustrating an example VCS based mobile femtocell;

FIG. 34 is a diagram illustrating an example wireless network incorporating an inverted femtocell;

FIG. 35 is a high level diagram illustrating an example VCS based inverted femtocell;

FIG. 36 is a diagram illustrating an example wireless network incorporating an inverted femtocell device;

FIG. 37 is a diagram illustrating message forwarding for an example inverted femtocell;

FIG. 38 is a diagram illustrating an example VCS based vehicle infotainment system modem;

FIGS. 39A and 39B are diagrams illustrating an example VCS based vehicle infotainment system network;

FIG. 40 is a high level diagram illustrating an example VCS based vehicle infotainment system;

FIG. 41 is a diagram illustrating message forwarding for an example vehicle infotainment system; and

FIG. 42 is a block diagram illustrating an example computer processing system adapted to implement the vehicle communications system mechanism or portions thereof.

### DETAILED DESCRIPTION

### Notation Used Throughout

The following notation is used throughout this document.

| Term | Definition |
|---|---|
| 3GPP | Third Generation Partnership Project |
| AAA | Authentication, Authorization, and Accounting |
| AC | Alternating Current |
| ADSL | Asynchronous Digital Subscriber Loop |
| AP | Access Point |
| ARQ | Automatic Repeat-reQuest |
| ASIC | Application Specific Integrated Circuit |
| AVI | Audio Video Interleave |
| BB | Baseband |
| BER | Bit Error Rate |
| BIST | Built In Self Test |
| BOM | Bill of Materials |
| BS | Base Station |
| BTS | Base Transmit Station |
| BW | Bandwidth |
| BWA | Broadband Wireless Access |
| CALM | Communications Access for Land Mobiles |
| CAN | Controller Area Network |
| CDMA | Code Division Multiple Access |
| CINR | Carrier to Interference and Noise Ratio |
| CME | CALM Management Entity |
| CPU | Central Processing Unit |
| CQI | Channel Quality Indicator |
| CS | Circuit Switched |
| CTC | Combined-Transform Coding |
| CVIS | Cooperative Vehicle-Infrastructure Systems |
| DC | Direct Current |
| DHCP | Dynamic Host Control Protocol |
| DL | Downlink |
| DL-MAP | Downlink Medium Access Protocol |
| DSL | Digital Subscriber Loop |
| DSP | Digital Signal Processor |
| DSRC | Dedicated Short Range Communications |
| DSSS | Direct Sequence Spread Spectrum |
| DVB | Digital Video Broadcast |
| DVD | Digital Versatile Disc |
| DVR | Dumb Vehicle Repeater |
| EDGE | Enhanced Data rates for GSM Evolution |
| EEROM | Electrically Erasable Read-Only Memory |
| EGPRS | Enhanced General Packet Radio Service |
| EM | Electromagnetic |
| eNB | evolved Node B |
| EPROM | Erasable Programmable Read Only Memory |
| ETSI | European Telecommunications Standards Institute |
| EVDO | Evolution-Data Optimized |
| FAST | Fix Adapted for Streaming |
| FDD | Frequency Division Duplex |
| FDMA | Frequency Division Multiple Access |
| FEC | Forward Error Correction |
| FEM | Front End Module |
| FFT | Fast Fourier Transform |
| FH | Frequency Hopping |
| FHSS | Frequency Hopping Spread Spectrum |
| FM | Frequency Modulation |
| FPGA | Field Programmable Gate Array |
| FTP | File Transfer Protocol |
| GPRS | General Packet Radio Service |
| GPS | Global Positioning Satellite |
| GSM | Global System for Mobile Communication |
| HARQ | Hybrid ARQ |
| HDL | Hardware Description Language |
| HLR | Home Location Registry |
| HSDPA | High-Speed Downlink Packet Access |
| HSPA | High Speed Packet Access |
| HSPA | High Speed Packet Access |
| HSUPA | High-Speed Uplink Packet Access |
| HTTP | Hypertext Transfer Protocol |
| IC | Integrated Circuit |
| IEEE | Institute of Electrical and Electronic Engineers |
| IF | Intermediate Frequency |
| IFFT | Inverse FFT |
| IME | Interface Management Entity |
| IP | Internet Protocol |
| IR | Infrared |
| ISO | International Organization for Standardization |
| ITS | Intelligent Transport System |
| IVN | In-Vehicle Network |
| JPG | Joint Photographic Experts Group |
| LAN | Local Area Network |
| LTE | Long Term Evolution |
| LUT | Look-Up Table |
| MAC | Media Access Control |
| MAN | Metropolitan Area Network |
| MAP | Medium Access Protocol |
| MAS | Multiple Antenna System |
| MBCM | Macrocell Backhaul Communications Module |
| MBS | Multicast and Broadcast Service |
| MIMO | Multiple-In Multiple-Out |
| MP3 | MPEG-1 Audio Layer 3 |
| MPG | Moving Picture Experts Group |
| MRC | Maximal Ratio Combining |
| MS | Mobile Station |
| NAS | Non Access Stratum |
| NFC | Near Field Communication |
| NIC | Network Interface Card |
| NME | Network Management Entity |
| NW | Network |
| OEM | Original Equipment Manufacturer |
| OFDM | Orthogonal Frequency Division Modulation |
| OFDMA | Orthogonal Frequency Division Multiple Access |
| PAN | Personal Area Network |
| PC | Personal Computer |
| PCA | Personal Computing Accessory |
| PCI | Peripheral Component Interconnect |
| PCS | Personal Communication System |
| PDA | Personal Digital Assistant |
| PDU | Protocol Data Unit |
| PLMN | Public Land Mobile Network |
| PMI | Preceding Matrix Indicator |
| PMP | Portable Multimedia Player |
| PNA | Personal Navigation Assistant |
| PND | Personal Navigation Device |
| PRBS | Pseudo Random Binary Sequence |
| PROM | Programmable Read Only Memory |
| PSTN | Public Switched Telephone Network |
| QAM | Quadrature Amplitude Modulation |
| QoE | Quality of Experience |
| QoS | Quality of Service |
| RACD | Radio Access Communications Device |
| RAM | Random Access Memory |
| RAN | Radio Access Network |
| RANI | Radio Access Network Interface |
| RAT | Radio Access Technology |
| RF | Radio Frequency |
| RI | Rank Indication |
| RM | Rate Matching |
| ROM | Read Only Memory |
| RSSI | Received Signal Strength Indication |
| RUIM | Removable User Identity Module |
| SAN | Storage Area Network |
| SAP | Service Access Points |
| SBS | Serving Base Station |
| SDIO | Secure Digital Input/Output |
| SDMA | Space Division Multiple Access |
| SIM | Subscriber Identity Module |
| SIMO | Single-In Multiple-Out |
| SINR | Signal to Interference and Noise Ratio |
| SIP | Session Initiation Protocol |
| SNR | Signal to Noise Ratio |
| SOHO | Small Office Home Office |
| SPI | Serial Peripheral Interface |
| STC | Space Time Code |
| STC | Space Time Code |
| SVR | Smart Vehicle Repeater |
| TBS | Target Base Station |
| TCP | Transmission Control Protocol |
| TDD | Time Division Duplex |
| TDMA | Time Division Multiple Access |
| TV | Television |
| UE | User Equipment |
| UL | Uplink |
| UMB | Ultra Mobile Broadband |
| UMTS | Universal Mobile Telecommunications System |
| UPSD | Unscheduled Power Save Delivery |
| USB | Universal Serial Bus |
| UTRA | Universal Terrestrial Radio Access |
| UWB | Ultra Wideband |
| VCS | Vehicle Communications System |
| VIS | Vehicle Infotainment System |
| VLR | Visitor Location Registry |
| VPS | Vehicle Power Source |
| WAN | Wide Area Network |
| WBA | Wireless Broadband Access |
| WCDMA | Wideband Code Division Multiple Access |
| WiFi | Wireless Fidelity |
| WiMAX | Worldwide Interoperability for Microwave Access |
| WLAN | Wireless Local Area Network |
| WLL | Wireless Local Loop |
| WMA | Windows Media Audio |
| WMAN | Wireless Metropolitan Area Network |
| WMV | Windows Media Video |
| WPAN | Wireless Personal Area Network |
| wUSB | Wireless USB |
| WWAN | Wireless Wide Area Network |

### DETAILED DESCRIPTION

The mechanism will now be described more fully hereinafter with reference to the accompanying drawings, in which preferred embodiments of the mechanism are shown. The mechanism may, however, be embodied in many different forms and should not be construed as limited to the embodiments set forth herein. Rather, these embodiments are provided so that this disclosure will be thorough and complete, and will fully convey the scope of the mechanism to those skilled in the art. Like numbers refer to like elements throughout, and prime notation is used to indicate similar elements in alternative embodiments.

To aid in illustrating the principles of the mechanism, an example mobile station is described. As an example, the mobile station may comprise a single radio access communication device (RACD), e.g., GSM, WiMAX, WLAN, or multiple RACDs. In the multi-RAT case, the mobile device is capable of maintaining communications with more than one wireless communications system at the same time and may comprise any desired RAT including, for example, WiMAX, UWB, GSM, wUSB, Bluetooth, WLAN, 3GPP (UMTS, WCDMA, HSPA, HSUPA, HSDPA, HSPA+, LTE), 3GPP2 (CDMA2000, EVDO, EVDV), DVB and others. Note that the mechanism is not intended to be limited by the type or number of radio access communication devices (RACDs) in the MS.

Many aspects of the mechanism described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, Android, etc., or non-real time operating systems such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media. Examples of wireless media include RF, infrared, optical, microwave, UWB, Bluetooth, WiMAX, GSM, EDGE, UMTS, WCDMA, HSPA, LTE, CDMA-2000, EVDO, EVDV, WiFi, or any other broadband medium, radio access technology (RAT), etc.

The term ‘mobile station’ is defined as all user equipment and software needed for communication with a network such as a RAN. Examples include a system, subscriber unit, mobile unit, mobile device, mobile, remote station, remote terminal, access terminal, user terminal, user agent, user equipment, etc. The term mobile station is also used to denote other devices including, but not limited to, a multimedia player, mobile communication device, node in a broadband wireless access (BWA) network, smartphone, PDA, PND, Bluetooth device, cellular phone, smart-phone, handheld communication device, handheld computing device, satellite radio, global positioning system, laptop, cordless telephone, Session Initiation Protocol (SIP) phone, wireless local loop (WLL) station, handheld device having wireless connection capability or any other processing device connected to a wireless modem. A mobile station normally is intended to be used in motion or while halted at unspecified points but the term as used herein also refers to devices fixed in their location.

The term ‘vehicle’ or ‘automotive’ as used herein refers to any automotive vehicle or other automotive apparatus, machine, device, mechanized equipment or craft in which the presently disclosed system may be useful. Such usage includes private or commercial passenger vehicles, such as cars, trucks and buses, cargo and other commercial vehicles, tractors and other farm equipment, as well as aircraft and watercraft.

The term ‘operator’ or ‘driver’ refers herein to any person or crew who operates such a vehicle or who may be equipped or potentially recognized by the presently disclosed system to be an authorized operator, driver or user of such a vehicle. The term ‘on-board’ or ‘internal’ refers herein to being carried aboard, upon or within a vehicle. Conversely, the term ‘external’ or ‘outboard’ refers herein to being exterior to and/or remote from a vehicle.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels, touch screen or other user input means. Examples of multimedia devices include pocket sized personal digital assistants (PDAs), personal navigation assistants (PNAs), personal navigation devices (PNDs), personal media player/recorders, cellular telephones, handheld devices, digital readers (e-readers) and the like.

The term radio access communications device, radio access communications system or radio access communications transceiver is defined as any apparatus, device, system or mechanism adapted to transmit, receive or transmit and receive data through a medium. The communications device or communications transceiver may be adapted to communicate over any suitable medium, including wireless media. Such a device is adapted to access network resources and nodes through wireless radio means.

The term RX method is defined as the combination of algorithms and decoding methods used for reception of data by a receiving device such as an MS, UE or other communications capable device.

The term “vehicle form factor” is intended to refer to any portion of a vehicle's exterior or interior, such as external body surfaces, areas or volumes, interior portions of the vehicle, hood, roof, trunk, engine compartment, side panels, doors, windows, windshields, etc. The terms integrated and embedded are intended to refer to the incorporation of the VCS or portions thereof into the structure and form factor of the vehicle such that they combine in any or all manner (mechanical, electrical, electromagnetic (e.g., MAS, etc.), protocol, bus, software, hardware, vehicle system interoperability (e.g., CALM, CAN, etc.), coexistence, etc.) into a single unified system capable of interoperating and functioning cooperatively.

The word ‘exemplary’ is used herein to mean ‘serving as an example, instance, or illustration.’ Any embodiment described herein as ‘exemplary’ is not necessarily to be construed as preferred or advantageous over other embodiments.

Some portions of the detailed descriptions which follow are presented in terms of procedures, logic blocks, processing, steps, and other symbolic representations of operations on data bits within a computer system. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical and/or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the mechanism, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices or to a hardware (logic) implementation of such processes.

The mechanism can take the form of an entirely hardware embodiment, an entirely software embodiment or an embodiment containing a combination of hardware and software elements. In one embodiment, a portion of the mechanism can be implemented in software, which includes but is not limited to firmware, resident software, object code, assembly code, microcode, etc.

Furthermore, the mechanism (or portions thereof) can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (embedded or removable in the form of, e.g., USB flash drive, SDIO module, etc.), ROM, EPROM, or other volatile and non volatile semiconductor memory devices.

### Vehicle Integrated Communications System

In one embodiment, the vehicle integrated communications system comprises a core cellular communications system that can function as platform for any number of vehicle based applications. The core cellular communications system is described in detail infra Several infrastructure applications are described that are built on top of the core cellular communications system. Examples of the applications include: dumb and smart repeaters, mobile and inverted femtocells and an infotainment system.

Conventional femtocells are small access points that are located at the home or SOHO and connected via the Internet wired infrastructure to the access network. These femtocells were developed in response to the cell edge/coverage problem described supra. The UEs themselves have not been a focus of development regarding the cell edge/coverage problem due to several reasons, including: (1) most of the UEs are hand held mobile phones with small form-factors that dramatically reduce diversity and MIMO efficiency due to antenna co-location and correlation; (2) UEs are battery powered with reduced power available for processing of complex algorithms and multiple RF chains; and (3) UEs are basically low cost devices with reduced size of ICs and no bill of material (BOM) budget for multiple RF chains.

In one embodiment, one approach to the cell edge/coverage problem uses techniques such as adaptive modulation and coding along with adaptive precoding in the transmitter of a spatial multiplexing multi-antenna cell. In addition automatic repeat request (ARQ) and hybrid ARQ (H-ARQ) can also be utilized.

In another embodiment, the cell edge/coverage problem is addressed by using repeater/relays which forward a received signal towards a specified user (or group of users) with lower power than normally required from the central BS. Consequently, the level of interference experienced in areas far from the repeater/relay but still in the main BS coverage is reduced along a reduction in the transmit signal power required from the BS. Furthermore, users would typically receive higher quality signals carrying higher rates of information while using fewer cellular resources with respect to a conventional BS-user link (e.g., transmission time, frequency bandwidth and/or spatial streams). Such a scenario is beneficial for the entire network.

In particular, the vehicle integrated communications system provides several solutions to the cell-edge/coverage problem including: (1) a vehicle integrated cellular communications system that functions as a platform for vehicle related applications; (2) an RF domain dumb vehicle repeater (DVR); (3) a smart vehicle repeater (SVR) that incorporates two links of the same RAT, one towards the macro cell base station and the other towards the local served UEs; (4) a mobile femtocell that incorporates two links of the same RAT, one towards the macro cell base station and the other towards local served UEs; (5) an inverted femtocell where the backhaul is through the cellular link and end users are served through a local wired or wireless link via any suitable standard, such as, WiFi, Bluetooth, Wireless USB, Ethernet, USB, etc.; and (6) a vehicle mounted infotainment system (VIS) that incorporates a cellular communication system that is directly integrated into the vehicle system network. Each of these solutions is described in more detail infra.

### Vehicle Integrated Cellular Communications System Platform

Wireless communication has become, in recent years, an inseparable part of our daily lives. We encounter and use such communication in almost every conceivable scenario and expect it to present maximum performance capacity creating an expectation of an “always connected” state of being. New applications and services based on wireless technology are being introduced on a daily basis as the functionality and features of mobile phones, base stations and multimedia devices are dramatically increasing. The pace of innovation is immense, forcing integration technologies.

While wireless communications opens a wide range of business opportunities for businesses and manufacturers, however, possible applications are restricted to available bandwidth. Bandwidth availability is becoming a serious obstacle to further development of related services and applications when users are on the move (i.e. in cars, buses, trains, etc.)

One goal of the mechanism is to enhance aggregated cell spectral efficiency in the 3G and 4G (e.g., UMTS, HSPA, LTE, LTE-Advanced, WiMAX, etc.) macro-cell (i.e. outdoors environment: urban, sub-urban and rural areas) network environment to a level that enables a homogenous quality of service user experience, increased cell average and edge spectral efficiency, through synergy and overall integration between the vehicle platform and Broadband Wireless Access (BWA) User Equipment (UE) terminals.

It is noted that the mechanism discloses concepts applicable to any Radio Access Technology (RAT). For illustration purposes, the focus in this document is on OFDMA based RATs such as LTE and WiMAX in analysis, simulations and specific algorithm development. MIMO-OFDMA based RATs such as WiMAX and LTE represent current state of the art technology and the evolution path to fourth generation technologies such as IMT-Advanced.

It is a well known characteristic of 3G and 4G cellular systems that a spectral efficiency gap exists between the cell center and the cell edge, as shown in FIG. 22 for static (trace 410), mid-speed (trace 412) and high-speed (trace 414) profiles. As indicated, high mobility of the user in the macrocell environment further degrades overall spectral efficiency.

A vehicle based wireless terminal enjoys the potential advantages of size, enhanced user interface and power availability. The Vehicle Integrated Communications System (referred to simply as Vehicle Communications System or VCS) exploits these advantages to offset throughput degradation due to high vehicle speed and cell-edge/coverage limitations. The improvement in communications performance contributes to overall network efficiency and capacity. Use of VCS in networks will allow operators and users to increase Wireless Broadband Access (WBA) utilization and usage while enabling a wide range of applications and services ranging from infotainment to state of the art Intelligent Transport Systems (ITSs).

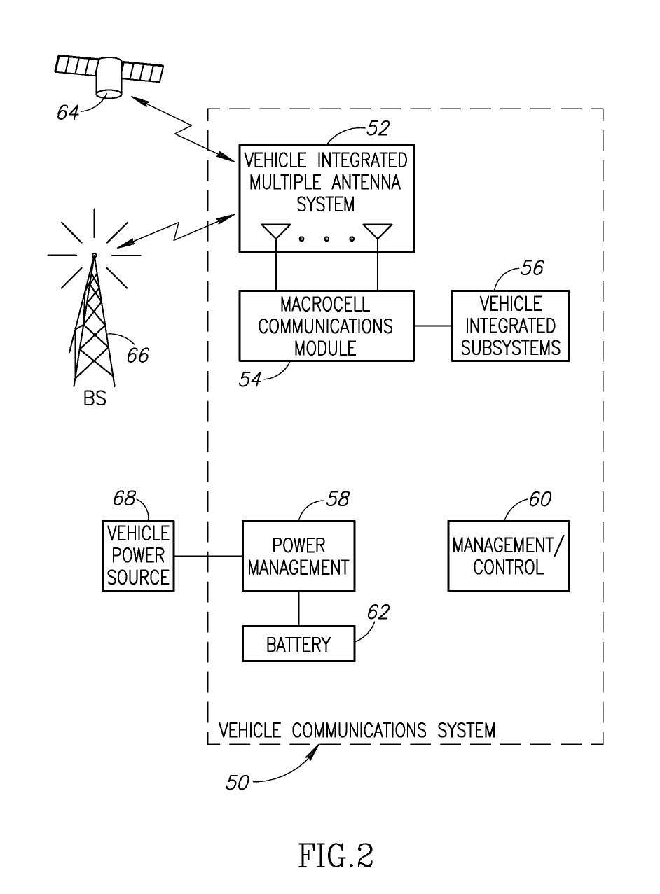

A high level block diagram illustrating the components of an example vehicle communication system is shown in FIG. 2. The VCS, generally referenced 50, comprises a macrocell communications module 54, vehicle integrated multiple antenna system (MAS) 52, vehicle integrated subsystems 56, power management module 58, battery 62 and management/control block 60.

In operation, the macrocell communications module functions to provide the core communications link with the network. In one embodiment, the core communications link comprises a cellular link that is established between the VCS and the cellular base station 66. In an alternative embodiment, the core communications link comprises a satellite link that is established between the VCS and a satellite communications system 64. Note that for illustration purposes, the description of the VCS and various applications infra refers to a cellular communications system. It is appreciated, however, that other types of communications systems are also contemplated (e.g., satellite, etc.) and can be used with the VCS.

The MAS, described in more detail infra, comprises a plurality of antennas that are integrated into the body of the vehicle. Numerous benefits are gained from integrated a plurality of antennas into the vehicle platform. The power management module comprises circuitry operative to manage the charging and discharging of the optional battery 62 and to provide power to the VCS and its various components. The source of power for the VCS is primarily the vehicle power system 68 to which the VCS is connected to. Backup battery 62 provides power in the event vehicle power is not available. Management and control block 60 provides overall administration, configuration, management and control functions for the VCS. Additional optional power sources (not shown) may be provided each with its own power limitations, including: an aftermarket speaker phone with power output capability, DC/DC power source, and any bus powered power source (e.g., USB device in bus powered mode).

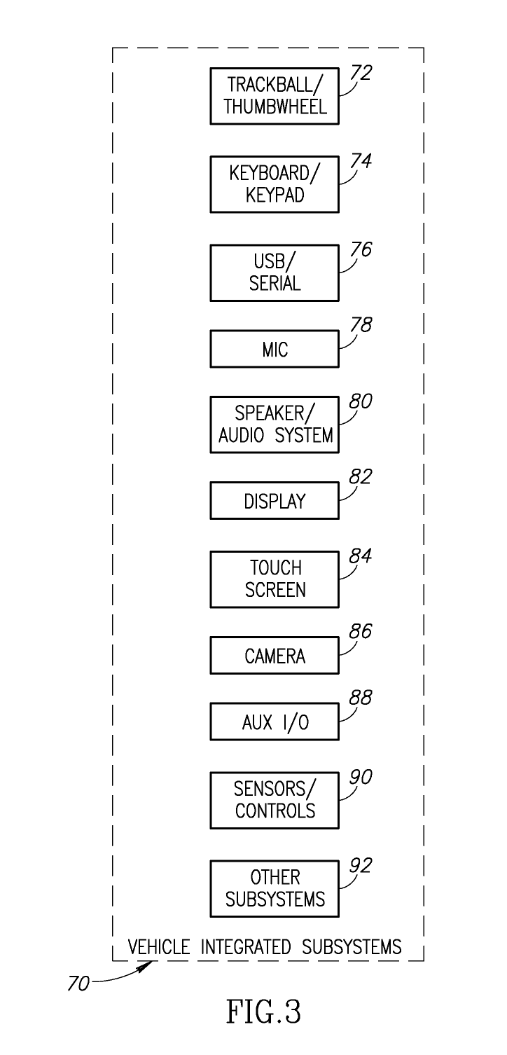

Note that the cellular communications system platform embodiment of the VCS shown in FIG. 3 can operate independently on its own providing cellular communications as a vehicle “UE” to occupants of the vehicle. Alternatively, in other embodiments, the cellular communications system platform can be used as the base for implementing several vehicle based communications applications including, for example, a repeater, femtocell and infotainment system, as described in more detail infra.

A high level block diagram illustrating the vehicle integrated subsystems in more detail is shown in FIG. 3. The vehicle integrated subsystems, generally referenced 70, comprise user-interface devices, controls, etc. that may or may not be integrated into the vehicle (i.e. in the body, dashboard, door, floor, roof, etc. A trackball/thumbwheel 72 may comprise a depressible thumbwheel/trackball that is used for navigation, selection of menu choices, confirmation of action, music selection, etc. Keypad/keyboard 74 may be arranged in QWERTY fashion for entering alphanumeric data and/or may comprise a numeric keypad for entering dialing digits and for other controls and inputs. The keyboard may also contain symbol, function and command keys such as a phone send/end key, a menu key and an escape key. A serial/USB or other interface connection 76 (e.g., SPI, SDIO, PCI, USD, etc.) provides a serial link to a user's PC or other device such as iPod, iPhone, iPad, etc. One or more microphones 78 may be integrated in the vehicle's interior for use in voice/video calling, voice commands to the VCS, etc. Speakers/audio system 80 and associated audio codec or other multimedia codecs are used to play back music, for voice/video calling, for VCS generated voice feedback, etc. A display 82 and associated display controller can be provided to display system and user information. A touch screen 84 and associated display controller may comprise a touch sensitive display providing both display and user input functions. A camera and related circuitry 86 may be provided for use in video calling, etc. Auxiliary I/O 88, any number of embedded sensors and controls 90 and other subsystems 92 may be provided.

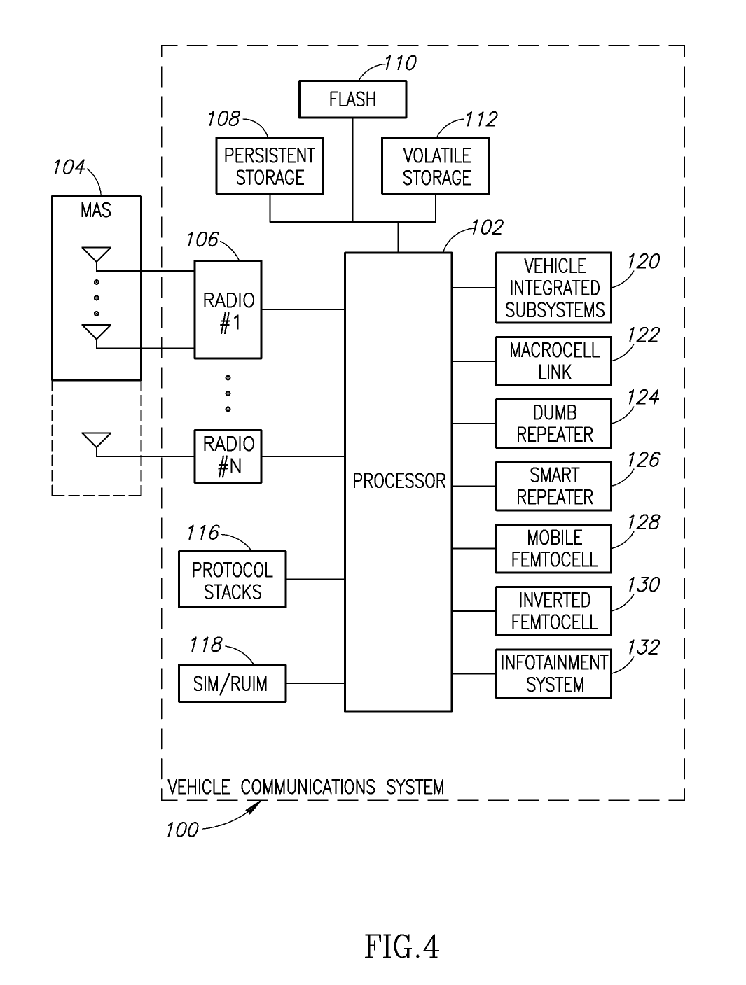

A block diagram illustrating the functional blocks of an example vehicle communication system in more detail is shown in FIG. 4. The VCS is a two-way communication device having voice and data communication capabilities. It can serve in a standalone configuration providing cellular voice and data capabilities for vehicle occupants. In addition, it can function as a platform upon which various vehicle based applications can be implemented, such as repeaters, femtocells and infotainment systems. The VCS may have the capability to communicate with other computer systems via the Internet. Note that this example of the VCS is not intended to limit the scope of the mechanism as VCS can be implemented in a variety of vehicle based applications. It is further appreciated that VCS 100 shown is intentionally simplified to illustrate only certain components, as the VCS may comprise other components and subsystems beyond those shown.

The VCS, generally referenced 100, comprises a processor 102 which may comprise one or more baseband processors, CPUs, microprocessors, DSPs, etc., optionally having both analog and digital portions. The VCS may comprise a plurality of radios 106 and associated antennas 104. Note that in the example of FIG. 4, a multiple antenna system (MAS) 104 is shown connected to radio #1. Other radios may or may not utilize a MAS, depending on the particular implementation of the VCS. Radio #1 provides the link to the macrocell (i.e. basic cellular link) in accordance with a particular radio access technology (RAT). Other radios that implement other wireless standards and RATs may be included. Examples include, but are not limited to, Code Division Multiple Access (CDMA), Personal Communication Services (PCS), Global System for Mobile Communication (GSM)/GPRS/EDGE 3G; WCDMA; WiMAX for providing WiMAX wireless connectivity when within the range of a WiMAX wireless network; Bluetooth for providing Bluetooth wireless connectivity when within the range of a Bluetooth wireless network; WLAN for providing wireless connectivity when in a hot spot or within the range of an ad hoc, infrastructure or mesh based wireless LAN (WLAN) network; near field communications; UWB; GPS receiver for receiving GPS radio signals transmitted from one or more orbiting GPS satellites, FM transceiver provides the user the ability to listen to FM broadcasts as well as the ability to transmit audio over an unused FM station at low power, such as for playback over a car or home stereo system having an FM receiver, digital broadcast television, etc. In addition, other radios may comprise Dedicated Short Range Communications (DSRC), IEEE 802.11p and IEEE 1609 which are all examples of current wireless radio standards developed to enable short range vehicle to vehicle, vehicle to infrastructure and vehicle to roadside communications.

The VCS comprises one or more vehicle integrated subsystems 120 described in FIG. 3 supra. The VCS also comprises protocol stacks 116, which may or may not be entirely or partially implemented in the processor 102. The protocol stacks implemented will depend on the particular wireless protocols required. The VCS also comprises internal volatile storage 112 (e.g., RAM) and persistent storage 108 (e.g., ROM, magnetic hard disk, etc.) and flash memory 110. Persistent storage 108 also stores applications executable by processor 102 including related data files used by those applications to allow the VCS to perform its intended functions. Applications include for example, code and any related hardware 122 to implement the macrocell link, code and any related hardware 124 to implement a dumb repeater, code and any related hardware 126 to implement a smart repeater, code and any related hardware 128 to implement a mobile femtocell, code and any related hardware 130 to implement an inverted femtocell and code and any related hardware 132 to implement an infotainment system. SIM/RUIM card 118 provides the interface to a user's (vehicle occupant's) SIM or Removable User Identity Module (RUIM) card for storing user data such as address book entries, user identification, etc.

Operating system software executed by the processor 102 is preferably stored in persistent storage 108, or flash memory 110, but may be stored in other types of memory devices, such as a read only memory (ROM), hard disk storage or similar storage element. In addition, system software, specific device applications, or parts thereof, may be temporarily loaded into volatile storage 112, such as random access memory (RAM). Communications signals received by the VCS may also be stored in the RAM.

The processor 102, in addition to its operating system functions, enables execution of software applications on the VCS. A predetermined set of applications that control basic VCS operations, such as data and voice communications, may be installed during manufacture. Additional applications (or apps) may be installed locally or downloaded from the Internet and installed in memory for execution on processor 102. Alternatively, software may be downloaded via any other suitable protocol, such as SDIO, USB, network server, etc.

When required network registration or activation procedures have been completed, the VCS may send and receive communications signals over a communications network (cellular, satellite, etc.). Signals received from the communications network by MAS 104 are processed by radio circuit 106. Processing includes, for example, signal amplification, frequency down conversion, filtering, channel selection, etc., and may also provide analog to digital conversion, synchronization, demodulation, decoding, decryption, etc. Analog-to-digital conversion of the received signal allows more complex communications functions, such as demodulation and MIMO decoding to be performed. Signals to be transmitted are processed and transmitted by the radio circuit 106, including digital to analog conversion, frequency up conversion, filtering, amplification and transmission to the communication network via MAS 104.

In accordance with the mechanism, the VCS 100 is adapted to implement the core communications link and any applications built thereon as hardware, software or as a combination of hardware and software. In one embodiment, for example, the VCS is implemented as a software task. The program code operative to implement the VCS is executed as a task on the processor and either stored in one or more memories 108, 110 or 112 or stored in local memories within the processor 102.

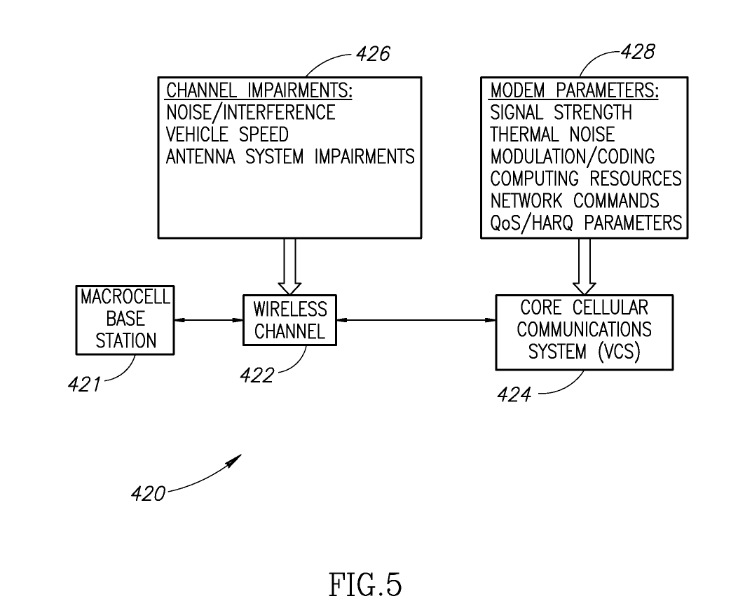

The performance advantage of the VCS can be illustrated by considering a Down Link (DL) communications model configured according to LTE specifications as shown in FIG. 5. The model, generally referenced 420, comprises a macrocell base station 421, wireless channel 422 and core cellular communications system (VCS) (i.e. cellular or satellite modem) 424. The base station 420 transmits a single signal or multiple signals (SIMO or MIMO configuration). The signal travels through the wireless channel 422 to the modem 424. The channel may be configured to exhibit one or more channel impairments 426 including noise and interference conditions. The channel is also configured to emulate various vehicle speeds and UE antenna system impairments (e.g., antenna correlations). The baseband receiver (modem) detects the signal and reports the throughput.

The improvement in link level performance attained by use of the VCS results in enhancement of overall cell and network capacity. This is achieved by the use of a large span MAS, an efficient multi-antenna capable transceiver, efficient processing of multiple MIMO RF signals and efficient processing of advanced interference mitigation and dynamic channel estimation algorithms.

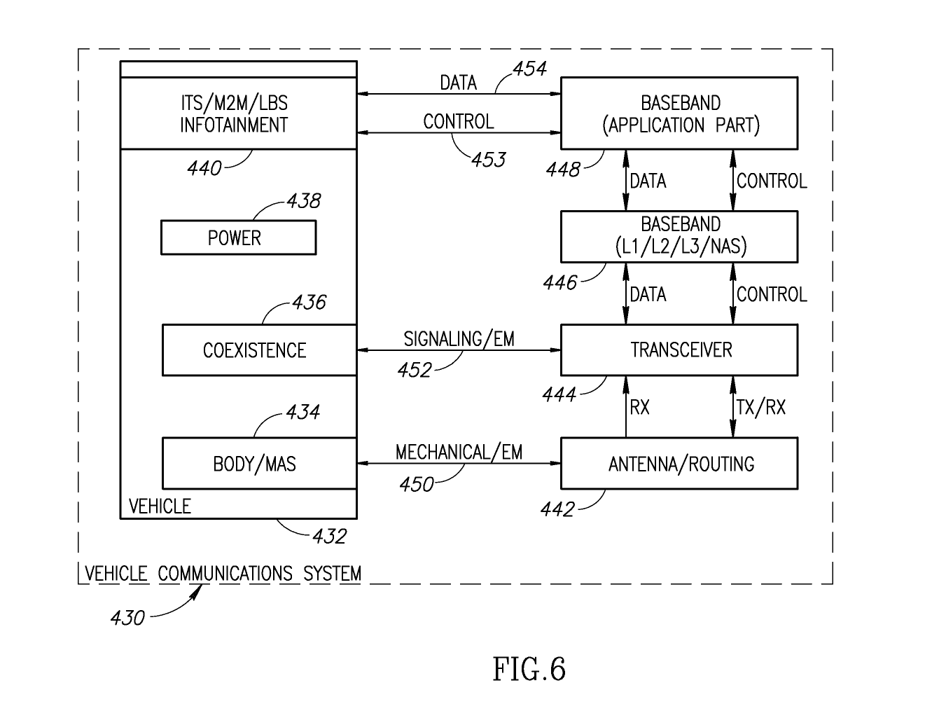

A feature of the VCS is that the communications components are integrated into the vehicle platform. A block diagram illustrating the system level integration in an example vehicle communications system implementation is shown in FIG. 6. The VCS, generally referenced 430, comprises a vehicle portion 432 comprising MAS 442 integrated into the automotive body 434, coexistence management 436 that functions to coordinate transceiver operation through dedicated signaling 452, power source 438 which provides energy to the entire system and ITS/M2M/LBS and infotainment 440 which are integrated with the baseband via data and control interfaces 454 and 453, respectively. Antenna/routing 442 corresponds to body/MAS 434 (mechanical arrow 450). Transceiver 444 corresponds to coexistence 436 (signaling arrow 452). The transceiver communicates with the baseband layer 446 which communicates data and control signals with the baseband 448 (i.e. the application part). The baseband communicates data 454 and control 453 information to the ITS/M2M/LBS and infotainment layer 440.

In integrating a plurality of antennas into the vehicle platform, minimum modifications to the vehicle platform are made to avoid the ill effect of additional cost, achieve high robustness, effective maintenance and a reduction in electromagnetic interference to both vehicle components as well as communications.

In integrating the communications transceiver, coexistence considerations of the transceiver and RF filtering take into account typical wireless services and applications in use today and those anticipated in the future, including GPS/Galileo, wireless sensor networks, ITS, etc. Considerations in efficient integration of the baseband with the transceiver include maintaining coexistence functionality with other wireless standard and integrating control and data planes with vehicle related services and infotainment systems. Considerations in power supply and distribution include electronic characteristics and power distribution to the communications system using the vehicle power system as the power source.

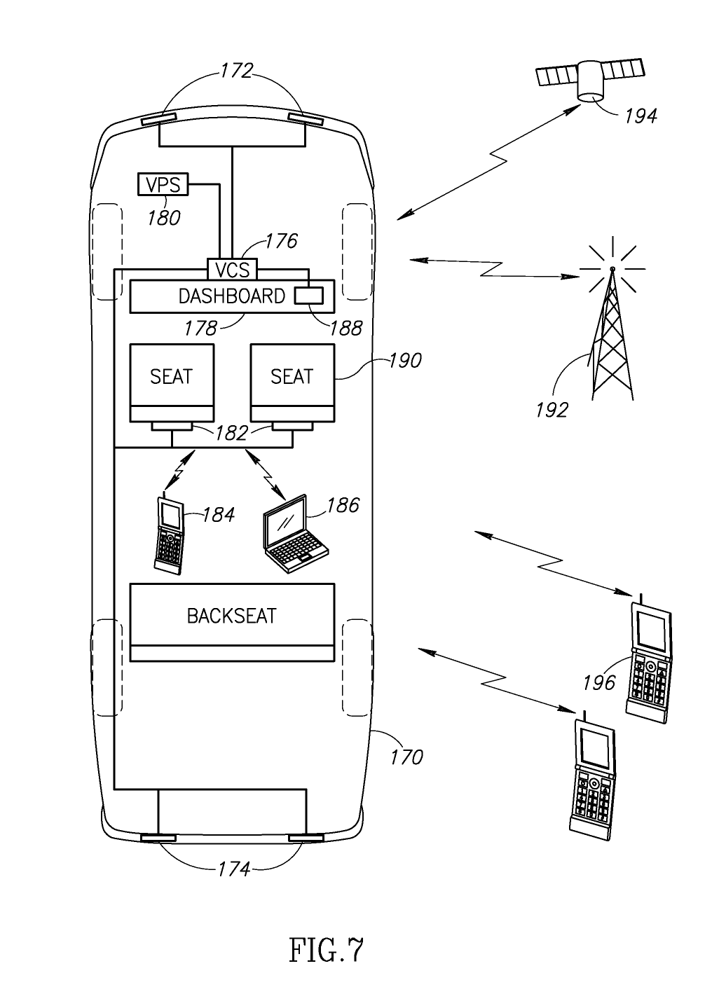

A diagram illustrating example placement of antennas and infotainment system terminals in a vehicle is shown in FIG. 7. The example placement of VCS components in the vehicle 170, including infotainment terminals is shown. The VCS components comprise, VCS module 176, antennas 172 integrated into the front bumpers, antennas 174 integrated into the rear bumpers, a connection to the vehicle power source (VPS) 180, infotainment terminals 182 integrated into the seats 190 and user interface 188 integrated into the dashboard or other suitable location in the vehicle. The VCS is operative to communicate with one or more vehicle occupant UEs 184, 186 as well as UEs 196 in the neighboring vicinity of the vehicle and provide a backhaul communications link to the cellular base station 192 (or satellite system 194).

The multi antenna system (MAS) is sparse and embedded in the vehicle in such a way that the individual antennas are sufficiently remote from each other. Further, the number of antennas is considerable, four or more in the typical case. The RF transceiver in the VCS module 176 processes the transmitted and received signals. The VCS accommodates multi-antenna signal efficiency and coexistence with vehicle and wireless connectivity systems. The baseband is capable of processing multi antenna signals efficiently. Superior baseband performance in interference cancellation and in high mobility conditions attained reduces the gap between the cell edge and cell center to achieve superior quality of experience and improved over all cell capacity.

The core communications link interfaces with in-vehicle infotainment and other Intelligent Transport System (ITS) to provide seamless and efficient integration. VCS components enjoy a virtually infinite power supply provided by the vehicle power source when compared with handheld battery powered terminals. This major advantage enables long connectivity sessions and the utilization of far more complex algorithms. The improved user performance attained contributes to overall cell and network capacity as well as Quality of Service (QoS) management in the network.

In one embodiment, the MAS comprises at least four antennas, although any number of antennas may be used. The baseband PHY and MAC layers are adapted to process multi-dimensional signals efficiently, cancel interference, implement adaptive modulation and coding, utilize dynamic channel modeling and estimation to achieve in 3GPP LTE, for example, at least a factor of two improvement in throughput in static and high vehicle speed in presence of one strong interferer.

As described supra, performance at the edge of a cell is significantly degraded compared to performance in the cell center. In an LTE example, the cell spectral efficiency in an urban area is estimated at 2.1 bps/Hz/cell and only 1 bps/Hz/cell at high speed. This compares with a theoretical peak performance of 7 bps/Hz/cell. At the cell-edge, LTE performance is reduced to less then 30% compared to the peak near the cell center.

In one embodiment, the approach to boosting capacity performance is to use small cell sites and repeaters. In such systems, the User Equipment (UE) comprises one or two antennas, with slow adaptation to facilitate maximum MIMO performance and the requirement to handle a moderate interference level. In the VCS, the UE terminal is integrated into the vehicle as a platform.

In one embodiment, the focus of the VCS is on the cell edge and the cell average and not necessarily the peak throughput. Due to the geometry of the cell, the majority of users are located at a cell edge “ring”. Therefore, increasing performance at the cell edge by use of the VCS raises the cell average throughput. Wireless network operators are not required to invest in upgrading their network (i.e. the infrastructure side) since the VCS is implemented on the UE side. The VCS, on a first level, does not require modifications to any wireless standards. It is fully compatible with existing specifications such as LTE or WiMAX. Thus, it has minimal impact on networks and users. Further, enhancements can be specified to achieve even more efficiency and quality.

Benefits of the VCS include encouraging greater use of wireless broadband in the automotive industry. The VCS can be the driver of a new class of vehicle related services and applications, such as in the areas of machine to machine, location based services, remote diagnostics, Intelligent Transport Systems and in-vehicle infotainment. The VCS and related mechanisms may drive macro deployment of wireless broadband data access networks such as WiMAX, LTE and LTE-Advanced.

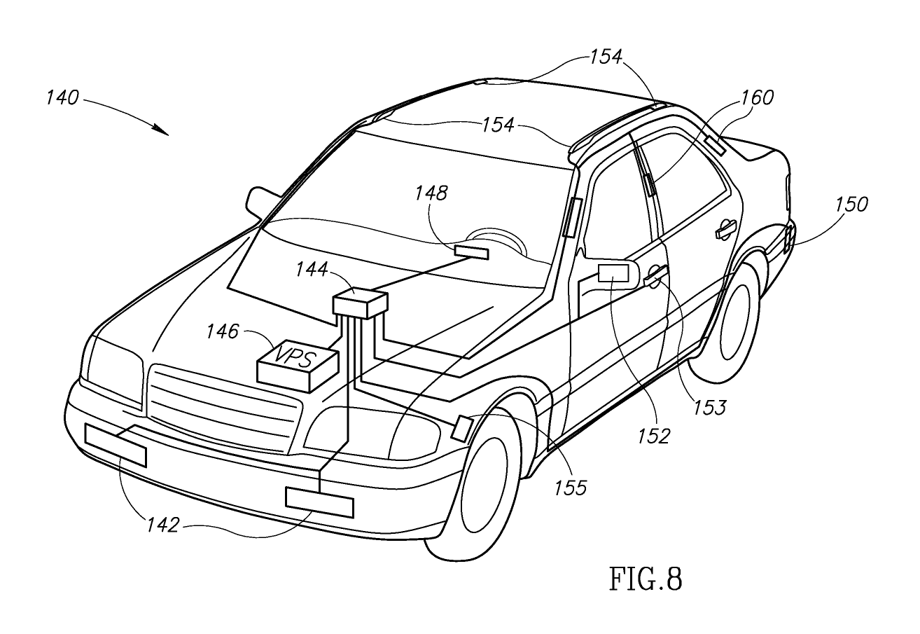

A diagram illustrating an example placement of the components making up the vehicle communications system is shown in FIG. 8. In this example component placement, the vehicle, generally referenced 140, comprises the VCS module 144 connected to various antennas, controls and a user interface. The VCS module 144 receives electrical power from the vehicle power source (VPS) 146. It is also connected to a multiple antenna system (MAS) comprising a plurality of antennas integrated into the vehicle in various locations, including antennas 154 integrated into the roof racks, antennas 152 integrated into the side view mirror, antennas 142 integrated into the front bumper, antennas 150 integrated into the rear bumper and antennas 160 integrated into the roof pillars. A user interface 148 (e.g., display, touch screen, keypad, microphone, speaker, etc.) is integrated into the dashboard of the vehicle. The VCS module 144 is also connected to one or more sensors (e.g., car door handle sensor 153, wheel speed sensor 155, etc.).

### Multiple Antenna System (MAS)

The VCS provides significantly improved antenna performance by use of a multiple antenna system (MAS) comprising a plurality of antennas integrated into the vehicle platform. An antenna is a passive element designed to convert current to traveling electromagnetic (EM) wave. It does not generate power, however, but just alters the EM wave's distribution in space. The performance of an antenna is determined in part by its interface to the radio circuitry and the shape and materials of the antenna and its package or surrounding. Due to reciprocity there is a constant ratio (independent of the antenna type and size) between the TX gain and RX effective area (analog to gain in the TX) or aperture. Therefore, only transmission parameters are discussed herein. The relevant antenna parameters include gain, efficiency, bandwidth, center frequency, polarization and power handling capability. Each is discussed below beginning with gain.

Antenna Gain

Antenna gain is usually written in terms G(θ, φ) where θ (theta) is the horizontal angle in the range [0, 2π] and φ (phi) is the vertical angle in the range [0, π]. That is, antenna gain varies in space. The 3D gain distribution of G(θ, φ) is referred to as the antenna pattern and is depicted graphically in either 2*2D plots or a 3D like plot. In an isotropic antenna, the gain is one in all directions (a single lobe shapes as a sphere), an ideal theoretical reference. A dipole antenna has an omni directional pattern, that is, it has a symmetrical shape in one plane and a figure eight like shape in the perpendicular. This antenna pattern is doughnut-like called a toroid in mathematical terms. Other antenna types such as Yagi and patch are directional antennas, meaning their gain is much larger than one at some angles (called also beams or lobes), but very small in all other directions. Note that G(θ, φ) is measured for the main lobe in dBi, that is, relative to an isotropic antenna.

Hand held terminals may be placed in any direction and orientation in space depending on their usage as a voice or data terminal. When Bluetooth or WiFi are concurrently enabled, for example, the terminal may be located in a pouch or a bag. In this case, it is impossible to know the orientation of the terminal in advance. Hand held terminals usually utilize whip antennas with a load coil or a dual MIMO antenna system. In either case, the antenna pattern is omni directional. In use of a typical hand terminal, the human body interacts with the antenna through reflection and absorption (i.e. loss). Typically, due to its small size, the maximum gain of a hand held terminal antenna is less than 0 dBi. Thus, since there is no control over a terminal's orientation in space, the effective antenna gain in the direction of the base station or a major reflector could be very low.

In the VCS, vehicle (e.g., automotive) antennas are built into (i.e. integrated) into the vehicle platform by the vehicle manufacturer (or aftermarket installation). These antennas have a predefined vehicle body effect and a predefined orientation in space (as determined by the road itself). In addition, the size of antenna available in many cases is significantly larger than that available in a hand held device.

The antennas in the MAS are preferably constructed so as to not expose vehicle occupants to transmit energy. The vehicle mounted antennas in the MAS, are directional antennas, whose main lobes point outwards from the vehicle interior and are sufficiently narrow to minimize overlap with other antennas. The antenna patterns between the antennas in the MAS may differ from one another due to the vehicle form and antenna locations which may not be symmetrical. The antenna gain in the main lobe is typically 3 to 6 dB higher than that of a hand held antenna. A vehicle mounted antenna when placed on the vehicle roof top may comprise an omni directional antenna. Even in this case, the antenna pattern is typically still better than that of a hand held antenna since its directivity can be controlled for the vertical plane.

Table 1 below provides a comparison of various gain characteristics of hand held antennas and those for use in the MAS in the VCS.

TABLE 1
Comparison of various gain characteristics between
hand held and vehicle integrated antennas

| Characteristic | Hand held antenna | Vehicle integrated antenna | Comment |
|---|---|---|---|
| Main lobe gain | Less than 0 dBi | At least 3 to 6 dBi | |
| Antenna pattern | Omni directional | Directional | In MIMO systems, |
| | | | hand held antennas |
| | | | may have more |
| | | | directivity, but the only |
| | | | factor is the relative |
| | | | location of the |
| | | | antennas. Body effect |
| | | | and BS antenna |
| | | | location cannot be |
| | | | taken into account. |
| Surrounding | Difficult to control | The main factor (vehicle | A hand held may be |
| environment and | | body) is known in advance | placed on a table, in a |
| packaging | | | bag, in a pouch or held |
| | | | by hand. |
| Vehicle body | Reduced signal | Located on the outmost | |
| penetration | strength while | surface or on a non | |
| | passengers are | conducting material. | |
| | inside the vehicle | | |

Antenna Efficiency

Antenna efficiency is affected by conducting losses and reflection losses. Some loss of efficiency is due to the antenna pattern and the relative positions of the UE and base station as discussed supra. Antenna efficiency is mainly an integration related design issue. The main contributors to the conducting losses are feed cable length, conductive material in the antenna vicinity and the dielectric material. The antenna near field may come into interaction with circuitry in the antenna vicinity. Reflections are mainly related to bandwidth and to impedance matching between the antenna and the feed cable or circuit.

Table 2 below provides a comparison of various efficiency related characteristics of hand held antennas and those for use in the MAS in the VCS.

TABLE 2
Comparison of efficiency related characteristics
between hand held and vehicle integrated antennas

| Characteristic | Hand held Antenna | Vehicle integrated antenna |
|---|---|---|
| Conductive loss | Dielectric | Feed cables |
| | Near field effect | |
| | between transceiver | |
| | and antenna | |
| | Packaging and | |
| | surrounding | |
| Reflection loss | Matching | Matching |

Antenna Bandwidth and Band (Center Frequency)

The bandwidth of an antenna is determined by the antenna type and its design. Typically, larger form factors enable more room for design solutions that are in better fit with the requirements. Center frequency or band is a design parameter for the antenna.

Antenna Polarization

Antenna polarization relates to the orientation of the transmitted EM wave in space. More specifically, it is the direction of the electric field. Since base station antennas are vertical, optimum results are obtained with matched polarization at the UE (VCS) antenna. Note that sometimes base station antennas utilize polarization diversity. Even in this case, however, the polarization occurs across the vertical plane. The best efficiency is obtained for a vertical or near vertical antenna. Vehicles incorporate an inherent advantage in polarization because antennas can be integrated into the body so as to obtain good vertical polarization. Note that implementing polarization diversity in a vehicle has an advantage considering that roads and horizontal surfaces in other vehicles emit horizontally polarized EM waves.

Antenna Design Process for VCS Application

The Antenna design process incorporates several phases, including: (1) transceiver and antenna location determination; (2) modeling of the vehicle body (in terms of EM reflections, conduction and absorption); (3) determining the requirements of the various antennas (i.e. gain, efficiency, bandwidth, polarization, etc.), in addition to cost and manufacturing constraints; (4) specify antenna design to meet the requirements; (5) test and verification (antenna range) of the specific antenna integrated into the vehicle; and (6) testing and verification (antenna range) of the entire MAS as a whole.

Antenna Integration into the Vehicle Platform

Several example antenna configurations for the MAS are provided hereinbelow. Each antenna may comprise a multi-technology antenna module (e.g., different bandwidth) and/or multiband module (i.e. different center frequency).

Roof Top Antenna Placement

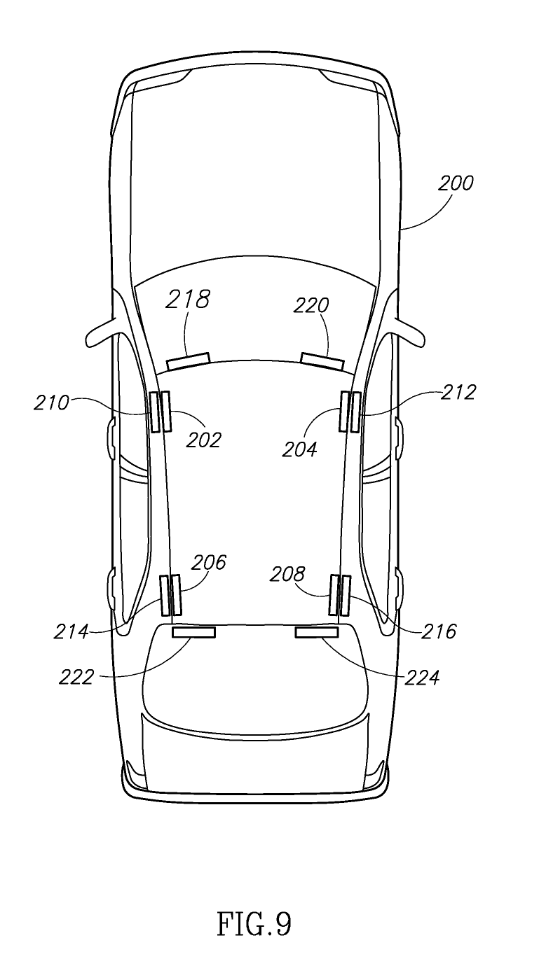

A diagram illustrating example placement of antennas on the roof top of a vehicle is shown in FIG. 9. This MAS antenna configuration is best suited for high frequency bands where the demand for line of site is most important. In general, this configuration provides optimal performance in any frequency band due to the larger distance from the ground to the antenna and being the most free of obstacle paths. Note that roof top antenna placement also includes roof racks and upper windscreens in both front and rear of the vehicle. Note also that the vehicle may comprise any suitable vehicle such as, for example, a private car, limousine, track, bus, convertible, van, agricultural machine, etc. The antenna type may comprise monopole, dipole, whip, patch or any similar type, depending on the particular implementation of the VCS.

As shown in FIG. 9, the example roof top placement comprises four to eight antennas in one of several configurations. In one configuration, the four antennas (202, 204, 206, 208) are integrated into the roof top and may comprise, for example, the GIDM-DB multiband cellular antenna manufactured by ZCG Scalar, Victoria, Australia (www.zcg.com.au). This configuration exhibits a high position, vertical polarization, relatively low cost and efficient configuration.

In a second configuration, the four antennas (202, 204, 206, 208) are integrated into the roof top and may comprise, for example, antennas detailed in I. Jensen, et al., “CVIS Vehicle Rooftop Antenna Unit”, published by the Cooperative Vehicle-Infrastructure Systems (CVIS) project, (www.cvisproject.org). This configuration exhibits a high position, vertical polarization, relatively low cost and efficient configuration.

In a third configuration, the four antennas (210, 212, 214, 216) are integrated into the roof top and may comprise, for example, antennas detailed in I. Jensen, et al., “CVIS Vehicle Rooftop Antenna Unit”, published by the Cooperative Vehicle-Infrastructure Systems (CVIS) project, (www.cvisproject.org). Note that the antennas in this configuration may be tilted at an angle to conform to the shape of the body of the vehicle.

In a fourth configuration, the four antennas (218, 220, 222, 224) may be printed on glass, plastic or embedded in the glass or plastic (e.g., the windshield) and may comprise, for example, antennas detailed in G. Huebner, et al., “Printed Antennas for Automotive Applications”, Issue No. 1, 2008, Science & Technology, pp. 35-39, published by International Circle of Educational Institutes for Graphic Arts Technology and Management, http://www.hdm-stuttgart.de/international_circle/circular/issues/08_{—}01/ICJ_{—}01_{—}35_huebner_petersen.pdf and in S. Lindenmeier et al., “Integrated Microwave Antenna Systems in Mobile Applications”, Institute of High Frequency Technology and Mobile Communication, University of Bundeswehr Munich, Germany. The VCS can take advantage of the extensive use of plastics in car design today. Since plastic does not shield RF signals, antennas can be integrated in plastic parts without damaging or influencing the surface of the part. Note that polarization of the antennas in this configuration is horizontal.

In a fifth configuration, antennas [(202, 204, 206, 208) OR (210, 212, 214, 216)] AND (218, 220, 222, 224) may be used. Antennas (218, 220, 222, 224) may be printed on glass, plastic or embedded in the glass or plastic as cited supra in articles by G. Huebner, et al. and S. Lindenmeier et al. Note that polarization of antennas (218, 220, 222, 224) in this configuration is horizontal.

In a sixth configuration, antennas [(202, 204) OR (210, 212) OR (202, 204, 206, 208) OR (210, 212, 214, 216) OR (202 OR 210 in the middle of the roof top, 206 OR 212 in the middle of the roof top)] AND (218, 220, 222, 224) may be used. Antennas (218, 220, 222, 224) may be printed on glass, plastic or embedded in the glass or plastic as cited supra in articles by G. Huebner, et al. and S. Lindenmeier et al. Note that polarization of antennas (218, 220, 222, 224) in this configuration is horizontal.

In a seventh configuration, antennas [(202, 204, 206, 208) OR (210, 212, 214, 216)] AND [(210, 212) OR (214, 216) OR (218, 220, 222, 224) OR (220 in the middle of the window or windshield, 224 in the middle of the window or windshield)] may be used.

In an eighth configuration, antennas (202 OR 210 in the middle of the roof top, 204 OR 212 in the middle of the roof top, 224 in the middle of the rear window or windshield) may be used.

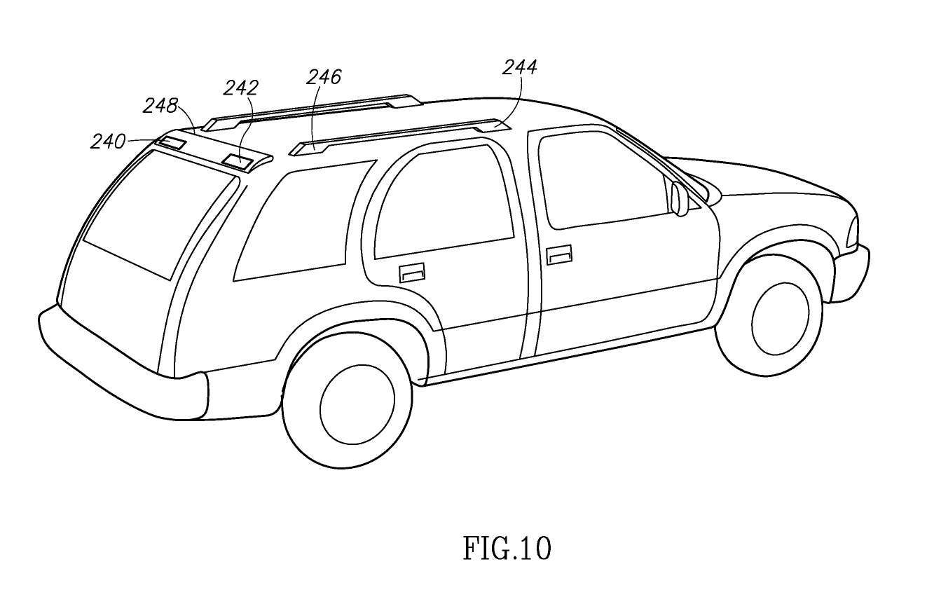

Note that in all the antenna configurations described supra, the group of antennas (202, 204, 206, 208) may be integrated into the endpoints of the roof rack bars rather than on the roof top as shown in FIG. 10. As an example, passenger side roof rack endpoints 246 and 244 are shown. In addition, alternate locations for antennas 222, 224 (FIG. 9) are 240, 242 (FIG. 10) which are integrated into a rear spoiler atop the rear window.

Advantages of the antenna integration configurations described supra include (1) they provide the highest possible location for the antennas; (2) they provide a relatively large separation distance between antennas; (3) mixing the antenna groups, i.e. (202, 204, 206, 208), (210, 212, 214, 216) and (218, 220, 222, 224), provides mixed antenna polarization along all three space axis: vertical, horizontal in the direction of driving and horizontal perpendicular to direction of driving; and (4) they integrate well into the structure of the car body.

Roof Pillar Antenna Placement

Roof pillars refer to the bars or other structures that function to form the passenger and driver compartment in a vehicle. Although the most applicable antenna type in this case is a patch antenna, any other type of antenna can be used that can be integrated with the conducting surface (i.e. ground) of the pillars.

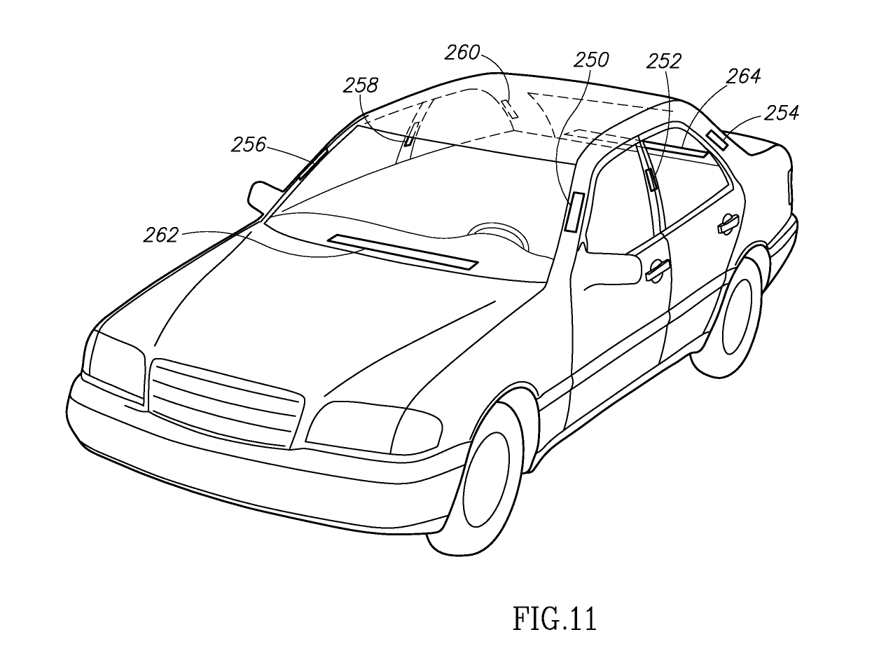

A diagram illustrating example placement of antennas on the pillars of a vehicle is shown in FIG. 11. The roof pillar antennas include antennas 250, 252, 254, 256, 258, 260 which may comprise a type in accordance with the integrated microwave antennas in S. Lindenmeier et al. cited supra in connection with FIG. 9 or similar type antenna (e.g., typically narrow shaped, mounted on a ground/conductive bar). Antennas 262 and 264 may comprise a printed or integrated antenna such as in G. Huebner, et al. cited supra.

Several useful antenna configurations are provided below as an example. In a first configuration, four antennas (250, 254, 256, 260) are used. This configuration results in a relatively high position, vertical polarization, low cost and efficient configuration. In a second configuration, four antennas (252, 258, 262, 264) are used. This configuration covers 360 degrees and provides dual polarization, is low cost and diverse. In a third configuration, six antennas (250, 254, 256, 260, 262, 264) are used. This configuration covers 360 degrees and provides dual polarization. In a fourth configuration, eight antennas (250, 252, 254, 256, 258, 260, 262, 264) are used. This configuration covers 360 degrees and provides dual polarization. Advantages of the above described antenna configurations include: (1) high location of the antennas; (2) large separation distance; (3) mixed polarization when antennas 262 and 264 are included in the configuration; and (4) good integration into the car body structure.

Lower Body Antenna Placement

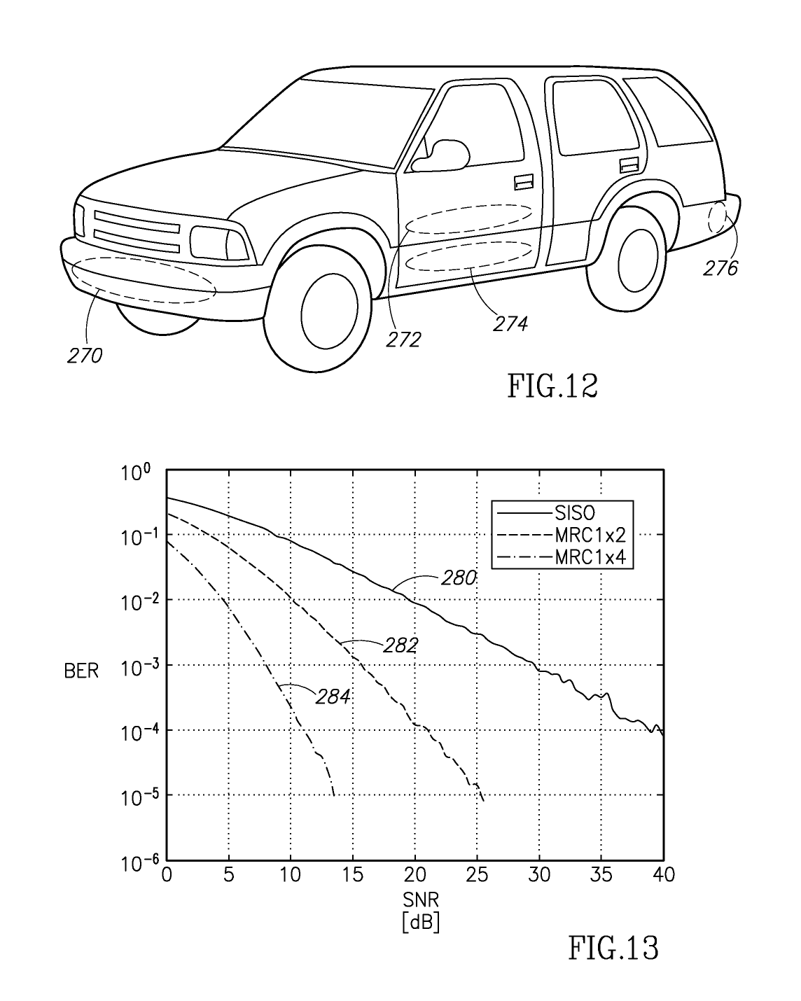

The antenna configurations in this group is the worst in terms of height position and blocking, but in compensation, benefits from the relatively large area that can be used. A diagram illustrating example placement of antennas on the lower body portions of a vehicle is shown in FIG. 12. As shown, the antenna placement locations comprise the front bumper 270, rear bumper 276, driver and passenger side mid panels 272 and lower panels 274. Note that although not shown completely, the rear bumper is also a large volume location. These lower vehicle body locations are of large area and volume locations that are well suited for integration of high performance antennas. As described supra, in heavy traffic (i.e. city driving), these vehicle body areas will most likely be blocked by other vehicles. In addition, these body areas are highly affected by the ground. This configuration does, however, have the benefit of a large antenna form factor that can provide a gain as high as 10 dB compared to a small antenna, but suffers from the worst antenna placement location. The antenna type typically used in this configuration comprises printed antennas, patch antennas, etc. with multiple polarization directions at these locations.

Note that the MAS as implemented and constructed by a vehicle manufacturer can select a combination of the above locations (i.e. roof top, roof rack, pillars, lower body panels/bumpers) subject to various considerations related to the overall vehicle design and system aspects.

### High MAS Antenna System Order

The MAS order (or rank) refers to the number of uncorrelated antennas that contribute to the communication system and effectively appear as a larger antenna apparatus. Several multi-antenna transmission and/or reception techniques may be used with the VCS, including: (1) antenna diversity (for TX and/or RX); (2) spatial multiplexing over MIMO channels; (3) beamforming; and (4) any combination of the above.

The multi-antenna transmission and reception techniques listed above present tradeoffs between increasing channel detection performance and data rate transmission. Increasing the diversity order of the TX/RX scheme increases the detection performance with antenna diversity and beamforming. With spatial multiplexing, the diversity order is reduced in order to increase data rates.

Antenna Diversity

Antenna diversity is commonly used to reduce the effects of multipath fading. Performance gains, however, diminish as the number of antennas used increases. Consider the two basic diversity forms: receive and transmit diversity. A diagram illustrating the receive diversity gain improvements as the number of antennas increases is shown in FIG. 13. The bit error rate (BER) curves for the SISO case (trace 280), maximal ratio combining (MRC) 1×2 (i.e. one TX antenna and two RX antennas) (trace 282) and MRC 1×4 (i.e. one TX antenna and four RX antennas) (trace 284) are shown. As is indicated, the BER performance gains diminish as the number of RX antennas increases.

The diversity gain is dependent of the combining algorithm. In one embodiment, selection combining is used whereby the strongest signal of N received signals is selected. When the N signals are independent and Rayleigh distributed, the expected diversity gain is given as

$${\sum }_{k = 1}^{N} \frac{1}{k} \qquad ( 1 )$$

expressed as a power ratio. Therefore, any additional gain diminishes rapidly with the increasing number of channels.

In another embodiment, maximal-ratio combining (MRC) (often used in large phased array systems) is used where the received signals are weighted with respect to their SNR and then summed. The resulting SNR is expressed as

$${\sum }_{k = 1}^{N} {SNR}_{k} \qquad ( 2 )$$

where SNRₖ represents the SNR of the received signal k.

In another embodiment, channel diversity may be increased by processing at the transmit side as described in S. M. Alamouti, “A Simple Transmit Diversity Technique for Wireless Communications”, IEEE Journal on Select Areas in Communications, vol. 16, no. 18, pp. 1451 1458, October 1998. Channel diversity can be increased by one of several methods. Commonly used methods are based on separating antennas in space (i.e. space-time coding (STC)). Antennas are placed far enough apart to be independent in terms of multipath fading experienced. Typically, the separation distance is preferably larger than the wavelength in order for the antennas to be uncorrelated. Other methods use different polarization. There is no antenna correlation when the polarizations of the antennas are perpendicular to each other. Another approach utilizes antenna direction where the antenna lobes cover different spatial angles.

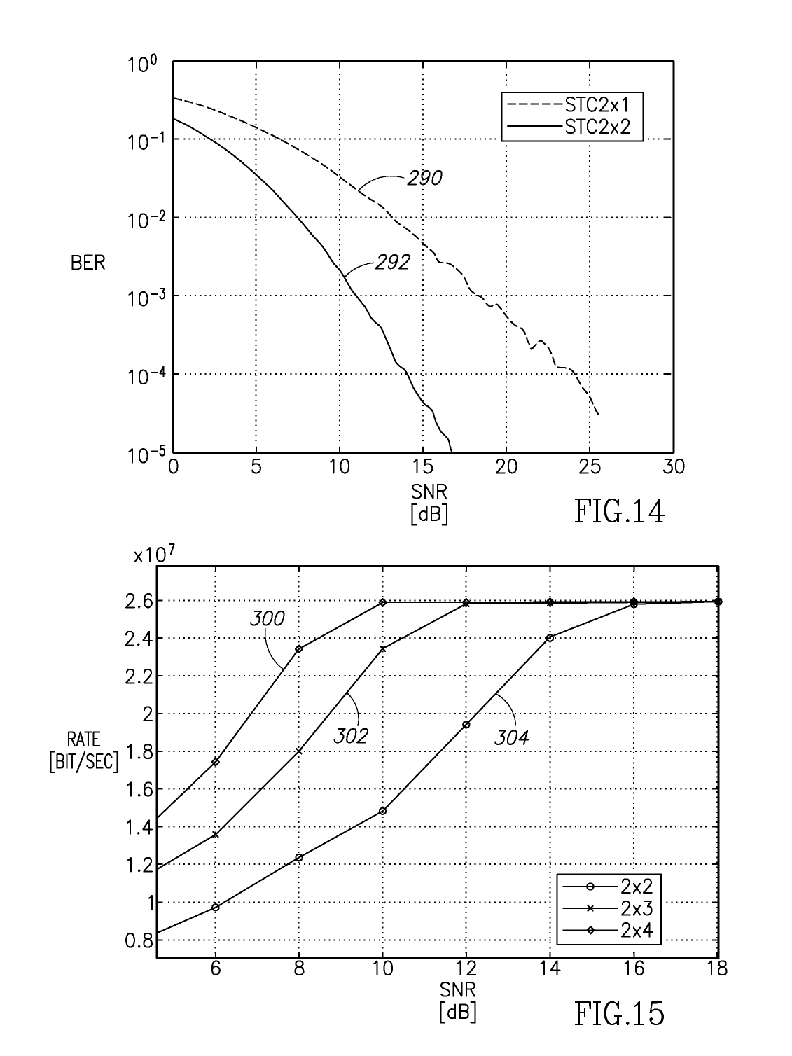

In another embodiment, additional gain is achieved utilizing both transmit and receive diversity. A diagram illustrating the STC gain improvement with and without receive diversity is shown in FIG. 14. The bit error rate (BER) curves for STC 2×1 (i.e. two TX antennas and one RX antenna) (dashed trace 290) and STC 2×2 (i.e. two TX antennas and two RX antennas) (solid trace 292) are shown. As indicated, BER performance gains are achieved with the addition of the second RX antenna to provide RX diversity. The total system gain is equivalent to the gain achieved by a receive diversity system of the order that is the multiplicity of both RX diversity and STC. Since it is typical of a base station to incorporate a multi-antenna system comprising two, four or more antennas, the MAS used in the VCS optimizes the performance at a system level and takes full advantage of the base station MAS infrastructure.

Spatial Multiplexing

Spatial multiplexing is a transmission technique in MIMO communications that transmits independent and separately encoded data signals from each of multiple transmit antennas to improve communications performance. In spatial multiplexing, a high rate signal is split into multiple lower rate streams and each stream is transmitted from a different transmit antenna in the same frequency channel. If these signals arrive at the receiver antenna array with sufficiently different spatial signatures, the receiver can separate these streams, creating parallel channels free.

Given a sufficiently high SNR and a MIMO channel that is rich with reflectors and multi-antenna systems on both the TX and RX sides, the total throughput of the channel is increased by SS=MIN(Kₜ, Kᵣ), where Kₜ represents the number of transmit antennas and Kᵣ the number of receive antennas. Note that it is assumed that there is a maximum limit to the throughput in the SISO configuration that is set by the RAT specifications. In spatial multiplexing, spatial streams are communicated at the same time. For example a MIMO system of 2×2 transmits two spatial streams. If the SNR is high enough, these two streams are configured to deliver the maximum throughput, thus doubling link capacity.

OFDMA based communications such as specified in IEEE standards 802.16e, 802.16m, 802.11n, LTE, LTE—Advanced, etc. are well suited for MIMO processing. For example, according to the LTE standard there are different evolved Node B (eNB) and UE categories. Base stations can incorporate two or four antennas while the UE may comprise a single antenna (CAT1), two antennas (CAT2 through CAT4) or four antennas (CAT 5), as described in Table 4.1-1 of 3GPP Technical Specification Group Radio Access Network, E-UTRA UE Radio Access Capabilities, 36.306, v9.0.0, December 2009.

Beamforming

Beamforming techniques creating antenna beams on the transmitter side that are directed in space into the receivers. In one beamforming technique, complex weighted (phase and sometimes gain) replicas of the same signal are emitted from each of the transmit antennas in the MAS such that the signal power is maximized at the receiver. A benefit of beamforming is that the signal gain from constructive combining is increased and the multipath fading effect is reduced. Note that in order to benefit from beamforming, the transmitter requires knowledge of the specific channel characteristics to each receiver.

The transmitter knowledge of the receiver(s) may be obtained in a TDD system through reciprocity (assuming both sides are transmitting frequently) or through information provided by the receivers to the transmitters through a full duplex control scheme. This added feedback, degrades the theoretical peak performance, since it is an overhead to the system and reduces capacity. A similar process is applicable at the receiver as well.

It is noted that several MIMO methods can be combined together. For example, spatial multiplexing can be combined with diversity or precoding (beamforming). One example may be closed loop MIMO where a precoding matrix is used to precode the symbols in the transmit vector to enhance performance. In this case transmitter knowledge of the link is utilized to implement precoding in a MIMO system. A similar method is Space Division Multiple Access (SDMA) where the radiation pattern of the base station, both in transmission and reception, is adapted to each user to obtain highest gain in the direction of that user, typically using phased array techniques at the base station.

On the receiver side, if Kᵣ>Kₜ, the additional receive antenna(s) can be used to enhance performance due to the increased diversity order. The graph in FIG. 15 illustrates the receive diversity and spatial multiplexing improvements with two (trace 304), three (trace 302) and four (trace 300) antennas is shown. The curves show bit rate as a function of SNR for receivers with two, three and four antennas. As indicated, performance improvements of 4 to 6 dB are attained.

Thus, use of a higher MAS order can benefit from the algorithms and techniques described hereinabove to provide improved communication performance over multipath fading channels. Since spatial multiplexing and beamforming techniques are utilized, the higher number of antennas provides a performance gain of 4 to 8 dB in fading channels and where many interferers are active. The final MAS order should preferably be determined by taking into account overall system and cost constraints. Preferably, a MAS order is in the range of four to eight antennas is optimal.

### Improved De-Correlation Between MAS Antennas

Antenna signals, mainly within the receiver can be correlated due to: (1) the diversity method being imperfect; and (2) coupling between receive circuitry channels or to the transmit signal.

Regarding diversity imperfections, when the antennas are very close to each other or the polarization is imperfect, correlations may exist between the propagation channels of the transmit or receive signals picked up by the different antennas. These correlations typically decrease the performance of the MAS relative to the theoretical peak. In a handheld device, where the form factor is very small, directivity is imperfect due the hand held being in any orientation, the user body interacts with the RF signals, etc., correlations between the antenna signals exist. In vehicles, however, the distance between antennas is much larger than the wavelength which minimizes correlations between antennas.

Consider an illustrative quantitative example where L_{c}, the coherency length, is defined as L_{c}=λ²/Δλ where λ=c/f. Assuming free space propagation c=299,792,458 m/s and f=1 GHz results in λ=0.3 m. The distance between antennas placed in a vehicle (incorporating the same polarization) can easily be made greater than 3 times L_{c} (approximately one meter). In higher frequency bands, e.g., 2 and 3 GHz, antenna de-correlation is improved even further.

Hand held device dimensions are usually smaller than the coherence length. Diversity partial de-correlation is achieved through utilization of polarization diversity and directive antennas with no overlap between main beams of the antenna patterns. This scheme, however, is inferior to the large distances available in the vehicle platform.

Regarding receive circuitry coupling, the vehicle platform provides an advantage over hand held devices due to the vehicle form factor.

### Transmit and Receive Algorithm Selection

The VCS also comprises the ability to select the optimal receive and transmit algorithm to maximize the benefit from the high order MAS integrated into the vehicle platform. Receiver performance can be improved when number of antennas is larger than the number of spatial streams. To maximize apparatus and system performance requires an adaptive implementation of a combination of algorithms in the transmitter and receiver. In an example embodiment, the receiver is operative to autonomously select a multi-antenna detection algorithm (e.g., MIMO decoder configuration, etc.) in accordance with one or more maximization criteria, e.g., maximization of SNR, etc.

In one embodiment, the selection process is determined by the PHY layer controller and considers the following instantaneous parameters and information: signal strength, thermal noise (AWGN) level; interference level, signal modulation and coding settings, vehicle speed (explicitly or implicitly using low, medium and high regions), channel properties (including rank, quality, frequency selectivity, etc.), available computational power, network decisions and instructions, maximum UE category approved, session QoS, scheduling and HARQ parameters and the number of antennas in the MAS.

Note that some of the above mentioned parameters may differ across the signals in-band frequency, e.g., in LTE between Resource Blocks. Therefore the information and system setting may be frequency selective.

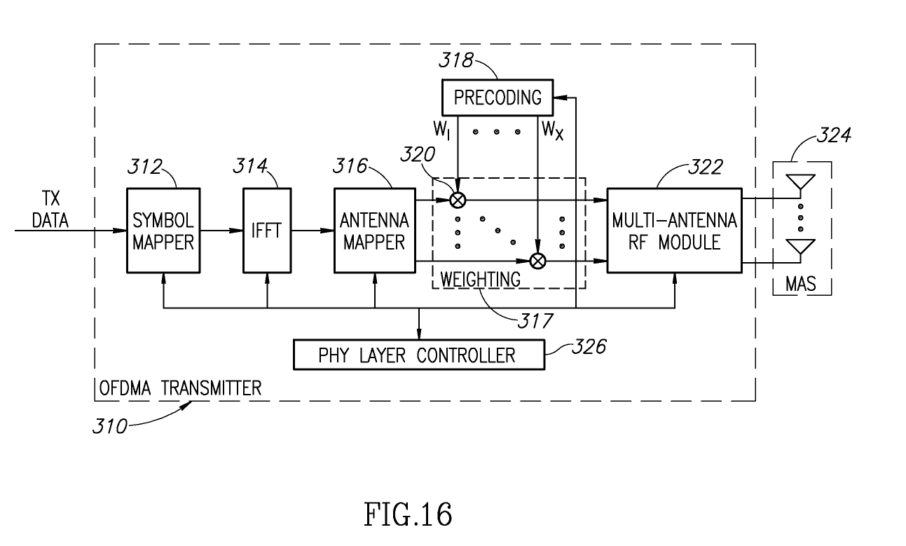

Two different methods may be used in the VCS to select the best current receive and transmit method, one in the transmitter and one in the receiver. To illustrate, a simplified block diagram of an example multi-antenna OFDMA transmitter is shown in FIG. 16. The transmitter, generally referenced 310, comprises symbol mapper 312, inverse FFT (IFFT) 314, antenna mapper 316, weighting block 317 comprising k multipliers 320 for applying weights W₁ through Wₖ generated by the precoding algorithm in block 318 to the output of the antenna mapper, multi-antenna RF module 322, MAS 314 having k antennas and PHY controller 326. In this TX scheme example (partial scheme of the antenna related parts) the transmitter implements STC coding (if enabled) and the antenna mapper functions to map the spatial streams into the k antennas.

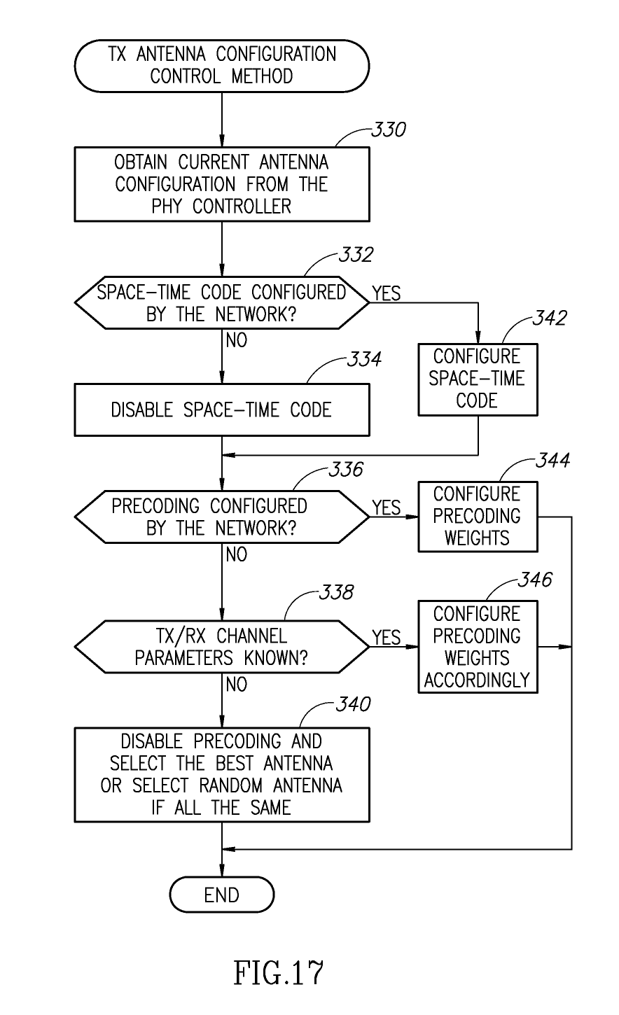

A flow diagram illustrating an example TX antenna configuration control method is shown in FIG. 17. First, the current antenna configuration is obtained from the PHY controller 326 (step 330). If space-time coding (STC) is configured by the network (step 332), the space-time code is configured in the transmitter (step 342). If not configured by the network (step 332), space-time coding is disabled (step 334). If precoding is configured by the network (step 336), the transmitter configures the precoding weights w (block 318) (step 344). If precoding is not configured by the network, then it is checked whether TX/RX channel parameters are known (step 338). If they are, then precoding weights w are configured accordingly (step 346). Otherwise, precoding is disabled and one of the antennas in the MAS is selected as optimal or an antenna is selected at random if the differences are minimal between them (step 340).

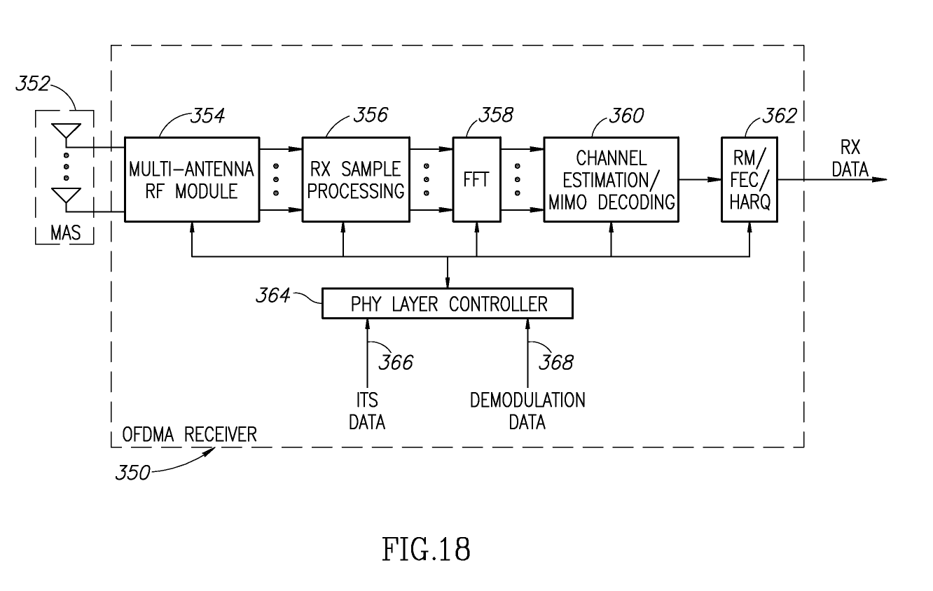

To illustrate the method of selecting the best current receive method, a block diagram illustrating an example multi-antenna OFDMA receiver is shown in FIG. 18. The example receiver, generally referenced 350, comprises a MAS having k antennas 352, multi-antenna RF module 354, RX sample processing block 356, time domain block processing and FFT 358, channel estimation/MIMO decoding block 360, Rate Matching (RM), FEC and HARQ block 362 and PHY layer controller 364 adapted to receive ITS data 366 and demodulation data 368.

In operation, the PHY layer controller 364 interacts with the receiver modules, protocol stack and the Intelligent Transport System (ITS) to acquire information and to configure the receiver accordingly. The configuration may be different among physical channels (e.g., PDCCH, PDSCH, PBCH, etc.) and different coding and modulation and/or different signal in-band resource blocks in frequency or time. The configuration may also be set differently between measurement, synchronization and decoding tasks.

Furthermore, the BS-MS communications configurations exhibit some dependency between the configurations over physical channels in that the transmitter is configured according to feedback from the receiver. The network configured adaptive modulation and coding scheme and MIMO configuration relies on the reported channel quality indication, Precoding Matrix Indicator (PMI) and Rank Indication (RI) measured by the receiver (channel quality indication (CQI), Precoding Matrix Indicator and Rank Indication reporting). This dependency can be utilized by the receiver in selecting detection algorithms and CQI/PMI/RI reporting according to this selection, thus providing the network with knowledge regarding receiver temporal performance. The algorithm selection and reporting to the network according to such a selection is managed and resolved within the receiver autonomously such as by the PHY controller module. Other entities in the PHY flow chain, however, may also perform this functionality.

In one embodiment, the MIMO decoder configuration is determined by first calculating the Channel Quality Indicator (CQI) and the channel Rank (RI) provided to the network for each detection configuration and then selecting a configuration that yields the best CQI and RI.

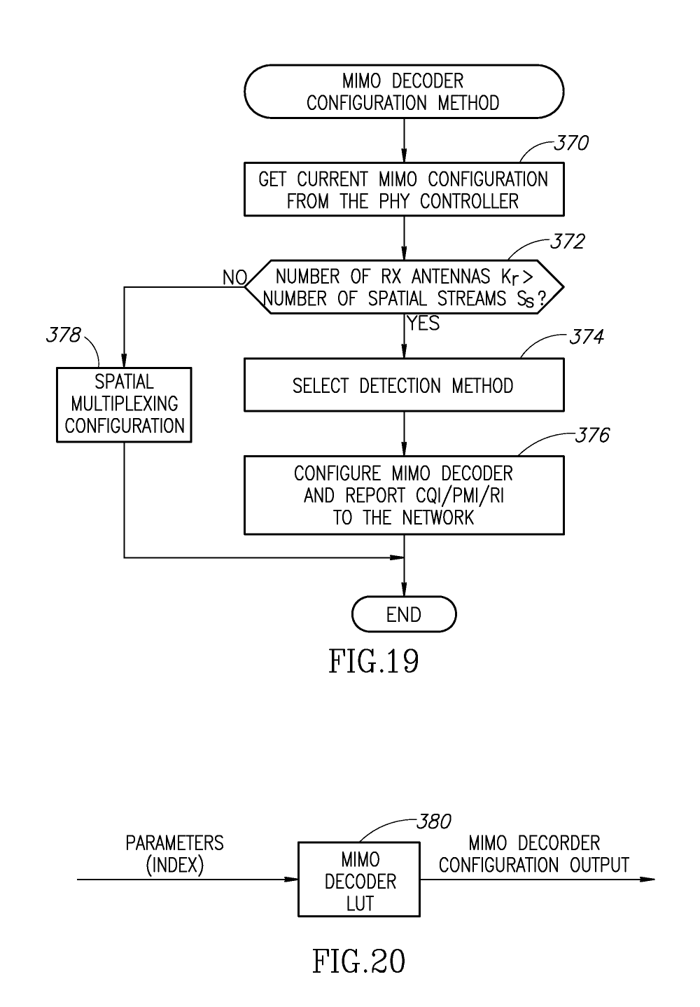

A flow diagram illustrating an example MIMO decoder configuration control method is shown in FIG. 19. First, the current MIMO configuration is obtained from the PHY layer controller 364 (step 370). If the number of RX antennas Kᵣ is greater than the number of spatial steams Sₛ (step 372), then the MIMO detection method and configuration is evaluated and selected (step 374) and the MIMO decoder is configured with the selected method and the CQI/PMI/RI are reported to the network accordingly (step 376). If the number of RX antennas Kᵣ is not greater than the number of spatial steams Sₛ (step 372), then there is no degree of freedom available to the decoder and spatial multiplexing is configured according to network instructions (step 378).

Two possible implementations for selecting the MIMO decoder configuration in the VCS are presented below. In the first method, a performance estimation method, either the error probability of each configuration is estimated or, alternatively, the channel quality indicator (CQI) for each configuration is estimated. The configuration that optimizes the receiver's target function under the constraint of the given resources managed by the network is then selected. One example of the above criterion is to provide the minimum error probability: config=min(Pₑ|config), with Pₑ being the error probability. Another criterion is to explicitly use the configuration that maximizes the CQI and/or RI.

In the second method, a look-up table (LUT) scheme, a table is prepared a priori where each entry comprises a configuration decision, as shown in FIG. 20. The index to the table 380 is the quantized value of different parameters. An optimization is performed a priori to determine quantization thresholds and table entries values. At run time, the index is calculated according to the values of the parameters and the quantized thresholds. The index is then used to access the table and retrieve the configuration from the table.

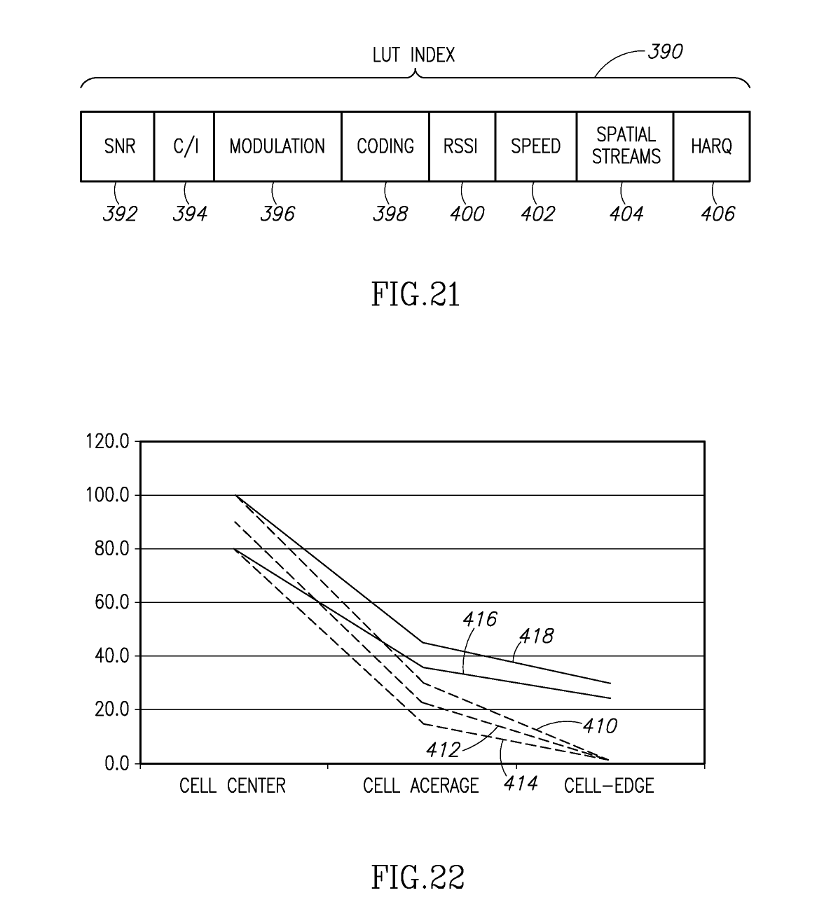

A diagram illustrating example parameters making up the look up table index is shown in FIG. 21. The example parameters make up the index 390 to the LUT and comprise the following (with example value representations): 3-bit SNR 392 (normalized to modulation) where 000 represents equals 0 dB, 111 the maximum throughput, in between represents a linear scale in dB; 2-bit C/1394 represents the number of dominant interferers; 2-bit modulation 396 where 00 denotes QAM, 01 denotes 16QAM, 10 denotes 64QAM; 1-bit coding where 0 denotes convolution, 1 denotes combined-transform coding (CTC); 1-bit RSSI 400 where 0 denotes very low, 1 denotes typical; 2-bit speed 402 where 00 denotes below 10 km/hr, 01 denotes below 50 km/hr, 10 denotes below 100 km/hr, 11 denotes above 100 km/hr; 2-bit spatial streams 404 where 00 denotes one, 01 denotes two and 10 denotes four spatial streams; and 1-bit HARQ 406 where 0 denotes first iteration, 1 denotes consequent iteration.

### Battery Life

In regard to battery life, handheld devices are severely limited by the stored energy within their batteries. Considering that the current development in battery capacity is slow in comparison to the fast pace of development of broadband communications, handheld device designers are forced to optimize designs for power efficiency. The VCS and other types of wireless broadband devices and systems, however, are adapted for integration into a vehicle platform and take full advantage of the vehicle's superior energy capacity which can be considered as a continuous source of power. Thus, very long transmission sessions are possible along with the ability to implement higher complexity algorithms that benefit from high order MAS.

### VCS Improved Performance

A diagram illustrating the relative improvement of the vehicle communications system over conventional cellular systems is shown in FIG. 22. An improvement in data throughput is attainable by use of the VCS as indicated by traces 416 (high-speed) and 418 (static) showing significant performance improvement at the cell-edge. The conceptual graph of FIG. 22 is based on a mix of data sources and depicts the improvement that can be achieved in LTE DL throughput, for example, when the core cellular communication system (i.e. the VCS modem) is embedded in a vehicle platform.

To generate the graph, the following classes of algorithms are used: (1) interference cancellation in SIMO and MIMO channel configuration and corresponding decoding; (2) RX diversity in SIMO and MIMO channel configuration and corresponding decoding; and (3) 2×2, 4×2 and 4×4 MIMO channel configuration and corresponding decoding.

The context and assumptions used include the following: (1) four antennas with multi-antenna receiver embedded in a vehicle platform; (2) appropriate wireless system configuration; (3) thresholds are either pre-stored according to performance measurements or are adaptively adjusted by the modem; (4) only two TX antennas are used by the base station; (5) vehicle speed, even when utilizing dynamic and partial channel estimation, is taken in to account in the threshold tables as an additional source of noise; (6) CINR and vehicle speed contribution are estimated by the modem channel estimation module 360 (FIG. 18). Note that vehicle speed can be reported by the ITS subsystem through interface 366.

The following are optional within the decoding algorithm selection for the example of a four antenna MIMO case: (1) partition into zones according to Carrier to Interference and Noise Ratio (CINR) threshold stored in a MIMO threshold table; (2) in a high CINR zone use interference cancellation algorithms; (3) in medium CINR with no dominant interferer, use RX diversity coupled with a MIMO decoding algorithm of two spatial streams; (4) in medium CINR with a single dominant interferer, use interference cancellation coupled with a MIMO decoding algorithm of two spatial streams; (5) in high CINR, if only two spatial streams are transmitted, use RX diversity coupled with a MIMO decoding algorithm of two spatial streams; and (6) in high CINR, if four spatial streams are transmitted, use a MIMO decoding algorithm of four spatial streams.

The following are optional within the decoding algorithm selection for the SIMO case: (1) partition to zones according to CINR threshold stored in a SIMO threshold table; (2) in a high CINR zone use interference cancellation algorithms; (3) in medium CINR with no dominant interferer, use RX diversity; (4) in medium CINR with up to three dominant interferers, use an interference cancellation algorithm; and (5) in high CINR use RX diversity.

### Applications Utilizing the Core Cellular Communications System Platform

The wireless transition from circuit switched voice to broadband data requires increased capacity in the cellular network. One approach to increase capacity at a given wireless bandwidth is by increasing the number of cells. A higher cell count is achievable through the deployment of smaller cells, utilization of microcells and femtocells.

Outside dense urban areas, however, this method is not feasible, due to the large areas that have to be covered. In these areas, the number of users is typically low with a reduced economic benefit to operators from increasing the number of cell sites. Use of the VCS as described herein can increase the spectral efficiency of the overall network benefiting cellular operators from a capacity increase in their outdoor portion of the network.

Several applications of the core cellular communications system platform (described supra) are disclosed. Systems and methods are provided whereby the outdoor portion of a cellular network includes relaying of mobile terminals, mobile repeaters and mobile femtocells to improve the overall capacity of the network. The applications include (1) a mobile repeater to nearby cellular devices enabled by the higher throughput of a backhaul cellular link; (2) a mobile femtocells that provide increased coverage for in-vehicle occupants (e.g., driver and passengers), users in other cars in the vicinity of the mobile femtocell, connected machines and pedestrians in the neighborhood of the mobile femtocell; (3) a mobile access point (also referred to as an inverted femtocell) for wireless devices inside a vehicle which has with the improved connectivity and throughput to the macro cell site; and (4) a vehicle infotainment system or other system that integrates the core cellular communications platform in an ITS or other in-vehicle system.

### VCS Dumb Vehicle Repeater

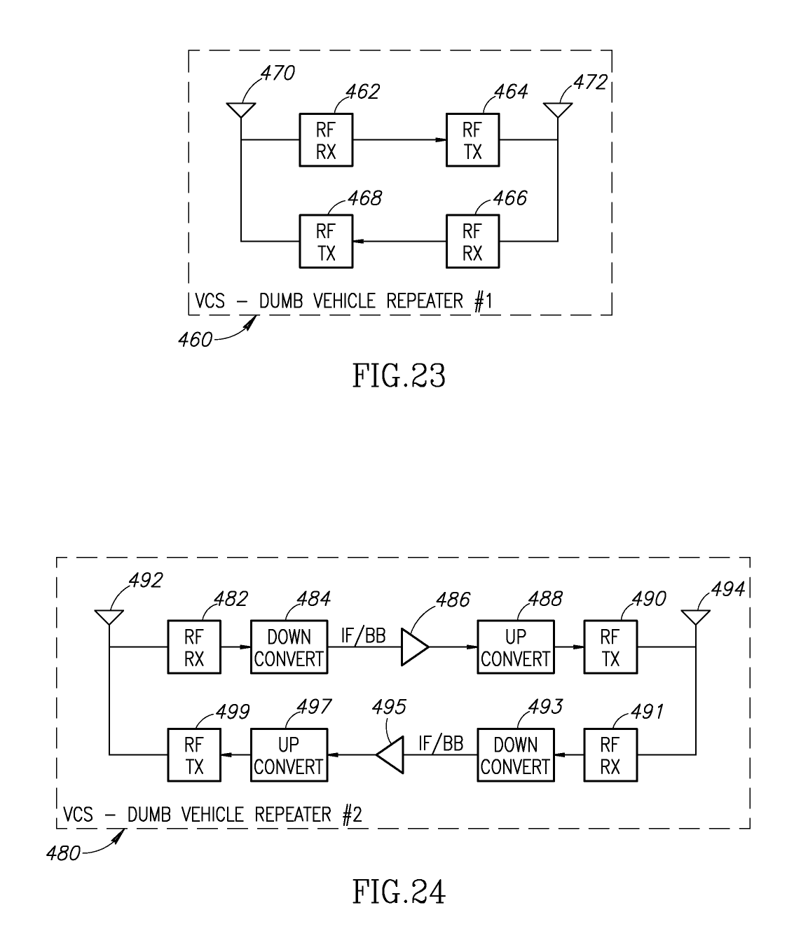

In a dumb vehicle repeater (DVR) the repeating function is performed in the analog and RF domains, whereby an RF transmitter is coupled back to back with an RF receiver as shown in FIG. 23. The result is signal (and noise) enhancement that enables a remote device to detect the original signal as long as the noise is not significantly enhanced. The first example dumb vehicle repeater, generally referenced 460, comprises, in one direction, antenna 470, RF receiver 462, RF transmitter 464 and antenna 472. In the other direction the repeater comprises antenna 472, RF receiver 466, RF transmitter 468 and antenna 470. Note that receive and transmit antennas 470, 472 may be implemented as separate antennas (not shown) or combined as receive/transmit antennas as shown in FIG. 23.

Alternatively, a version of the first example repeater 460 may comprise additional components to achieve better performance. A high level diagram illustrating a second example dumb vehicle repeater is shown in FIG. 24. The second example repeater, generally referenced 480, comprises in one direction, antenna 492, RF receiver 482, downcoverter 484, optional amplifier 486, upconverter 488, RF transmitter 490 and antenna 494. In the other direction, the repeater 480 comprises antenna 494, RF receiver 491, downconverter 493, optional amplifier 495, upconverter 497, RF transmitter 499 and antenna 492. In this second repeater, the RF is downconverted to IF or baseband (BB) after the receiver, it optionally amplified, upconverted to the same or different RF frequency band and amplified before coupling to the antenna.

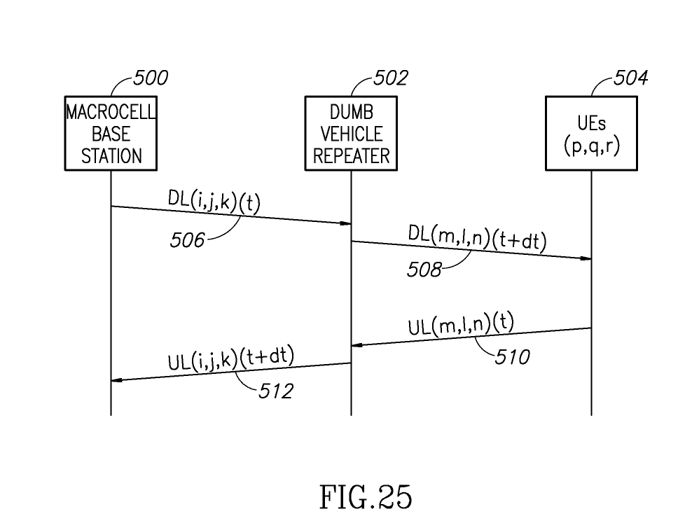

FIG. 25 illustrates message forwarding between a macrocell base station 500, dumb vehicle repeater 502 and UEs 504. Note that DL_{[i, j, k]} and UL_{[i, j, k]} denote the resources allocated between the repeater and the base station for three users denoted p, q, r. Three UEs or users are used here for illustration purposes only. In addition, DL_{[m, l, n]} and UL_{[m, l, n]} denote the resources allocated between the repeater and the above mentioned UE users p, q and r. These resources, e.g., carrier frequency may be the same or different between base station and repeater and repeater and UEs. It is assumed that the delay introduced between the repeater and the UEs is of negligible effect on the application running in the UE. In general, the repeater does not perform any data extraction. Information forwarding to the UE can be performed using any suitable technique. For example, the received signal is amplified at the repeater at the RF level. In this case, filtering of the signal prior to amplification can be used to improve the signal quality in terms of, e.g. spectral mask. Other approaches may apply down conversion to baseband frequency or IF followed by sampling. Application of well-known digital signal processing techniques improves the signal quality followed by up-conversion to RF and signal forwarding to the UE. Note that this approach is bidirectional and may be used in the UL as well.

### VCS Smart Vehicle Repeater

In modern cellular networks, the latency exhibited by the network is an important performance factor. Thus, it may be impractical to implement digital processing in the repeater as part of the link between the base station and the target UE (as may be done in the DVR). To address this issue, the smart vehicle repeater (SVR) incorporates signaling functionality that enables it to terminate the radio link to the macrocell base station on the one hand, and to facilitate a different radio link to the UEs served by the SVR.

Wireless networks are used to provide wireless connectivity to mobile terminals, which are also referred to as mobile stations (MS), user equipment (UE), mobile units, etc. Examples of mobile station devices include cellular telephones, smartphones, superphones, tablets, text messaging devices, laptop computers, desktop computers, personal data assistants (PDA), etc. A typical wireless network includes one or more base stations (BS) that provide wireless connectivity to one or more mobile stations in a particular geographic area or cell. Base stations are also commonly referred to as access points or node-BSs.

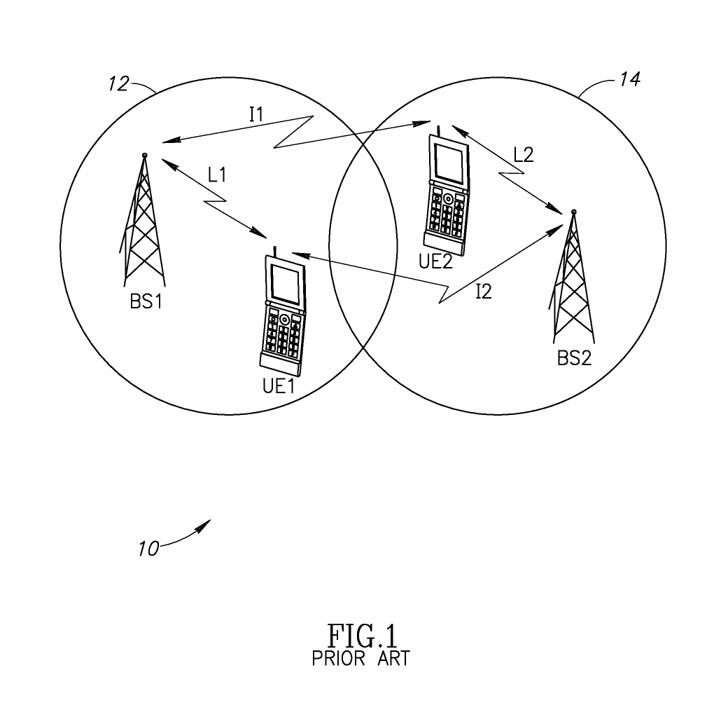

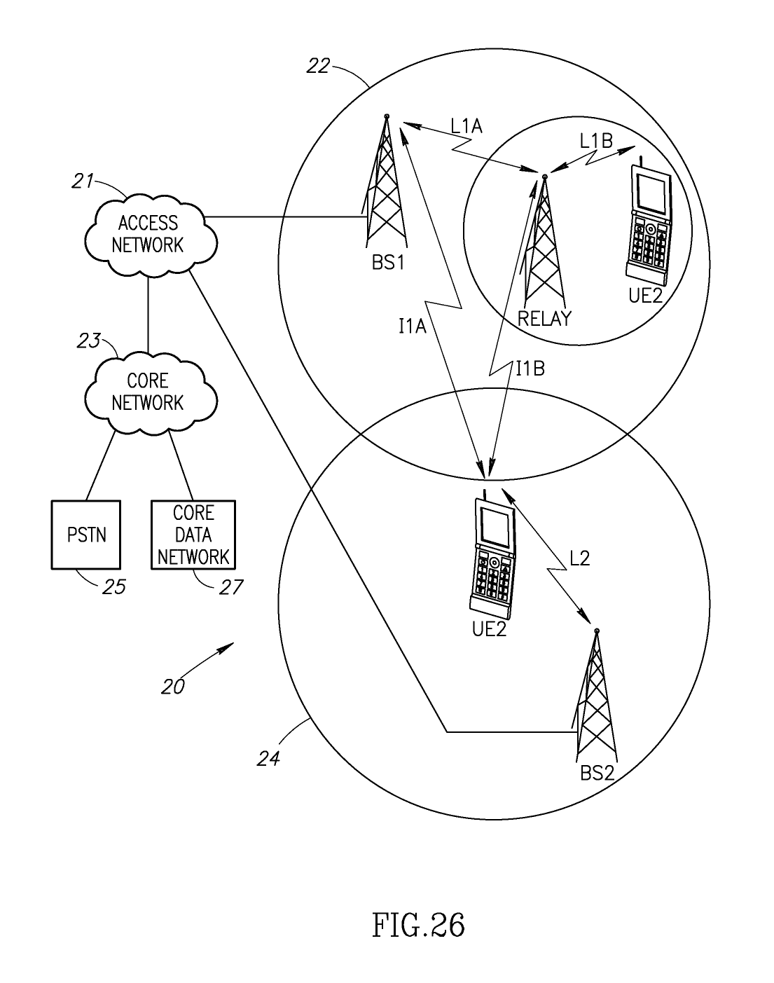

Considering the cellular coverage problem of prior art cellular systems, the VCS repeater (and femtocell) address these issues. A block diagram illustrating a first example wireless communications network incorporating repeater/relay device is shown in FIG. 26. The example network comprises a first cell 22 with BS1 and a second cell 24 with BS2. Link L1 is split into link L1A (BS-Relay link) between BS1 and the Relay and link L1B (Relay-User link) between the Relay and UE1. The assumption here being that link L1A has much less power due to the height, signal processing, power and antenna quality of the relay when compared with link L1 in FIG. 1. Furthermore, link L1B requires far less power in order to facilitate the data rates and quality of service requirements of UE1, since the link between the Relay and UE1 is much better than the link between BS1 and UE1. Both links L1A and L1B, however, cause interference to the neighboring cell users (I1A, I1B, respectively), especially at the cell edge (cell edge interference). The total interference power, however, is much smaller with respect to the power sensed in the scenario illustrated in FIG. 1.

With reference to FIG. 26, the wireless network also comprises access network 21, core network 23, core public switched telephone network (PSTN) 25 and core data network 27. Note that the backhaul network may be coupled to a common public or private network such as the Internet, a telephone network, e.g., public switched telephone network (PSTN), a local area network (LAN), wide area network (WAN), metropolitan area network (MAN), a cable network, and/or any other wired or wireless network via connection to Ethernet, digital subscriber line (DSL), telephone line, coaxial cable, and/or any wired or wireless connection, etc.

The UEs are operative to use any of a variety of modulation techniques such as spread spectrum modulation, single carrier modulation or Orthogonal Frequency Division Modulation (OFDM), etc., and multiple access techniques such as Direct Sequence Code Division Multiple Access (DS-CDMA), Frequency Hopping Code Division Multiple Access (FH-CDMA)), Time-Division Multiple Access (TDMA), Frequency-Division Multiple Access (FDMA), Orthogonal Frequency Division Multiple Access (OFDMA), and/or other suitable modulation techniques to communicate via wireless links to its serving cell.

The UEs may comprise, for example, radio access electronic devices such as a desktop computer, laptop computer, handheld computer, tablet computer, cellular telephone (e.g., smartphone, superphone), pager, audio and/or video player (e.g., MP3/4 player or a DVD player), gaming device, video camera, digital camera, PND, wireless peripheral (e.g., printer, scanner, headset, keyboard, mouse, etc.), medical device (e.g., heart rate monitor, blood pressure monitor, etc.), and/or any other suitable fixed, portable or mobile electronic devices.

The UEs may use an OFDM modulated signal to transmit large amounts of digital data by splitting a radio frequency signal into multiple small sub-signals, which in turn are transmitted simultaneously at different frequencies. In particular, UEs may use OFDM modulation to communicate over the wireless network. For example, UEs may operate in accordance with the IEEE 802.16 family of standards (e.g., IEEE 802.16e, 802.16m, etc.) to provide for fixed, portable and/or mobile Broadband Wireless Access (BWA) to communicate with one or more base stations via one or more wireless links.

Although some of the above examples are described above with respect to standards developed by ETSI, 3GPP and the IEEE, the mechanism is applicable to numerous specifications and standards such as those developed by other special interest groups and/or standard development organizations, such as the Wireless Fidelity (WiFi) Alliance, Worldwide Interoperability for Microwave Access (WiMAX) Forum, etc., and is not to be limited to the examples presented herein.

Note that the base stations maintain wireless communication links with the UEs while the access network provides communications between base stations. The access network also provides communications to the core network which links mobile users to the PSTN, Internet/WAN and other external networks. Note that although UEs maintain an active connection with one base station, i.e. the serving base station (SBS), they may be within transmission and reception range of multiple base stations, i.e. possible target base stations (TBS).

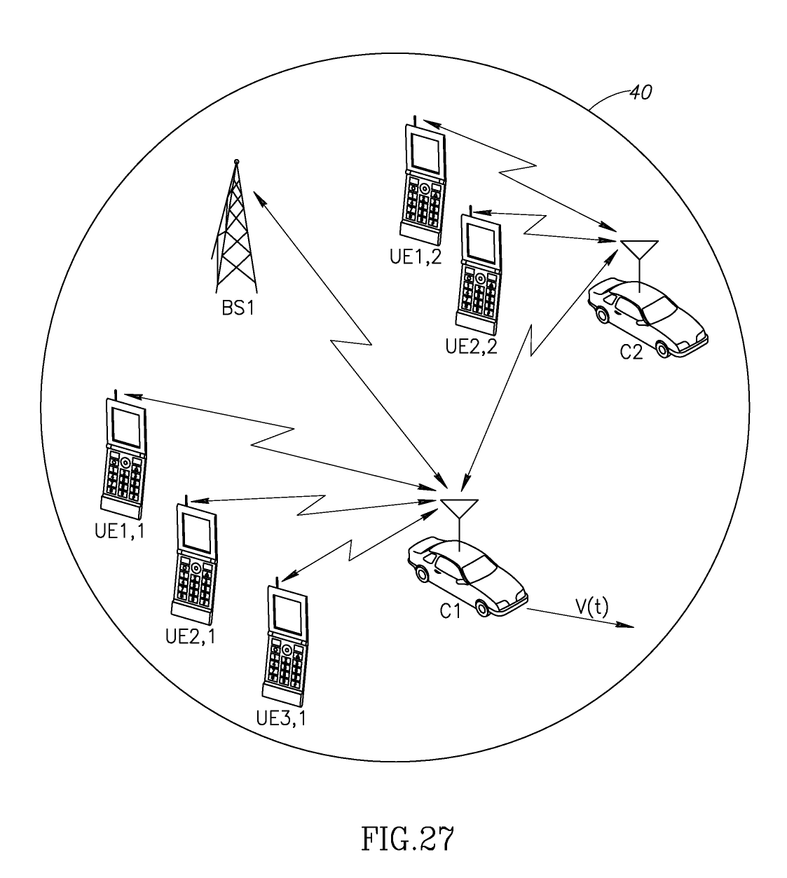

A diagram illustrating a second example wireless network incorporating a repeater/relay device is shown in FIG. 27. The cell 40 with BS1 comprises vehicle (car) C1 traveling at a speed v(t) connected to UEs 1,1; 2,1 and 3,1 and vehicle C2 connected to UEs 1,2 and 2,2. This scenario illustrates a relaying mechanism between the repeaters (or femtocells) implemented in the two vehicles C1 and C2. In the event C2 experiences poor reception conditions, C1 dynamically relays the transmission to and from BS1 on behalf of C2. The C2 repeater (or femtocell) effectively provides services to users inside both vehicles and in its surrounding area (UEs 1,2; 2,1; 1,1; 2,1; etc.)

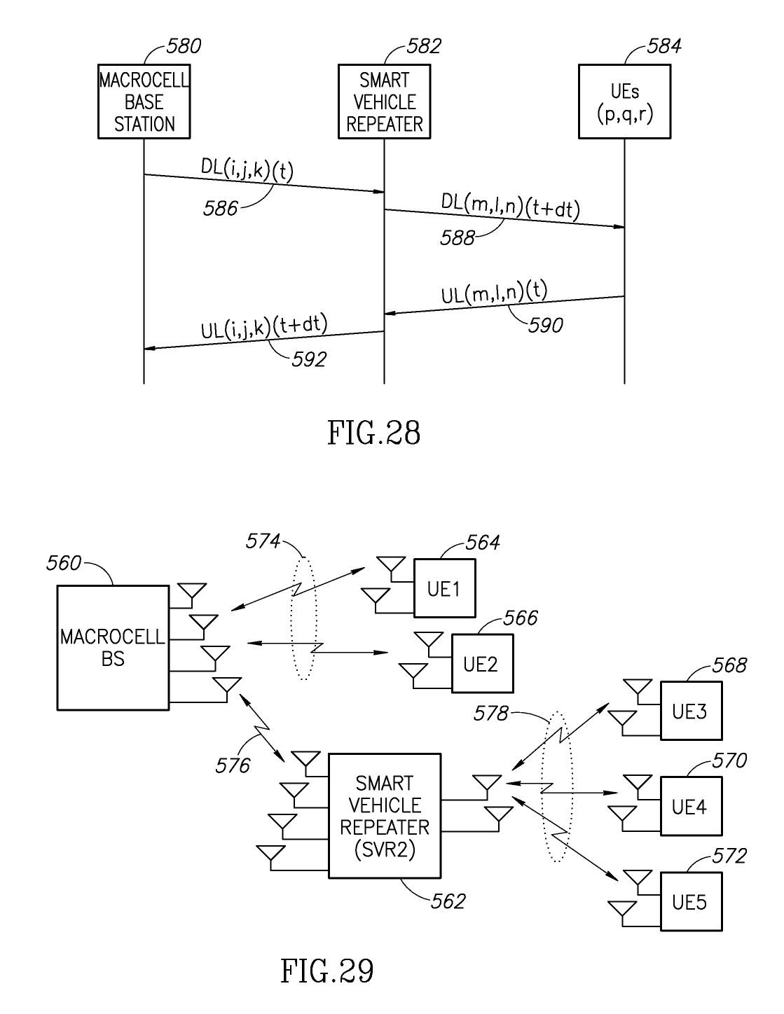

FIG. 28 illustrates message forwarding between a macrocell base station 580, a first embodiment smart vehicle repeater (SVR) 582 (also referred to as SVR1) and several UEs 584. Note that DL_{[i, j, k]} and UL_{[i, j, k]} denote the resources allocated between the first embodiment SVR and the base station for three UEs denoted p, q, r. The use of three UEs is for illustration purposes only. In addition, DL_{[m, l, n]} and UL_{[m, l, n]} denote the resources allocated between the first embodiment SVR and UEs p, q and r. Note also that these resources, e.g., carrier frequency, may be the same or different in messages between base station and first embodiment SVR and between first embodiment SVR and the UEs. Due to the processing involved in demodulating, modifying and modulating, a time difference exists between base station and SVR communications and SVR and UE communications. The first embodiment SVR functions to compensate for these delays communicating to the opposite side (i.e. the BS and UEs).

In a first embodiment SVR, data is reconstructed in order to be able to modify modulation or other physical layer related parameters (e.g., coding scheme, etc.). This is achieved using hard decisions or by using the forward error correcting code (FEC) functionality in the first embodiment SVR. In addition, higher layer parameters may be changed since the forward continuing link may be allocated with different resources than that of the first forward link. Furthermore, the system may also integrate hybrid-automatic-repeat-request (H-ARQ) or ARQ protocol functionality. These protocols may be implemented both in the first embodiment SVR and/or in the end station (i.e. UE for the DL and BS for the UL).

A diagram illustrating an example wireless network incorporating a second embodiment smart vehicle repeater (SVR) is shown in FIG. 29. The network comprises a macrocell base station 560 in communication with second embodiment SVR 562 (also referred to as SVR2 or simply SVR) and UEs, namely UE1 564 and UE2 566 over links 574. The SVR effectively forms a virtual cell for its registered UEs, namely UE3 568, UE4 570 and UE5 572 and connects with them over links 578. Cell data traffic connectivity is provided through the backhaul link 576. All necessary signaling for the virtual cell is independently generated by the SVR.

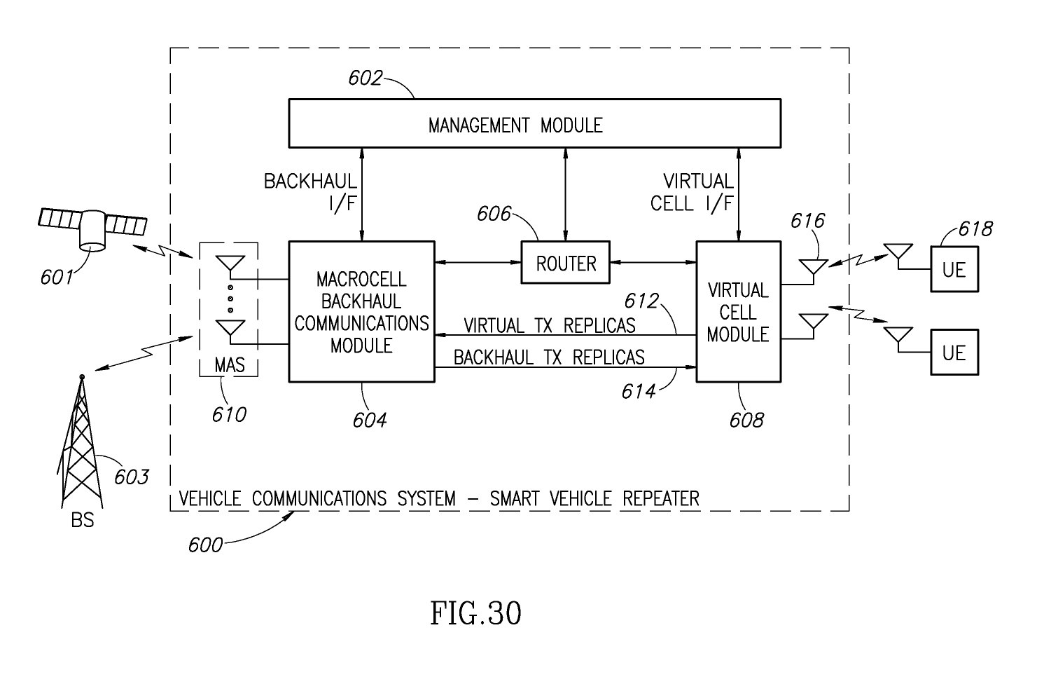

A high level diagram illustrating an example VCS based smart vehicle repeater is shown in FIG. 30. The VCS SVR, generally referenced 600, comprises several functional modules, including macrocell backhaul communications module 604 coupled to MAS 610, router 606, virtual cell module 608 coupled to antenna(s) 616 and management module 602.

The macrocell backhaul communications module implements the core cellular communications system 50 (FIG. 2), 100 (FIG. 4) to form an advanced UE opposite the macrocell base station 603 (or alternatively the satellite communications system 601). The base station is connected to an access network (not shown) which provides connectivity to services and the Internet for users. The macrocell backhaul communications module functions to provide the backhaul data link for the entire VCS. The operator control and configuration session is enabled between the network and the management module through the backhaul communications module. The data pipe for the virtual cell is provided through the backhaul communications module as well.

The virtual TX replicas 612 and backhaul TX replicas 614 are used to cancel the blocking effect of the local transmission that is inherent from the fact that a UE and a cell are located very close to each other. These signals may comprise an RF replica or a baseband replica or two replicas. A replica per each transmitting antenna is provided. For example, two replicas are provided for two transmitting antennas where each may be in the form of both an RF signal replica for each transmitting antenna and a baseband replica for each transmitting antenna.

SIM functionality for the virtual cell may reside in the management module 602 or in the macrocell backhaul communications module 604. Preferably, SIM functionality resides in the management module to provide a single entity that handles all Authentication, Authorization, and Accounting (AAA) issues.

The serving virtual cell module 608 functions to provide a virtual cell and a virtual associated cellular network (e.g., a 3GPP Public Land Mobile Network (PLMN)) to UEs 618. This virtual PLMN provides AAA, mobility and Non Access Stratum (NAS) services to the virtual cell. Note that part of the PLMN settings and configuration may be set by the network, while recognizing that this specific terminal is actually a SVR. The interface to the RAN and for enabling core network services such as AAA service may be emulated for simplicity and coherency with the wireless standard.

One or more cell registered UEs 618 roam into the virtual PLMN provided by the SVR.

As long as they are in the vicinity of the vehicle, they are served by this virtual PLMN and cell. From the perspective of the UEs registered with the SVR, they are associated with a cellular network comprising a single cell which is local to the vehicle. It is noted that this is a difference between the SVR (second embodiment SVR2) and either a femtocell or first embodiment SVR1. The femtocell functions as part of the operator network and is connected to the cellular network as another cell (with ID assignment, etc.). SVR1 does not provide the dedicated signaling and functionality of a PLMN. Further, in both a femtocell and SVR1, the registered UEs do not roam into the coverage area of the virtual cell. In the case of SVR2, the perspective of the network is that it sees a PLMN connected to a router and coupled by a link between the RAN and the cell. In the case of a femtocell, the perspective of the network is that it sees another cell facilitating a link between the network and UEs in the coverage area of the femtocell.

The virtual cell 608 is connected to the router 606 to create dedicated IP sessions for each of the registered UEs. The router module functions to route IP packets between the different modules and to the Internet through the backhaul communications module 604. The router may implement typical router functionality such as a firewall, DHCP server, etc. The virtual cell is connected to the management module to receive settings, configurations, etc. In addition, the virtual cell optionally interfaces with the management module for AAA services. Locating the AAA services, such as Home Location Registry (HLR) and Visitor Location Registry (VLR), encryption keys, etc. in the management module places all security functionality in a single module.

The virtual cell may instruct the registered UEs to operate in a manner that optimizes the overall performance. For example, setting neighbor cell measurements in a way that maximizes the localization of the UEs to the virtual cell. In another example, radio resources are allocated and transmissions scheduled in a way that reduces interference. A similar functionality may be associated with instructions related to handover.

In addition, the virtual cell may provide one or more services only to registered UEs. For example, services to those UEs currently in use by the family of a vehicle owner. In this configuration, any other UEs are barred from obtaining service. Alternatively, the virtual cell may provide a service to any UE within coverage of the virtual cell, e.g., as a device integrated into a public transportation vehicle such as a train, subway, ship, boat, airplane, helicopter, taxi or a bus. In the latter case, the cell may facilitate an interaction with the macrocell and the operator network to check UE owner credentials.

The management module 602 is responsible for the following functionality: (1) boot sequence; (2) module configuration; (3) mode of operation (boot, debug, SVR, calibration, etc.); (4) security; and (5) integrating with the vehicle system and ITS. The boot sequencing occurs each time the vehicle is used (including periods when the engine is not running). The management module wakes up the other modules and checks for proper operation of each. If the sequence has been completed successfully, it activates the configuration task.

During module configuration, the management module checks for updates utilizing the backhaul communications module. It then configures the modules accordingly and activates the virtual cell. If any calibration is required, it is performed before the virtual cell is activated for service.

Many modes of operation exist for the VCS, including: (1) boot mode to start the system; (2) debug mode to provide visibility of the internal status to test and maintenance equipment whereby no standard operating modes can be invoked such as the ITS interface, stand alone activation of each module, advanced calibration, BIST activation, etc.; (3) SVR normal operating mode; and (4) calibration mode which is used to calibrate the RF transceivers, associated gains and to measure interference between the backhaul link and the virtual cell and vice versa.

Security issues are preferably handled by the management module. The management module is responsible for the SIM interface of the backhaul link (which can alternatively be local to the backhaul module as well), the AAA interfaces of the virtual cell and the overall secured platform aspect of the device (e.g., secured boot, protection from hacking, unauthorized software changes, maintaining software integrity, etc.).

Further, the VCS SVR is operative to integrate with the vehicle platform. Vehicle status information may be provided to the SVR (e.g., vehicle lock status, vehicle engine status, vehicle speed, vehicle battery status, activity status of other wireless systems in or out of the vehicle, etc.). In emergency situations, an emergency call can be provided through the SVR without the need to go directly through the cellular network. Location information can be exchanged between the ITS and the SVR. A GPS receiver may be integrated in the SVR or in the vehicle platform itself. Radio coexistence between the SVR and other vehicle wired and wireless modules and subsystems is maintained (for example, the vehicle infotainment system). A vehicle status platform may provide vehicle status and indicators to a vehicle maintenance, service, support or emergency center. Integration of the SVR with other VCS applications such as inverted femtocell and vehicle infotainment system.

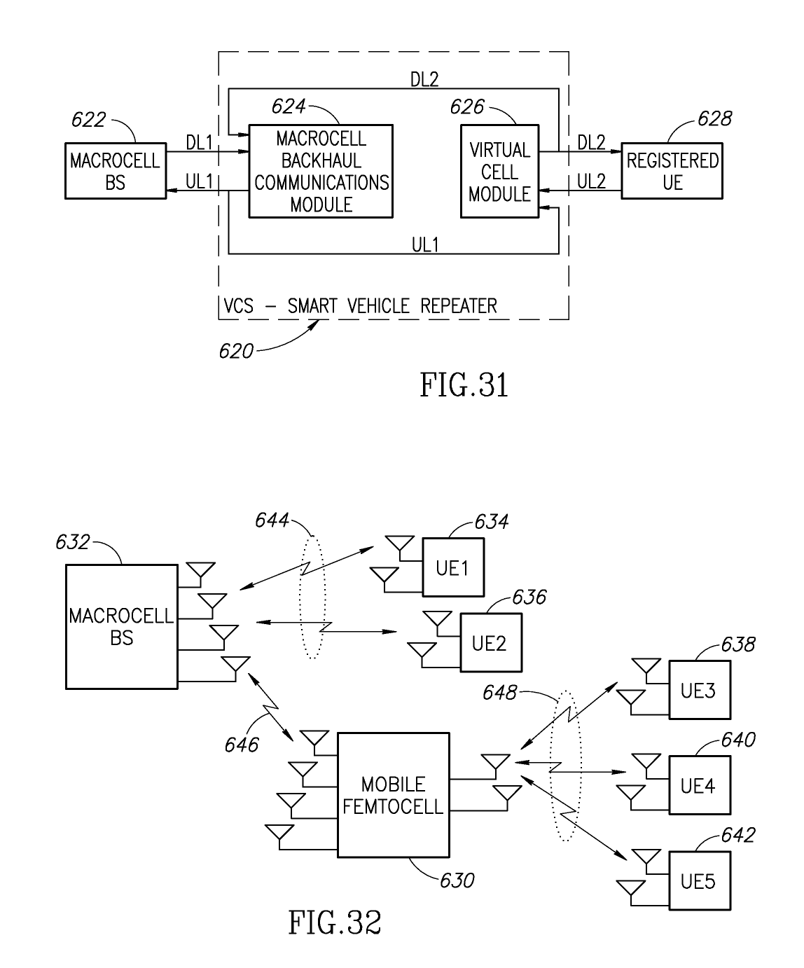

The macrocell backhaul communications module and the virtual cell operate very close to each other and occasionally utilize the same radio resources. Such close proximity and resource sharing creates an inherent interference. Using a Frequency Division Duplex (FDD) system as an example, the interference in a FDD based VCS SVR system is depicted in FIG. 31. The VCS SVR, generally referenced 620, comprises a macrocell backhaul communication module 624 in communication with the macrocell base station 622 and virtual cell module 626 in communications with registered UEs 628.

In the DL direction, the macrocell base station signals (possibly transmitted from multiple antennas) DL1 and the Virtual Cell signals DL2 are transmitted simultaneously. The antennas of the registered UEs pick up two signals: DL1 and DL2. Note that it is assumed that the signal strength of DL2>>DL1 (i.e. large C/I), due to the large differences in the distances between the two signals. Therefore interference from DL1 at the UE is handled by the receiver in the UE using one or more well-known interference reduction techniques. The macrocell backhaul antennas (i.e. the MAS), however, also picks ups two signals: DL1 and DL2. Since the signal strength of DL2>>DL1 (small or negative C/I) the backhaul communications module receiver experiences a large interference. This same phenomena occurs in the UL direction where the receiver in the virtual cell receives UL1 and UL2 where the signal strength of UL1>>UL2.

The interference causes two disturbing effects: (1) it saturates the RF circuitry and (2) it degrades the performance of the receiver. Reducing the interference requires the utilization of several methods alone or in combination: (1) directive antennas having antenna patterns that are non overlapping which minimizes the radiated interference; (2) controlling the transmitted power to reduce the interference; (3) scheduling the radio resources in a non overlapping manner, e.g., using different frequencies or different transmit time slots or frames to prevent the interfering event; (4) utilizing RF circuitry having a larger dynamic range; (5) employing interference cancellation in the RF circuitry, e.g., creating a replica of the interference and subtracting it from the received signal, which requires updating weights in a real time manner; and (6) employing interference cancellation in the baseband which can be performed, for example, by subtracting the weighted (known) interference from the receive signal or alternatively through joint detection in the MIMO decoder.

Typically, the number of internal antennae for the virtual cell is much lower (e.g., one, two or four) than the number of antennas in the MAS used with the macrocell backhaul communications module (between two and eight). Regarding the location of antennas for the virtual cell within the vehicle, any of several suitable locations may be used, including for example: (1) vehicle roof patch antennas with radiating patterns towards the downward direction; and (2) roof corner antennas having radiating patterns towards the center of the interior of the vehicle.

### Mobile Femtocell

In accordance with the VCS mechanism, another approach to the cell edge/coverage problem is referred to as a mobile femtocell. A mobile femtocell (also known as an access point base station) is defined as a very small cellular base station which serves a small number of users within a relatively small area (e.g., few square meters, in a residential or commercial location or in a vehicle). The mobile femtocell connects to the service provider's network via a cellular backhaul connection. Mobile femtocells can be adapted to any desired wireless standard such as, for example, WCDMA, GSM, CDMA2000, TD-SCDMA, WiMAX and LTE standards.

On one embodiment, a static femtocell may be adapted to cover a local and often times partially isolated area such as a building apartment, a store or an office. The backhaul link between the static femtocell and the operator usually comprises the residential Internet link such as an ADSL or cable broadband connection. The static femtocell establishes a secured link into the operator core network and forms an integral extension that is part of the cellular core access network.

Some operators sell the femtocells to customers who install them themselves. The benefit to the customer are better coverage, better tariffs while within coverage of the static femtocell and utilization of a single handset device for home and “on the go” usage. The value to the operator is sharing the capital expense of the cell with the customer, solve in-building coverage issues and compete with the telephone line operator on the calls made at the home.

In a mobile femtocell, the cellular network itself is utilized as the backhaul connection. It utilizes cellular communication radio access technology to communicate with both the operator core network and the users logged into the mobile femtocell within its coverage area. The mobile femtocell concept have several benefits including: (1) providing superior link with the macrocell then a handset in or near the vehicle; (2) the interference issues inherent to this concept are capable of being dealt with; (3) power dissipation advantage to handsets in that their transmit power requirements are likely lower; (4) optional billing advantage through aggregation of users within coverage of the mobile femtocell; and (5) optional location services advantage, when the mobile femtocell or one of the users within its coverage utilizes a superior means for location determination.

Between mobile femtocells in a cellular network there is no continuous coverage meaning that cellular users cannot rely only on deployment of femtocells. Unlike the relay solution supra, the femtocell may schedule resources to users within its coverage dynamically and autonomously. Similar to the repeater solution, the capability of routing the information to target users is beneficial in terms of lowering the interference to the environment along with maintaining a high signal quality while consuming less power, for the users served despite being relatively far from the cell center.

The mobile femtocell is similar to the SVR2 described supra but with at least two differences: (1) the virtual cell 608 (FIG. 30) is replaced by a femtocell (3GPP Home eNB or Home NB). In the case of the femtocell, there is no virtual public land mobile network (PLMN) since the femtocell is an integral part of the macrocell network. From the perspective of the network, the network sees another cell, and not a “UE” as is the case of the SVR2. The backhaul link to the macrocell base station is utilized as the link between the femtocell and the core and access networks of the operator. Considering a static femtocell that connects to the network via a static connection, e.g., ADSL or cable interface, the static backhaul connection is replaced by a cellular backhaul connection in the mobile femtocell.

It is noted that there exist several differences between a repeater and a femtocell. One difference between a repeater (SVR1) and a mobile femtocell is that a repeater essentially enhances the link condition via re-transmission of the same (baseband) waveform either on the same radio resource (such as frequency) or a different radio resource. Utilizing the same radio resource simplifies the repeater apparatus and creates an additional delayed reflection of the original transmission that can be utilized by the base station receivers (in the UL) and the UE (in the DL) to improve detection. In the case of different radio resource utilization, the repeater constitutes a virtual replacement of the original waveform. In an example, a repeater that demodulates the base station signal to form a baseband signal and then modulates it to another frequency band (and vice versa for the UE transmission) constitutes a virtual replacement of the base station to the UE and vice versa. The mobile femtocell forms an actual cell with unique radio characteristics, a unique identification in the access NW and communicates with the core and access network to execute mobility procedures, registration procedures, authentication and security procedures, etc. A mobile femtocell can bar its service from selected users and enable services to others. Repeaters do not facilitate such procedures with the operator NW.

A diagram illustrating an example wireless network incorporating a mobile femtocell is shown in FIG. 32. The network comprises a macrocell base station 632 in communication with mobile femtocell 630 and UEs, namely UE1 634 and UE2 636 over links 644. The mobile femtocell effectively forms a miniature cell for its registered UEs, namely UE3 638, UE4 640 and UE5 642 and connects with them over links 648. Cell data traffic connectivity is provided through the backhaul link 646. All necessary signaling for the mini-cell is independently generated by the mobile femtocell.

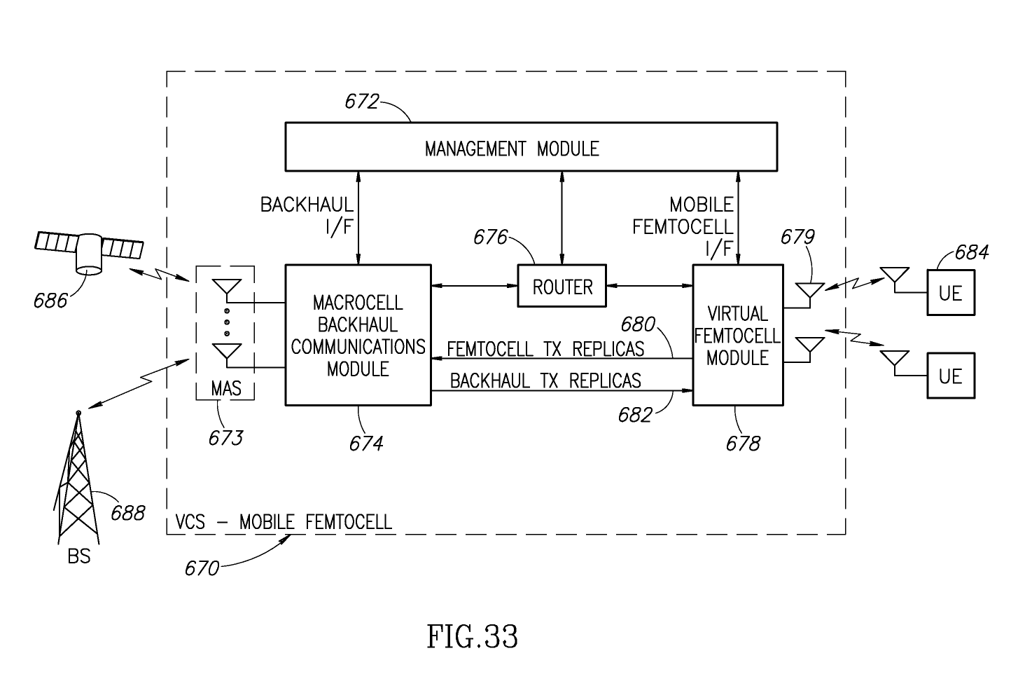

A high level diagram illustrating an example VCS based mobile femtocell is shown in FIG. 33. The VCS mobile femtocell, generally referenced 670, comprises several functional modules, including macrocell backhaul communications module 674 in communication with the cellular base station 688 (or satellite communication system 686) via MAS 673, router 676, mobile femtocell module 678 coupled to antenna(s) 679 and management module 672.

The macrocell backhaul communications module implements the core cellular communications system 50 (FIG. 2), 100 (FIG. 4) which is seen by the macrocell network as another cell site. The base station is connected to an access network (not shown) which provides connectivity to the Internet for users. The macrocell backhaul communications module functions to provide the backhaul data link for the entire VCS mobile femtocell. The operator control and configuration session is enabled between the network and the management module through the backhaul communications module. The data pipe for the mobile femtocell is provided through the backhaul communications module as well.

The mobile femtocell TX replicas 680 and backhaul TX replicas 682 are used to cancel the blocking effect of the local transmission that is inherent from the fact that a UE and a cell are located very close to each other. These signals may comprise an RF replica or a baseband replica or two replicas. A replica per each transmitting antenna is provided. For example, two replicas are provided for two transmitting antennas where each may be in the form of both an RF signal replica for each transmitting antenna and a baseband replica for each transmitting antenna.

The mobile femtocell module 678 functions to provide a mini-cellular network to UEs 684. This mobile femtocell provides AAA, mobility and Non Access Stratum (NAS) services to the cell. One or more cell registered UEs 684 handover into the mobile femtocell and as long as they are in the vicinity of the vehicle, they are served by the mobile femtocell. From the perspective of the UEs registered with the mobile femtocell, they are associated with a cellular network comprising a single cell which is local to the vehicle. Note that the mobile femtocell functions as part of the operator network and is connected to the cellular network as another cell. The mobile femtocell provides the dedicated signaling and functionality of a cell site. The perspective of the network is that it sees another cell site providing connections between the network and UEs in the coverage area of the mobile femtocell.

Note that although the following description of the benefits of the VCS mobile femtocell refers only to mobile femtocells it is appreciated that it also applies to VCS SVR2s and VCS inverted femtocells (described in detail infra) as well and is considered to apply thereto. In the VCS mobile femtocell, femtocell techniques are used to implement cellular coverage (macro deployment) based on a vehicle platform. Utilization of the vehicle platform enables an improved and stable base station link quality. One benefit of the vehicle platform is the ability to mount larger size antennas and/or higher antennas and/or larger number of antennas and better, more powerful algorithms without practical restriction on power consumption, size and power dissipation (i.e. with respect to a conventional mobile user terminal). Furthermore, unlike a building structure (i.e. residence or enterprise) the vehicle platform is mobile within the network.

In another embodiment, the vehicle based mobile femtocell moves through the cellular network and has mobility functionality such as handovers between BSs throughout the network coverage area. For users in the area covered by the mobile femtocell, the link appears static while the cellular link between the mobile femtocell and the BS may experience high mobility, a high level of interference or low signal power. The mobile femtocell is responsible for dynamically updating the link parameters in order to provide the required data rates and quality of service (QoS). The link between the mobile femtocell and the BS requires less resources and exhibits better performance with respect to the alternative of establishing and maintaining the link directly between the BS and the end user. Note that the end user may remain in the vehicle or its close environment in order to take advantage of the coverage gain.

Note that in one embodiment of the mechanism, coverage gain is also extended to occasional users in the area surrounding the vehicle. This service may be considered as an ad-hoc mode. The policy of providing the service to occasional users may be: (1) pre-defined, (2) centralized, (3) adaptively modified by the network, etc.

It is noted that a mobile femtocell implemented in a vehicle environment does not suffer from many of the drawbacks suffered by the UEs. For example: (1) a vehicle provides a very large form factor in the vehicle body with numerous suitable antenna mounting locations; (2) an internal combustion or diesel engine to power a heavy duty alternator to effectively provide a virtually unlimited power supply from the perspective of a cellular device; (3) the high cost of the vehicle itself and its accessories typically justify the added cost of the mobile femtocell; it is further assumed that operators are likely to encourage and subsidize mobile femtocell devices due to the overall system benefits to the cellular NW; and (4) vehicle manufacturers' interest to provide an improved user experience in terms of communications to the vehicle along with integrated entertainment devices based on communications (infotainment) may subsidize the system cost including installation.

In another embodiment, the mobile femtocell in a vehicle maintains a link with the BS transceiver through the cellular access network. The users inside the vehicle experience very good conditions due to the enhanced environment created by the mobile femtocell. Without a mobile femtocell, users inside the vehicle would typically experience low signal levels with high interference, especially in cell edge conditions.

In another embodiment, the mobile femtocell is adapted to integrate with vehicle platform. The integration has the following elements: (1) an antenna system whereby good space diversity can be achieved using an optimized antenna pattern (pointing out of the vehicle), large number of antennas, reducing attenuation due to body effect, efficient connection and calibration between the mobile femtocell backhaul RF circuitry and the antennas; (2) a vehicle based power supply to enable the advanced algorithms, continuous use and other features that would otherwise quickly drain a hand held battery; and (3) information exchange between the mobile femtocell and the vehicle (e.g., such as location, speed, engine status, etc.)

In another embodiment, the VCS mobile femtocell achieves superior link quality with the macrocell by being embedded (integrated) into the vehicle platform. This provides several advantages over a hand held handset or mobile phone including, for example: (1) the size of the vehicle platform enables a high degree of space diversity in the MAS; (2) the availability of electrical power enables the execution of sophisticated signal processing algorithms in the mobile femtocell; (3) the availability of electrical power enables continuous operation while the vehicle is operating; and (4) use of an advanced MAS that can incorporate directional antennas and/or adaptive functionality.

The cellular network structure of cells and sectors create link quality differences between the cell center (very good link condition, strong desired signal and weak interfering signals) and the cell edge (very poor link condition with desired signal and aggregated interference in similar levels) where these variances in the link quality can create a large variance (100 times or more) in the spectral efficiency in bps/Hz/cell.

The VCS mobile femtocell (i.e. the core cellular communications system) employs one or more multi-antenna (MIMO) techniques to enhance performance even in cell edge conditions with poor link quality. In a first technique, a diversity antenna uses difference in fading characteristics to each of the antennas to enhance the desired signal over the interfering signals and white noise (AWGN). As described supra, adding additional antennas to the MAS has a diminishing return, i.e. the gain improvement of adding a 2^{nd} antenna is larger than that obtained from adding a 3^{rd} antenna, and so on. In a second technique, interference cancellation is used where, considering K receive antennas, an interference canceling algorithm is capable of canceling K−1 interferers. In scenarios dominated by few major interferes, this is an effective technique to enhance performance.

A MIMO technique, beamforming is used which utilizes the MAS to create a pattern of several narrow and directional beams instead of a uniform antenna characteristic. The antenna pattern may be static or adaptive to temporal UE distribution in the cell (eNBs geographical deployment). Each UE (eNB) or groups of UEs in neighborhood locations may be assigned to a beam, thus minimizing interference and enhancing the desired signal. One concern with beamforming is mobility, since the beam has a specific space orientation. Traveling entities change their location in a way that can degrade performance due to the ability of the beamforming algorithm to track the location of moving entities. In general, a system of K antennas can create K beams. In a fourth technique, spatial multiplexing (referred to also as MIMO) is used where, in an environment rich with reflections, a system of K transmit antennas and L receive antennas can increase the link capacity by MIN(K, L). Note, however, that the link conditions in terms of noise and interference should be good enough to enable reliable detection by the receiver. Otherwise, the amount of retransmissions due to information packets received in error cancel out any benefit provided by spatial diversity.

Note that a combination of one or more techniques described above may be used simultaneously. In addition, it is desirable to achieve low correlation between the antennas. Low antenna correlation may be achieved by employing a large spatial difference (compared with the RF wavelength of a specific frequency band), directional antennas or orthogonality (e.g., via the orthogonal polarity of the electromagnetic components of the antenna). Further, it is desirable to employ a large number of antennas.

It is further noted that, RF signals are attenuated for antennas located inside the vehicle enclosure, due to the conductivity and permeability of the vehicle body. The VCS mobile femtocell embedded in the vehicle platform achieves a superior link condition by the utilization of a high quality MAS (in terms of the number of antennas, the spatial difference between them and the computational power to implement any necessary algorithms).

In comparison, a hand held mobile terminal cannot employ such a high quality MAS since its form factor is too small and is powered by a small and light weight battery. In a hand held mobile terminal, the correlation between the antennas is high. In addition, the hand held device is typically constantly changing its orientation in space, hence it is difficult to utilize directional related algorithms. The VCS mobile femtocell utilizes a high quality MAS with an interference management function that tracks the conditions on the link with the macrocell and determines the best combination of multiple antenna RX/TX algorithms to employ. For example, in the cell center, spatial multiplexing is preferred to increase throughput, but towards the cell edge an interference cancellation (few major interference sources) or diversity (white noise dominance) algorithm is preferred. At low vehicle speeds, beamforming gains priority.

Typically, the mobile femtocell can be implemented with MAS comprising between four to eight antennas. It is appreciated that fewer or more antennas may be used as well. It is possible that more than eight antennas may be integrated into the vehicle platform. The related MIMO receiver complexity, however, increases exponentially with the number of antennas. Thus, hand held terminals utilize only simplified algorithms with a lower number of antennas.

Since the VCS mobile femtocell comprises a radio system operating in the UE band (i.e. the backhaul communications part) and a radio system that operates in the base station band (i.e. the femtocell communications part), there is inherent interference between the UE served by the mobile femtocell and the backhaul part. The VCS mechanism provides a solution to this inference issue by use of any of the following techniques.

In a first technique, the mobile femtocell provides service in the same radio access technology (RAT), but on radio resources other then those used by the macrocell. Examples include: (1) using different frequency bands; (2) using a different subcarrier allocation in an FDMA system; (3) using a different scrambling and/or spreading code in a CDMA system; and (4) using a different duplexing method (FDD versus TDD) in the macrocell and mobile femtocell (where the frequency bands are inherently different).

In a second technique, the mobile femtocell operates in a different radio access technology. For example, the macrocell operates using LTE RAT and the mobile femtocell operates using HSPA.

In a third technique, the mobile femtocell operates on the same radio resource as the macrocell. Interference is handled using at least one of the following methods: (1) use of directional antennas (e.g., backhaul MAS having a null in the direction of the vehicle interior and mobile femtocell antennas are directed into the vehicle interior and have nulls towards the space outside the vehicle); (2) reducing the output power in the mobile femtocell (since the UEs in the coverage area in very close proximity to the mobile femtocell transceivers; (3) use of interference cancellation signal processing algorithms executed by the mobile femtocell, namely (a) algorithms operative to improve backhaul receiver and mobile femtocell receiver performance; and (b) algorithms operative to improve UE receiver performance; and (4) use of interference avoidance algorithms executed by the mobile femtocell apparatus which are operative to manipulate access parameters such as time scheduling and radio resource management so as to reduce mutual interference, e.g., in the event a portion of the radio resources space is free of interference, but the total data to be transmitted by the mobile femtocell part exceeds the resources, the management entity then postpones such low priority service to a later time. A similar case leads to a decision to reduce transmit power for lower priority (importance) or best effort service.

In another embodiment, the mobile femtocell provides a power dissipation advantage to the UE handsets in the coverage area. Since the mobile femtocell provides a service to a very localized group of UEs, it is desirable that the transmission between the mobile femtocell and the registered UEs is performed utilizing minimal output transmit power in order to reduce interference in the access network. The VCS mobile femtocell minimizes the transmission power by configuring a reduction in the output power of the registered handheld terminal UEs thereby contributing to longer battery life of the UEs and a reduction in overall radiation. Functioning as a cellular base station to the UEs, the mobile femtocell sends power control commands to the UEs in accordance with the particular wireless standard used.

In another embodiment, the VCS mobile femtocell provides a billing advantage through the aggregation of users within coverage of the mobile femtocell. Consider, for example, a private vehicle serving a family. In this case, communicating through the mobile femtocell may provide a discounted tariff for wideband data access and voice calls. In the case of public transportation (e.g., buses, trains, etc.), users may subscribe to a wideband data service provided by the public transportation operator and benefit from a discounted tariff. Users who use public transportation often or commute to work everyday, such a service desirable in terms of tariffs, quality of service and overall user experience.

In another embodiment, the VCS mobile femtocell provides location services, when the mobile femtocell or one of its registered users utilizes a means for location determination. Exchanging location based information between the mobile femtocell, its registered UEs and the vehicle platform, provides advantages in providing location based services. For example, vehicles equipped with a GPS system should be able to generate accurate location, speed, etc. readings. These readings can provide accurate location determination to the mobile femtocell. This information, in turn, can be provided by the mobile femtocell to UEs registered in its coverage area.

In another embodiment, the VCS mobile femtocell provides added value to the cellular system as the utilization of mobile femtocells facilitates the improvement in overall QoS and QoE, by improving cell edge performance and the overall spectral efficiency of the cellular network. Cellular network operators incorporate mobile femtocells in their networks benefit from network wide improvements. The part of the network utilized by subscribers in vehicles will be improved.

Improved cell edge and overall spectral efficiency leads to a more flat QoS level across the entire cell. Hence, the overall capacity and throughput of the network increases and its variance is reduced dramatically. The result for the operator is additional value that can be provided out of the access and core NW infrastructure.

An improved user experience in wideband data services promotes usage of the NW, likely resulting in a higher willingness to pay and higher revenues due to more intensive utilization of the NW. The improved cell edge performance and improved overall spectral efficiency, however, enables operators to provide additional capacity in response to any increase in demand.

With the constant evolving of radio access technology, performance at the cell edge and spectral efficiency of the cell gain in importance. In a GSM network, for example, the service provided is essentially a voice call. In GSM, the network is designed to facilitate voice calls at the cell boundaries. Any benefits of better link condition in the center of the cell are not leveraged. As technology evolves to provide data services, there is more of a focus to utilize the available spectrum as much as possible. Some of the techniques typically used include link adaptation (in GPRS and EGPRS), HARQ (in EDGE), CDMA (in 3G), diversity (in HSPA) and MIMO (in LTE, WiMAX and HSPA+). Since these techniques are all adaptive in nature, they benefit from the good conditions typically found in the cell center to provide higher throughput.

In the current quest to achieve maximum theoretical throughput, the cell edge is neglected. The gaps in spectral efficiency (i.e. throughput) between the cell edge and the cell center may be 100 times or more. This is problematic from a network planning perspective since QoS cannot be maintained for mobile users. This is especially for users in vehicles traveling at high speed.

The shortage of available spectrum forces the operators to deploy access networks at higher frequency bands. Signal propagation properties, however, are worse at these higher frequency bands. This phenomenon stresses mobile receivers and leads to smaller size cells. As much as the use of smaller cells increases capacity (capacity of a network can be calculated as the average cell capacity times the number of cells), it is not a practical solution for rural or road coverage due to the scale of the geographical area (as opposed to city center coverage).

Thus, the value of the VCS mobile femtocell is likely to increase over time as network operators seek additional capacity from their networks. Currently the VCS mobile femtocell benefits all 3G and EGPRS networks, WiMAX networks, 802.16m, LTE, LTE-Advance networks and future generations of cellular communications beyond 4G and IMT-Advanced. It provides added value and is applicable to any data service (including VoIP and video streaming) in any cellular system (i.e. an access network comprising cells) and satellite system (i.e. where backhaul communications is established via a satellite access network).

### VCS Mobile Access Point (Inverted Femtocell)

A non-inverted or classical femtocell is a small cellular base station, typically designed for use in residential or small business environments. The non-inverted femtocell is a user-deployed home base station (BS) that provides improved home coverage to UEs and increases the capacity for user traffic by using a backhaul connection (e.g., an IP connection) to a service provider over the user's broadband connection (e.g., Digital Subscriber Line (DSL), cable, satellite, fiber optic, etc.). In an inverted femtocell, the backhaul connection is a cellular link to the macrocell where users (UEs) connect via a personal area network (PAN) or local area network (LAN), e.g., WLAN, Bluetooth, Ethernet, etc.

In one embodiment, the VCS inverted femtocell (also referred to as a mobile access point or access point base station), is similar to the mobile femtocell with a difference being that the mobile femtocell module 678 (FIG. 33) is replaced by an access point module of a personal area network (PAN) or other local wireless technology such as WiFi, WLAN, Wireless USB, Bluetooth, etc. In this case the inherent interference between the macrocell backhaul module and the access point module is handled in most cases by filtering. In addition, in many cases, the TX replicas are replaced by a straightforward coordination scheme between the access point module and the macrocell backhaul module.

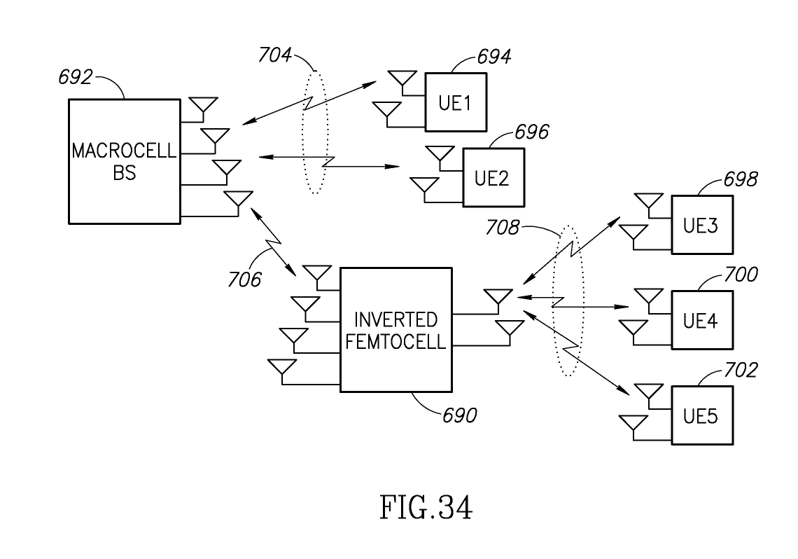

A diagram illustrating an example wireless network incorporating an inverted femtocell is shown in FIG. 34. The network comprises a macrocell base station 692 in communication with inverted femtocell 690 and UEs, namely UE1 694 and UE2 696 over links 704. The inverted femtocell provides an access point for one or more UEs, namely UE3 698, UE4 700 and UE5 702 and connects with them over links 708. Cell data traffic connectivity is provided through the backhaul link 706. Any necessary signaling for the inverted femtocell is independently generated by the access point module within the inverted femtocell.

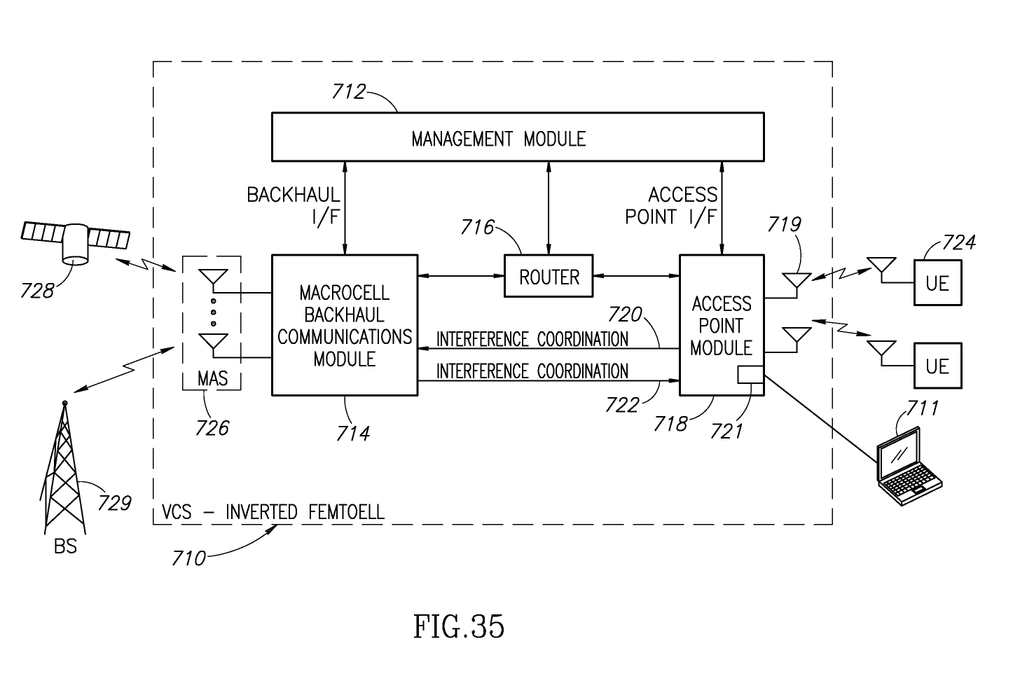

A high level diagram illustrating an example VCS based mobile access point (inverted femtocell) is shown in FIG. 35. The VCS mobile access point, generally referenced 710, comprises several functional modules, including macrocell backhaul communications module 714 in communication with the cellular base station 729 (or satellite communication system 728) via MAS 726, router 716, access point module 718 coupled to antenna(s) 719 and management module 712.

The macrocell backhaul communications module implements the core cellular communications system 50 (FIG. 2), 100 (FIG. 4) which is seen by the macrocell network as another cell site. The base station is connected to an access network (not shown) which provides connectivity to the Internet for users. The macrocell backhaul communications module functions to provide the backhaul data link for the entire VCS mobile access point. The operator control and configuration session is enabled between the network and the management module through the backhaul communications module. The data pipe for the mobile access point is provided through the backhaul communications module as well.

Interference coordination from the access point module to the macrocell backhaul module (arrow 720) and from the macrocell backhaul module to the access point module (arrow 722) functions to reduce the inherent interference between both modules.

The mobile access point module 718 functions to provide a wired or wireless link (e.g., WLAN, Bluetooth, Ethernet, etc.) to UEs 724. UEs 724 within the range of the access point module can be served by the mobile access point. In one embodiment, the access point module provides a wired link 721, such as Ethernet, for users (such as laptop 711) to connect to an IVN, Internet, etc. using the mobile access point as a gateway device. From the perspective of the UEs connected and authenticated with the access point module, they are associated with a PAN which is local to the vehicle and which provides connectivity to the Internet.

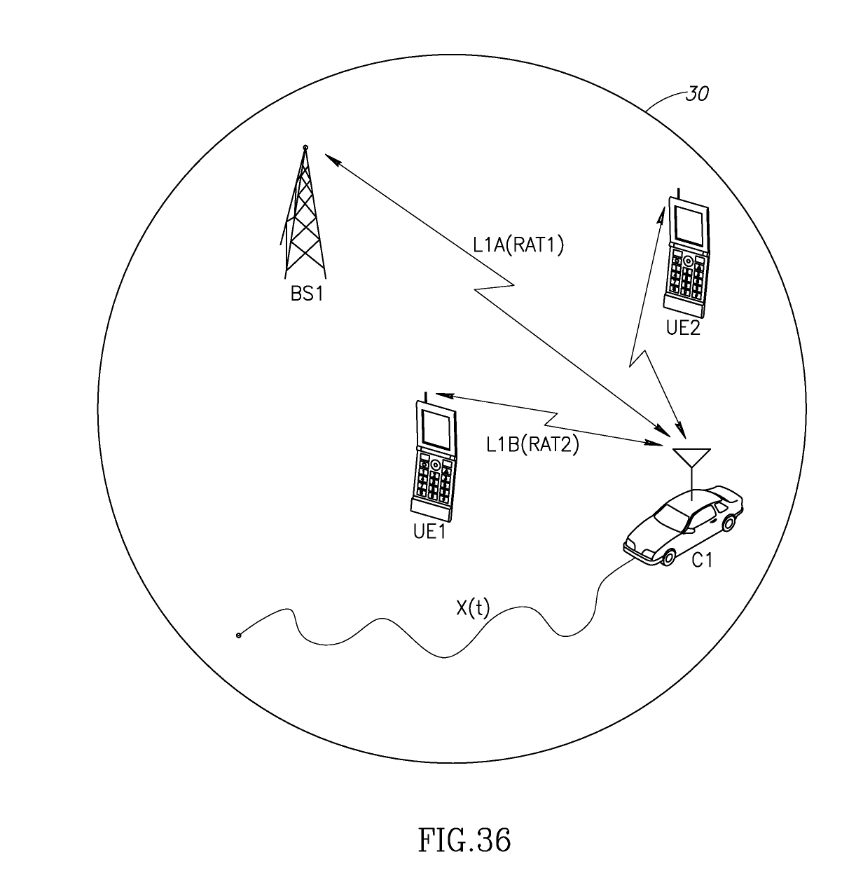

A diagram illustrating an example wireless network incorporating a mobile access point (inverse femtocell) device is shown in FIG. 36. The cell 30 with BS1 comprises a vehicle (car) C1 in communication with BS1 over link L1A. The link between the users (UE1, UE2, etc.) and the base station (BS1) is implemented using two separate links each on different radio access technologies RATs). For example, the link L1A between BS1 and the car C1 uses one radio access technology 3GPP-LTE (RAT1) while the link L1B between car C1 and the UEs uses a different radio access technology WiFi (WLAN) (RAT2). Another (RAT2) link between C1 and a UE may be used for an occasional user not normally configured in the access point (i.e. public access). Note that car C1 moves through the cellular network (NW) on a route x(t) with a time variant speed v(t) while connected to BS1 and the UEs.

Note that the mobile access point (inverse femtocell) may experience handovers by changing the serving BS from BS1 to BS2 (not shown). The mobile access point (inverse femtocell) is responsible for maintaining the link L1A along x(t) considering the link level fluctuations and any handovers. The links L1B between the mobile access point (inverse femtocell) and the users (UEs) are maintained continuously with RAT2 where signal levels normally in high enough level and no handovers are performed.

Note further that in another embodiment, the RAT1 may change over time, meaning that if the vehicle goes out of the coverage of RAT1 (3GPP-LTE in this example) a handover may be performed with other existing RAT1s such as 3GPP-HSPA maintaining the service continuity for users.

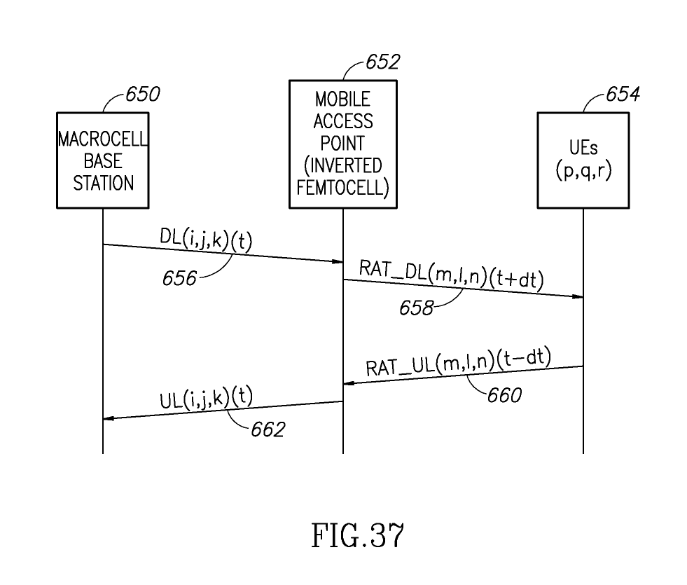

FIG. 37 illustrates message forwarding for an example inverted femtocell between the macrocell base station 650, inverted femtocell access point 652 and UEs (users) 654, namely three (p, q, r) in the example shown. Note that the terms DL_{[i, j, k]} and UL_{[i, j, k]} denote the resources allocated between the inverted femtocell and the base station for the three users denoted: p, q, r (three users shown for illustration purposes only). The terms RAT_DL_{[m, l, n] and RAT}_UL_{[m, l, n]} denote the resources allocated between the inverted femtocell and the above mentioned UEs (users) p, q, r. The term RAT in this example denotes any possible wireless access (e.g., WLAN, Bluetooth, etc.) in use between the access point and users which may be identical or different to the RAT in use between the macrocell base station and the access point.

Note that the sequence of processes, namely demodulate, modify and modulate causes a time difference in communications between the macrocell base station-access point and access point-users. In this case, the delays are caused by the use of different wireless technologies and connections. In addition, communications between the macrocell base station-access point and between access point-users may comprise H-ARQ/ARQ jointly or separately.

### VCS Infotainment System

Due to the ever increasing needs of road safety and sustainable mobility, there is a need for vehicle centric communications. In response, a series of automotive communications standards (Wide Area Communications, ISO TC204/WG16) are being developed known as Communications Access for Land Mobiles (CALM). The goal of CALM is to develop a standardized networking terminal that capable of connecting vehicles and roadside systems continuously and seamlessly. This is accomplished through the use of a wide range of communication media, such as mobile cellular and wireless local area networks, and short-range microwave or infra-red.

The scope of CALM is to provide a standardized set of air interface protocols and parameters for wireless digital data communications using one or more of several media, including existing communication technologies, CALM specific communication technologies, and enabling future communication technologies, networking protocols and upper layer protocols, in order to enable efficient intelligent transportation system (ITS) communications services and applications.

The CALM communication service includes the following communication modes: (1) Vehicle-Vehicle: a low latency peer-peer network with the capability to carry safety related data such as collision avoidance, and other vehicle-vehicle services such as ad-hoc networks linking multiple vehicles; (2) Vehicle-Roadside: similar to Vehicle-Vehicle, where one of the “vehicles” is parking, meaning that the roadside station is not connected to an infrastructure but may be connected to a local network of ITS stations, e.g., around a cross-section; (3) Vehicle-Infrastructure: multipoint communication parameters are automatically negotiated and subsequent communication may be initiated by either roadside or vehicle, where the roadside station is connected to an infrastructure, e.g., Internet or others; and (4) Infrastructure-Infrastructure/Roadside-Roadside: the communication system may also be used to link fixed points where traditional cabling is undesirable.

Various media defined in CALM include: (1) cellular systems, e.g. 2/2.5G GSM/HSDSC/GPRS and 3G UMTS; (2) infrared communication; (3) 5 GHz wireless LAN systems based on IEEE 802.11a/p; (4) 60 GHz systems; and (5) a common convergence layer to support media such as existing DSRC protocols, broadcast protocols and positioning receivers.

The Network layer may support several networking protocols, such as (1) Internet Protocol Networking including (a) Kernel is IPv6; (b) mobile IPv6 elements are included for handover; (c) header compression; and (d) Internet connectivity; (2) non-IP mobile connectivity and routing in fast ad-hoc network situations, including (a) the FAST protocol for single hop unicast/n-hop broadcast communications; and (b) GeoNetworking; and (3) Common Service Access Points (SAP) towards the lower layers (LSAP) and for management services.

Application examples of CALM include so called “infotainment” applications, including the update of roadside telemetry and messaging, in car internet, video and image transfer, traffic management, monitoring and enforcement in mobile situations, collision avoidance, route guidance, car to car safety messaging, Radio LAN, co-operative driving and in car entertainment and “yellow page” services.

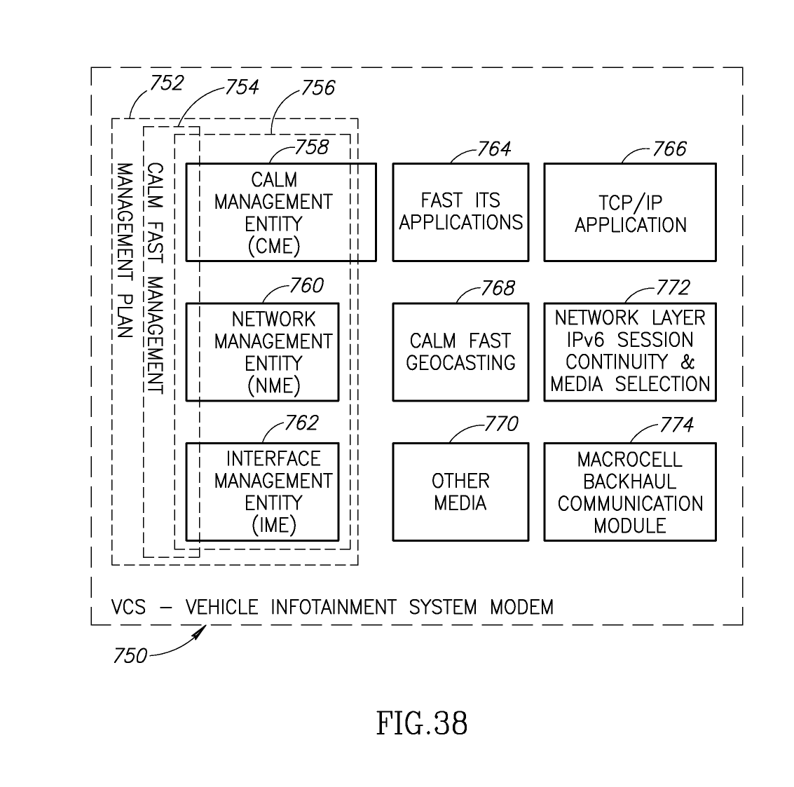

A diagram illustrating an example VCS based vehicle infotainment system (VIS) modem (also called telematics or ITS) is shown in FIG. 38. The VCS VIS modem (or CALM modem), generally referenced 750, comprises a management plan 752, CALM Fix Adapted for Streaming (FAST) Management 754, CALM Management Entity (CME) 758, Network Management Entity (NME) 760, Interface Management Entity (IME) 762, FAST ITS Applications block 764, CALM FAST Geocasting block 768, TCP/IP Application block 766, Network layer 772, other media block 770 and the macrocell backhaul communications module 774 (core cellular communications system 50 (FIG. 2), 100 (FIG. 4)).

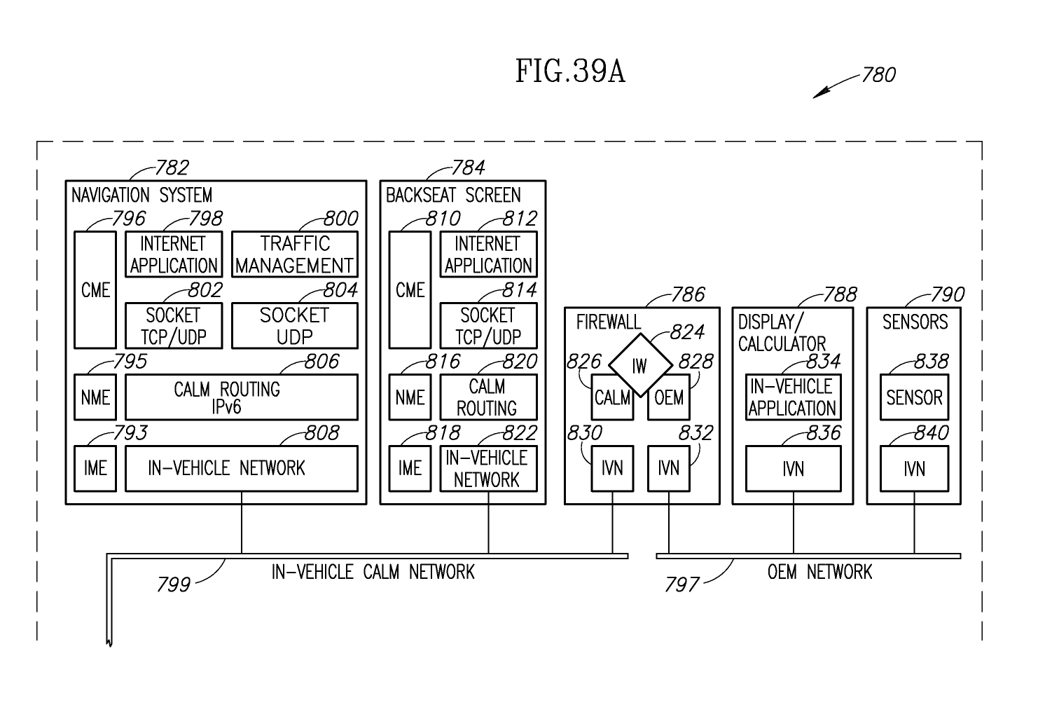

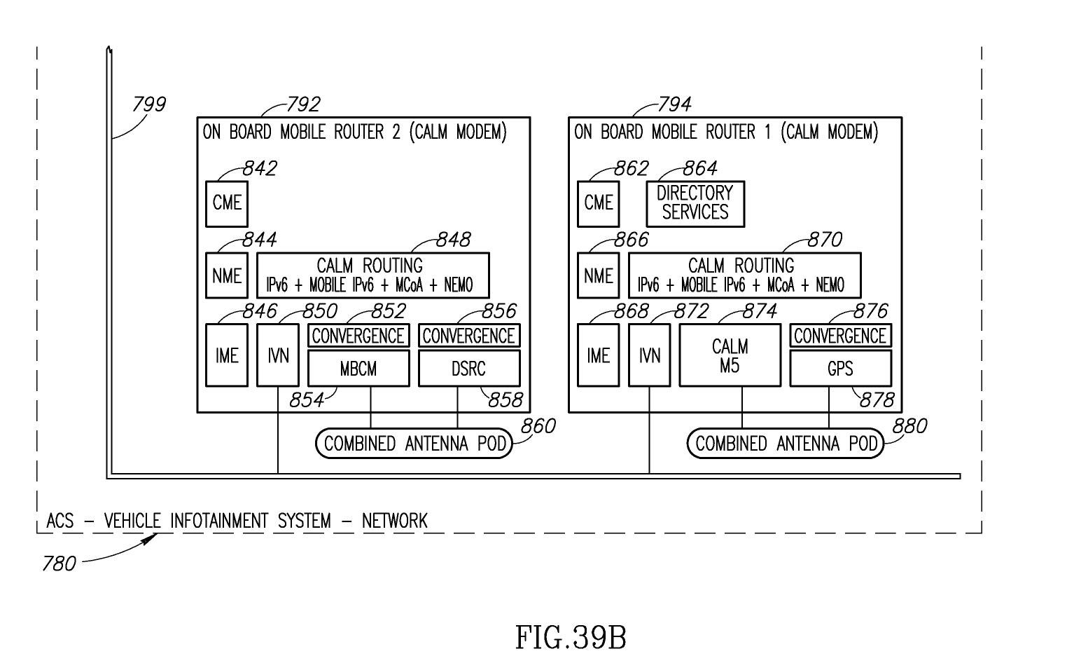

A diagram illustrating an example VCS based vehicle infotainment system network is shown in FIGS. 39A and 39B. The VCS VIS network, generally referenced 780, comprises a plurality of entities in communication via in-vehicle CALM network 799. For example, the entities include mobile router #1 794 coupled via IVN 872, mobile router #2 792 coupled via in-vehicle network (IVN) 850, navigation system 782 via IVN 808, backseat display 784 via IVN 822 and firewall 786 via IVN 830. The network also comprises a plurality of entities in communication via an OEM network 797. For example, the entities include firewall 786 via IVN 832, display/calculator 788 via IVN 836 and sensors 790 via IVN 840. On-board mobile router #2 (CALM modem) 792 comprises CME 842, NME 844, IME 846, CALM routing block 848, macrocell backhaul communications module (MBCM) 854 (such as core cellular communications system 50 (FIG. 2), 100 (FIG. 4)) coupled to antenna pod 860 (i.e. the MAS), Dedicated Short Range Communications (DSRC) 858 also coupled to antenna pod 860 and corresponding convergence blocks 852, 856.

On-board mobile router #1 (CALM modem) 794 comprises CME 862, NME 866, IME 868, CALM routing block 870, directory services block 864, CALM M5 874, GPS radio 878 and associated convergence block 876 coupled to antenna pod 880.

Navigation system 782 comprises CME 796, NME 795, IME 793, Internet application(s) 798, TCP/UDP socket 802, UDP socket 804 and CALM IPv6 routing 806. Backseat screen 784 comprises CME 810, NME 816, IME 818, Internet application(s) 812, TCP/UDP socket 814 and CALM routing 820. Display/Calculator 788 comprises in-vehicle application 834. Sensors 790 comprise one or more sensors 838.

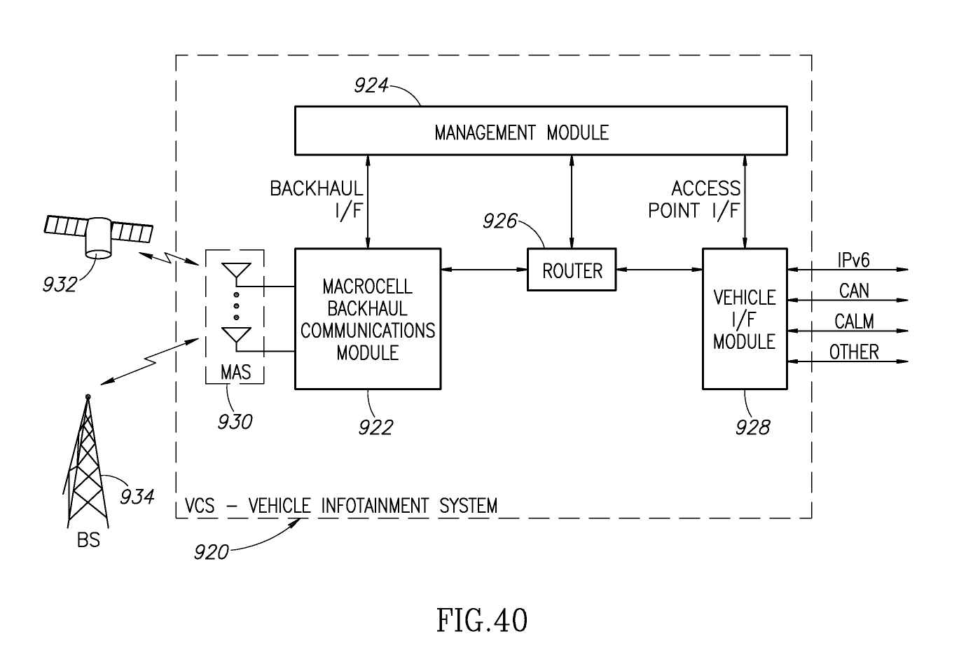

A high level diagram illustrating an example VCS based vehicle infotainment system (VIS) is shown in FIG. 40. The VIS, generally referenced 920, comprises several functional modules, including macrocell backhaul communications module 922 in communication with the cellular base station 934 (or satellite communication system 932) via MAS 930, router 926, vehicle interface (I/F) module 928 and management module 924.

The macrocell backhaul communications module implements the core cellular communications system 50 (FIG. 2), 100 (FIG. 4) which is seen by the macrocell network as a UE. The backhaul communication module functions to provide the core cellular link for the CALM BWA modem and mobile router.

The vehicle interface module functions to provide the electrical connectivity and any required protocol/format adaptations/conversions/translations to one or more interfaces, including: (1) an IPv6 protocol stack; (2) a Controller Area Network (CAN) (a network that allows sensors, actuators, devices, switches and displays to communicate over a bus at speeds up to 1 Mbps); (3) a Communications Access for Land Mobiles (CALM) network; and (4) any other suitable devices, systems or networks. The management module 924 interacts with the in vehicle management plane described supra.

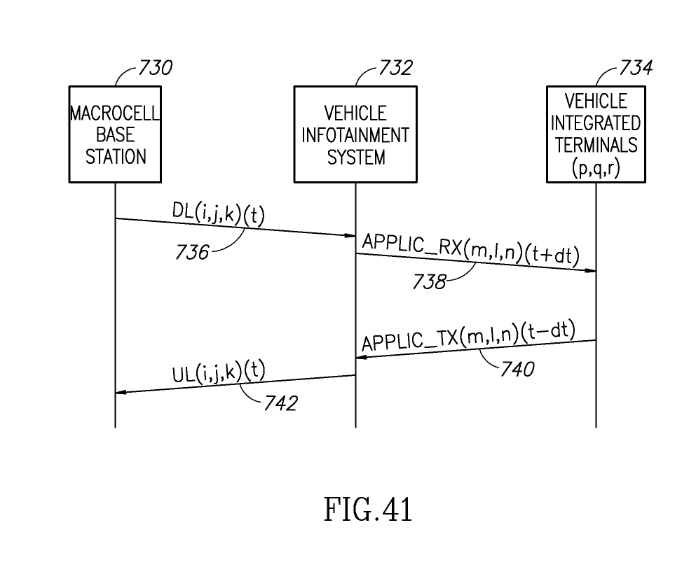

FIG. 41 illustrates message forwarding for an example vehicle infotainment system (VIS) between the macrocell base station 730, vehicle infotainment system 732 and vehicle integrated terminals 734, namely three user terminals (p, q, r) in the example shown. Note that the terms DL_{[i, j, k]} (736) and UL_{[i, j, k]} (742) denote the resources allocated between the vehicle infotainment system and the macrocell base station for three users terminals denoted: p, q, r (three being used here for illustration purposes only). The terms APPLIC_RX_{[m, l, n]} 738 and APPLIC_TX_{[m, l, n]} 740 denote the application sessions between the vehicle infotainment system and the above mentioned user terminals p, q, r and the vehicle infotainment system.

In the execution of the DL process, the DL signal is demodulated, processed by the VIS application and carries out any interaction with one of the in car terminals. In the UL direction, the UL is processed in reversed order. This causes a timing difference (i.e. latency) between the macrocell-VIS connection and the VIS-integrated terminal connections. In this case, the latencies are related to different aspects and layers.

### Computer Processing System

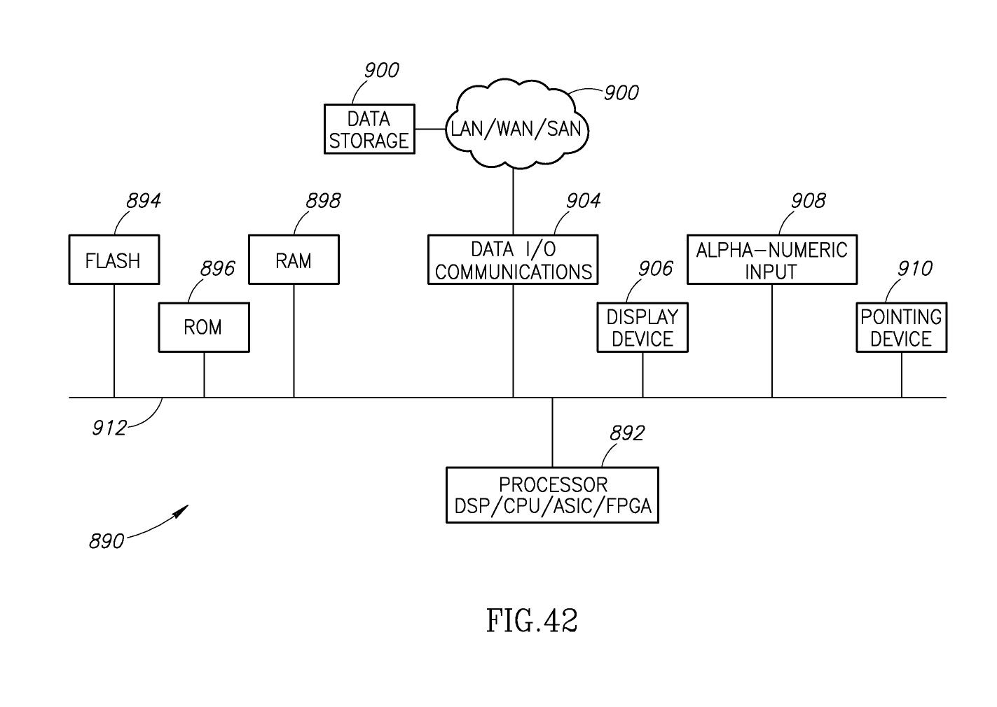

A block diagram illustrating an example computer processing system adapted to implement the vehicle communications system mechanism or portions thereof is shown in FIG. 42. The computer system, generally referenced 890, comprises a processor 892 which may comprise a digital signal processor (DSP), central processing unit (CPU), microcontroller, microprocessor, microcomputer, ASIC, FPGA or DSP core, etc.

The system also comprises static read only memory 896 and dynamic main memory 898 all in communication with the processor. The processor is also in communication, via bus 912, with a number of peripheral devices that are also included in the computer system. Peripheral devices coupled to the bus include a display device 906 (e.g., monitor), alpha-numeric input device 908 (e.g., keyboard) and pointing device 910 (e.g., mouse, tablet, etc.)

The computer system is connected to one or more external networks such as either a LAN, WAN or SAN 902 via communication lines connected to the system via data I/O communications interface 904 (e.g., network interface card or NIC). The network adapters 904 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 900 for storing application programs and data. The system comprises computer readable storage medium that may include any suitable memory means, including but not limited to, magnetic storage, optical storage, semiconductor volatile or non-volatile memory, or any other memory storage device.

Software adapted to implement the vehicle communications system mechanism is adapted to reside on a computer readable medium, such as a magnetic disk within a disk drive unit. Alternatively, the computer readable medium may comprise registers, a CD-ROM, floppy disk, RAM memory, flash memory, hard disk, removable hard disk, Flash memory 894, EPROM, EEPROM, EEROM based memory, solid state memory, registers, bubble memory storage, ROM memory, distribution media, intermediate storage media, execution memory of a computer, and any other medium or device capable of storing for later reading by a computer a computer program implementing the mechanism. The software adapted to implement the vehicle communications system mechanism may also reside, in whole or in part, in the static or dynamic main memories or in firmware within the processor of the computer system (i.e. within microcontroller, microprocessor or microcomputer internal memory).

Other digital computer system configurations can also be employed to implement the vehicle communications system mechanism, and to the extent that a particular system configuration is capable of implementing the system and methods of this mechanism, it is equivalent to the representative digital computer system of FIG. 42 and within the spirit and scope of this mechanism.

Once they are programmed to perform particular functions pursuant to instructions from program software that implements the system and methods of this mechanism, such digital computer systems in effect become special purpose computers particular to the method of this mechanism. The techniques necessary for this are well-known to those skilled in the art of computer systems.

It is noted that computer programs implementing the system and methods of this mechanism will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this mechanism. All these operations are well-known to those skilled in the art of computer systems.

The flowchart and block diagrams in the Figures illustrate the architecture, functionality, and operation of possible implementations of systems, methods and computer program products according to various embodiments of the present mechanism. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the mechanism. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the mechanism has been presented for purposes of illustration and description, but is not intended to be exhaustive or limited to the mechanism in the form disclosed. As numerous modifications and changes will readily occur to those skilled in the art, it is intended that the mechanism not be limited to the limited number of embodiments described herein. Accordingly, it will be appreciated that all suitable variations, modifications and equivalents may be resorted to, falling within the spirit and scope of the mechanism. The embodiments were chosen and described in order to best explain the principles of the mechanism and the practical application, and to enable others of ordinary skill in the art to understand the mechanism for various embodiments with various modifications as are suited to the particular use contemplated.

What is claimed is:

1. A vehicle integrated communications system, comprising:
a multi-antenna radio frequency (RF) module operative to be coupled to a plurality of antennas integrated into a vehicle platform for transmitting and receiving a plurality of spatial streams over a communications network link;
a receiver baseband module coupled to said RF module and operative to generate RX data in accordance with multiple receive spatial streams received from said plurality of antennas;
a transmitter baseband module coupled to said RF module and operative to generate, from TX data, multiple transmit spatial streams for transmission over said plurality of antennas; and
a controller operative to control the operation of said multi-antenna RF module, said receiver baseband module and said transmitter baseband module.

2. The vehicle integrated communications system according to claim 1, further comprising a power management module operative to supply power and status information to said vehicle communications system from a vehicle platform based power source.

3. The vehicle integrated communications system according to claim 1, further comprising a subsystem interface module for interfacing said vehicle communications system to one or more subsystems and in-vehicle networks integrated into said vehicle platform.

4. The vehicle integrated communications system according to claim 3, wherein said one or more subsystems are selected from the group consisting of: microphone, speaker, keyboard, keypad, display, camera, serial communications interface, Global Positioning Satellite (GPS).

5. The vehicle integrated communications system according to claim 1, wherein said transmitter base band module comprises an antenna mapper operative to map said multiple transmit spatial streams to individual antennas.

6. The vehicle integrated communications system according to claim 5, wherein the number of transmit antennas is greater than the number of transmitted spatial streams.

7. The vehicle integrated communications system according to claim 6, further comprising precoding wherein antenna mapping and weighting are configured in accordance with communications network link characteristics.

8. The vehicle integrated communications system according to claim 5, further comprising a weighting module operative to apply weights to said multiple transmit spatial streams.

9. The vehicle integrated communications system according to claim 8, wherein said weights are generated by a precoding algorithm performed by said controller.

10. The vehicle integrated communications system according to claim 1, wherein said receiver baseband module comprises a multiple-input multiple-output (MIMO) decoder operative to concurrently detect said multiple receive spatial streams in accordance with a MIMO decoder configuration, wherein the number of antennas is larger than number of spatial streams.

11. The vehicle integrated communications system according to claim 10, wherein said MIMO decoder configuration is determined by estimating an error probability of each configuration and selecting a configuration that yields a minimum error probability.

12. The vehicle integrated communications system according to claim 10, wherein said MIMO decoder configuration is determined by calculating the Channel Quality Indicator (CQI) provided to the network for each detection configuration and selecting a configuration that yields best CQI and Rank Indication (RI).

13. The vehicle integrated communications system according to claim 10, wherein said MIMO decoder configuration is provided by a look up table (LUT) comprising configuration entries, wherein an index to said LUT is computed as a function of one or more quantized parameters.

14. The vehicle integrated communications system according to claim 1, further comprising an interference cancellation module operative to provide interference mitigation of one or more interferer signals received over said link.

15. The vehicle integrated communications system according to claim 1, wherein said receiver baseband module is operative to utilize antenna diversity provided by said plurality of antennas to significantly improve signal to interference and noise ratio (SINR) performance of said vehicle communications system.

16. The vehicle integrated communications system according to claim 1, further comprising a beamforming module operative to utilize said plurality of antennas to create one or more directional antenna beams.

17. The vehicle integrated communications system according to claim 1, wherein said plurality of antennas have a fixed orientation.

18. The vehicle integrated communications system according to claim 1, wherein said plurality of antennas have substantial isolation between one another.

19. The vehicle integrated communications system according to claim 1, wherein most of the energy radiated by said plurality of antennas is directed away from the vehicle interior.

20. The vehicle integrated communications system according to claim 1, wherein said plurality of antennas comprise one or more directional antennas.

21. The vehicle integrated communications system according to claim 1, wherein said communications network comprises a cellular based wireless communications network.

22. The vehicle integrated communications system according to claim 1, wherein said communications network comprises a satellite based wireless communications network.

23. The vehicle integrated communications system according to claim 1, wherein said vehicle integrated communications system is operative to exchange information with said vehicle platform.

24. The vehicle integrated communications system according to claim 1, wherein the number of antennas is larger than the number of spatial streams.

25. The vehicle integrated communications system according to claim 1, wherein said receiver baseband module is operative to autonomously select a multi-antenna detection algorithm in accordance with one or more maximization criteria.

26. A method of communications for use in a vehicle communications system integrated into a vehicle platform, said method comprising:
providing a multi-antenna radio frequency (RF) module operative to be coupled to a multiple antenna system (MAS) comprising a plurality of antennas integrated into a vehicle platform, said multi-antenna RF module operative to transmit and receive multiple spatial streams over a communications network link;
providing a receiver baseband module coupled to said RF module and operative to generate RX data in accordance with multiple receive spatial streams received from said plurality of antennas;
providing a transmitter baseband module coupled to said RF module and operative to generate, from TX data, multiple transmit spatial streams for transmission over said plurality of antennas;
providing a controller operative to control the operation of said multi-antenna RF module, said receiver baseband module and said transmitter baseband module; and
selecting one or more optimal RX algorithms for execution in said receiver baseband module and one or more optimal TX algorithms for execution in said transmitter baseband module that exploit said plurality of antennas.

27. The method according to claim 26, wherein said one or more RX algorithms optimize the spectral efficiency and performance of said communications network link by exploiting use of said multiple antenna system.

28. The method according to claim 26, further comprising providing vehicle status and indications to a maintenance, service or emergency center.

29. The method according to claim 26, wherein said receiver baseband module utilizes antenna diversity provided by said multiple antenna system to significantly improve signal to interference and noise ratio (SINR) performance of said vehicle communications system.

30. A vehicle integrated cellular communications platform, comprising:
a multiple antenna system (MAS) comprising a plurality of antennas integrated into a vehicle form factor, said MAS operative to transmit and receive a plurality of spatial streams over a radio access network (RAN);
a cellular transceiver radio coupled to said MAS operative to provide communications over said RAN; and
a processor operative to execute one or more algorithms to maximize cell edge spectral efficiency and performance by exploiting one or more properties of said MAS.

31. The vehicle integrated cellular communications platform according to claim 30, wherein said one or more algorithms is selected from the group consisting of: antenna diversity algorithms, spatial multiplexing algorithms, beamforming algorithms, adaptive coding and modulation algorithms, dynamic channel estimation algorithms and interference cancellation algorithms.

32. The vehicle integrated cellular communications platform according to claim 30, wherein said one or more properties of said MAS is selected from the group consisting of: diversity order of said antennas, distance of antennas from each other, degree of correlation between antennas, placement of said antennas on said vehicle, antenna gain and antenna bandwidth.

33. A vehicle integrated cellular communications platform, comprising:
a cellular transceiver radio operative to be coupled to a multiple antenna system (MAS) integrated into a vehicle form factor and to transmit and receive a plurality of spatial streams over a radio access network (RAN) via said MAS; and
a processor operative to execute one or more algorithms to maximize cell edge spectral efficiency and performance by exploiting one or more properties of said MAS.

34. The vehicle integrated cellular communications platform according to claim 33, wherein said one or more algorithms is selected from the group consisting of: antenna diversity algorithms, spatial multiplexing algorithms, beamforming algorithms, adaptive coding and modulation algorithms, dynamic channel estimation algorithms and interference cancellation algorithms.

35. The vehicle integrated cellular communications platform according to claim 33, wherein said one or more properties of said MAS is selected from the group consisting of: diversity order of said antennas, distance of antennas from each other, degree of correlation between antennas, placement of said antennas on said vehicle, antenna gain and antenna bandwidth.
